(19) United States
(12) Patent Application Publication
(10) Pub. No.: US 2009/0230699 A1
(43) Pub. Date: Sep. 17, 2009

(54) Latch with Dual Rotary Pawls

(75) Inventor: Eric Carabalona, Kenilworth (GB)

Correspondence Address: PAUL AND PAUL, 2000 MARKET STREET, SUITE 2900, PHILADELPHIA, PA, 19103, US

(73) Assignee: SOUTHCO, INC., Concordville, PA (US)

(21) Appl. No.: 11/574,508

(22) PCT Filed: Aug. 31, 2005
(86) PCT No.: PCT/US2005/030818

§ 371 Date: May 9, 2008

Related U.S. Application Data
(60) Provisional application No. 60/606,257, filed on Sep. 1, 2004.
(60) Provisional application No. 60/611,937, filed on Sep. 21, 2004.

(51) Int. Cl. E05C 3/16

(52) U.S. Cl. 292/48

(57) ABSTRACT

A latch with dual rotary pawls is disclosed. The latch is particularly suited for releasably securing dual doors of a compartment in the closed position. Each rotary pawl engages a striker attached to a respective one of the doors to secure both doors in the closed position relative to the compartment.

### BACKGROUND OF THE INVENTION

1. Field of Invention

This invention relates to latch having dual rotary pawls for use in securing twin closure panels of a compartment in the closed position.

2. Brief Description of the Related Art

In many applications the need arises to fasten one panel to another. For example, in the automotive industry the panels acting as closures for the interior compartments of the vehicle must be secured in the closed position when the compartment is not being accessed. Examples of such compartments include the vehicle's glove compartment and the center console compartment between a vehicle's front seats. The closure members for such compartments are selectively secured in the closed position by latches in order to secure the contents of the compartments while allowing a user to selectively open the closure members to access the contents of the compartments. Many latches for this purpose have been proposed in the art. Examples of such latches can be seen in U.S. Pat. Nos. 5,927,772 and 6,761,278. However, there remains a need in the art for latches that can releasably secure dual closure members of compartments in the closed position.

### SUMMARY OF THE INVENTION

The present invention is directed to a latch for releasably securing dual doors of a compartment in the closed position. The latch has two rotary pawls, and each rotary pawl engages a striker rod attached to a respective one of the doors to secure both doors in the closed position relative to the compartment. Some embodiments of the latch according to the present invention are designed for use in applications where the dual doors are linked. In such applications closing one of the doors also moves the other door to the closed position. However, the mechanical linkage between the doors is not perfect and the closing of the doors is not always simultaneous. Often one door will slightly lag behind the other door in closing. The embodiments of the present invention that are designed to work with linked doors are designed to effect proper securing of the doors in the closed position even when one door lags behind the other.

### BRIEF DESCRIPTION OF THE DRAWINGS

FIGS. 1-23 are views of a first embodiment of a latch with dual rotary pawls according to the present invention and its various components.

FIGS. 24-41 are views of a second embodiment of a latch with dual rotary pawls according to the present invention and its various components.

FIGS. 42-63 are views of a third embodiment of a latch with dual rotary pawls according to the present invention and its various components.

FIG. 64-84 is a view of a fourth embodiment of a latch with dual rotary pawls according to the present invention and its various components.

FIGS. 85-98 are views of a fifth embodiment of a latch with dual rotary pawls according to the present invention and its various components.

FIGS. 99-114 are views of a sixth embodiment of a latch with dual rotary pawls according to the present invention and its various components.

FIGS. 115-120 are views of a seventh embodiment of a latch with dual rotary pawls according to the present invention and its various components.

FIGS. 121 and 122 are environmental views showing components of yet another embodiment of the latch of the present invention applied to a dual door glove box.

FIG. 123 shows the remote actuation components of the latch of FIGS. 121 and 122 in relation to the mechanical latching component of the latch.

FIG. 124 shows the remote actuator component of the latch of FIGS. 121 and 122.

FIG. 125 is an isometric view of the latch of FIGS. 121 and 122.

FIG. 126 is an isometric view of a latch that is a mirror image of the latch of the latch of FIG. 125 intended for mounting on the right side of the glove box.

FIGS. 127-128 are isometric views of the latch of FIGS. 121 and 122 in the unlatched configuration.

FIGS. 129-150 illustrate the operation of the latch of FIGS. 121 and 122 in cases when one striker lags the other.

FIGS. 151-163 are views of the isolated components of the latch of FIGS. 121 and 122.

Like reference numerals indicate like elements throughout the several views.

### DETAILED DESCRIPTION OF THE INVENTION

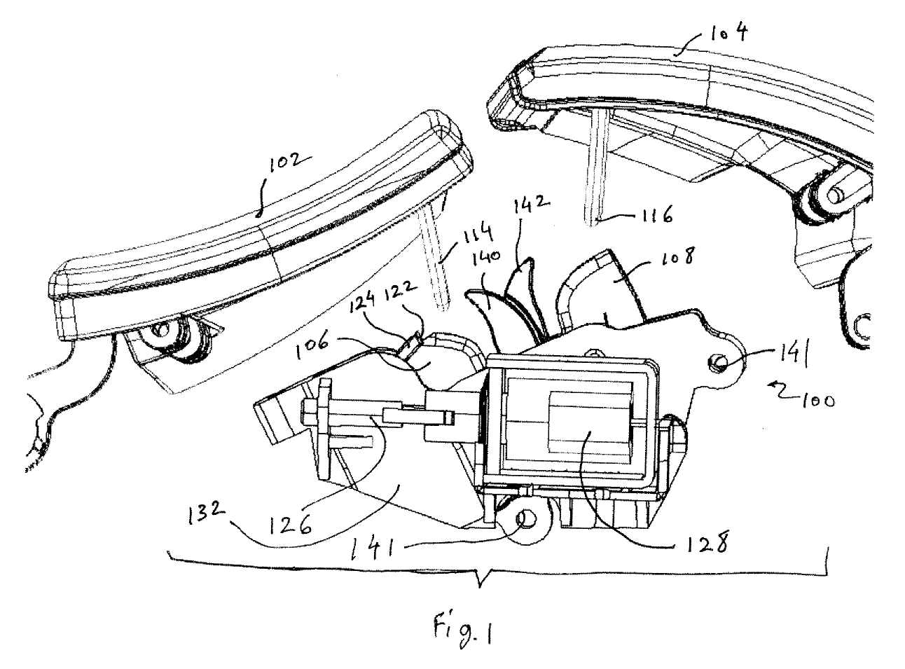

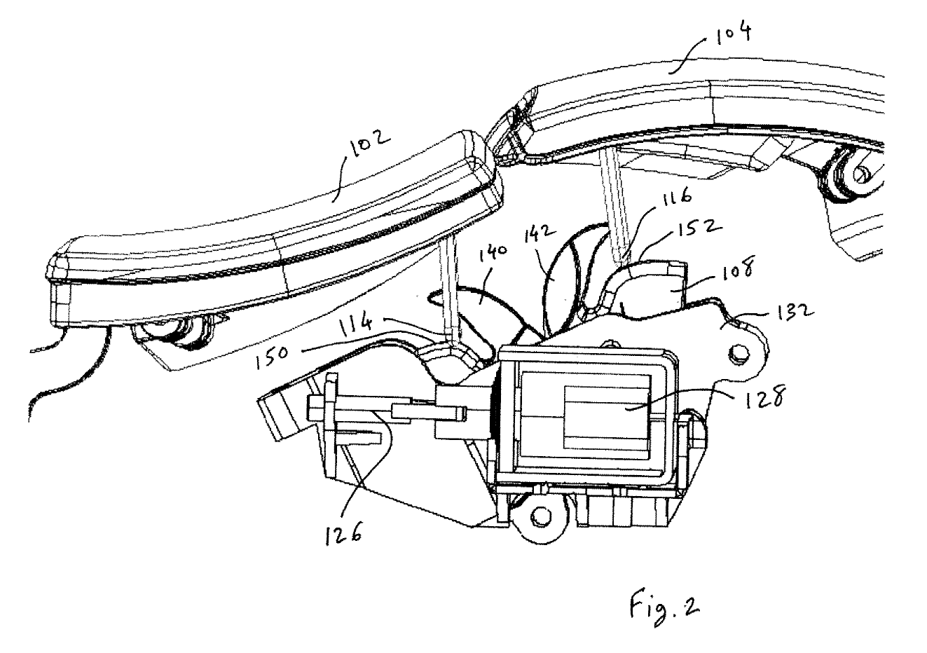

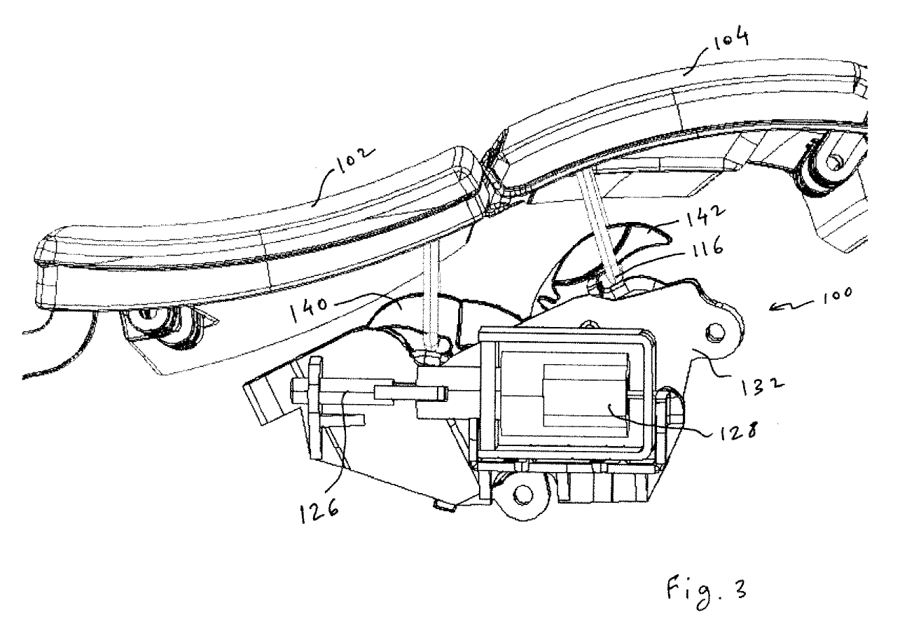

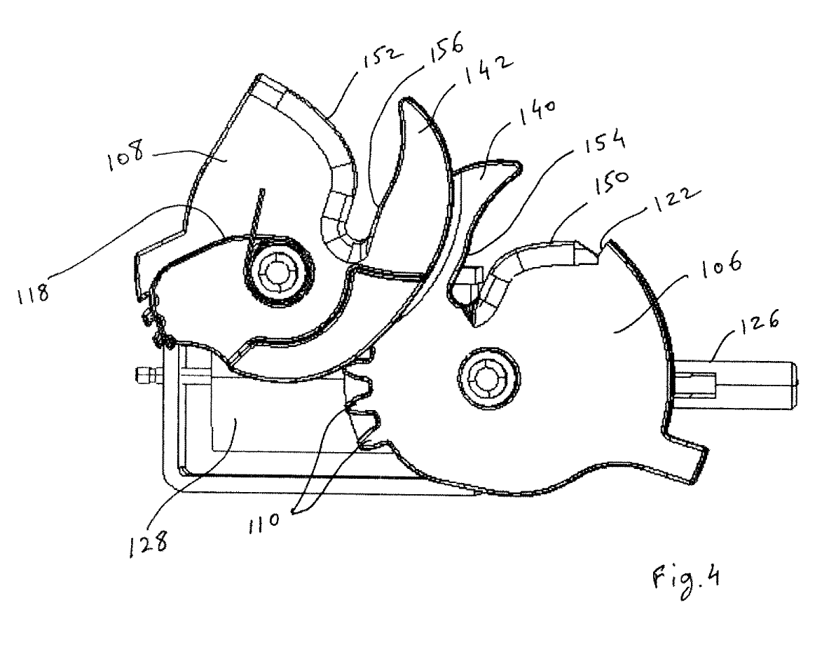

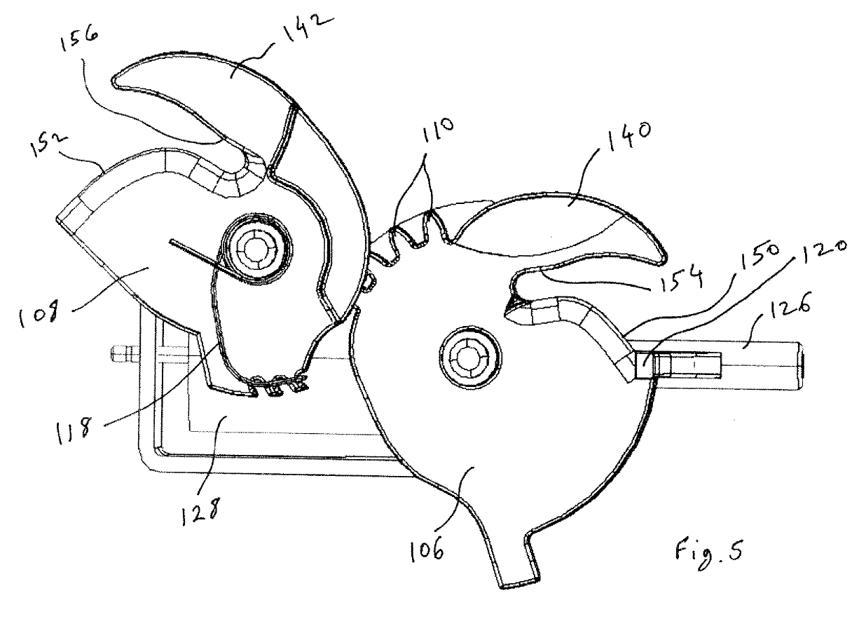

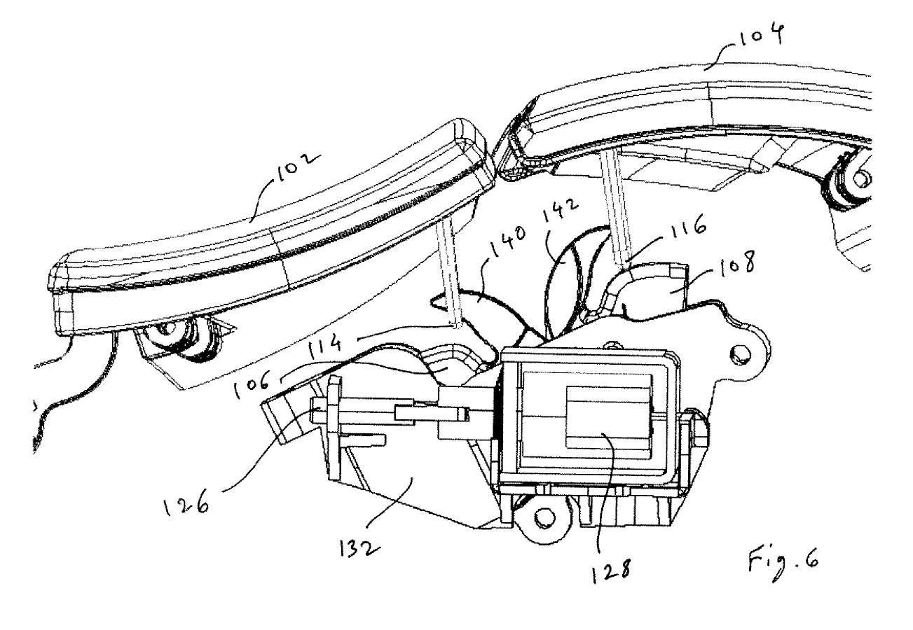

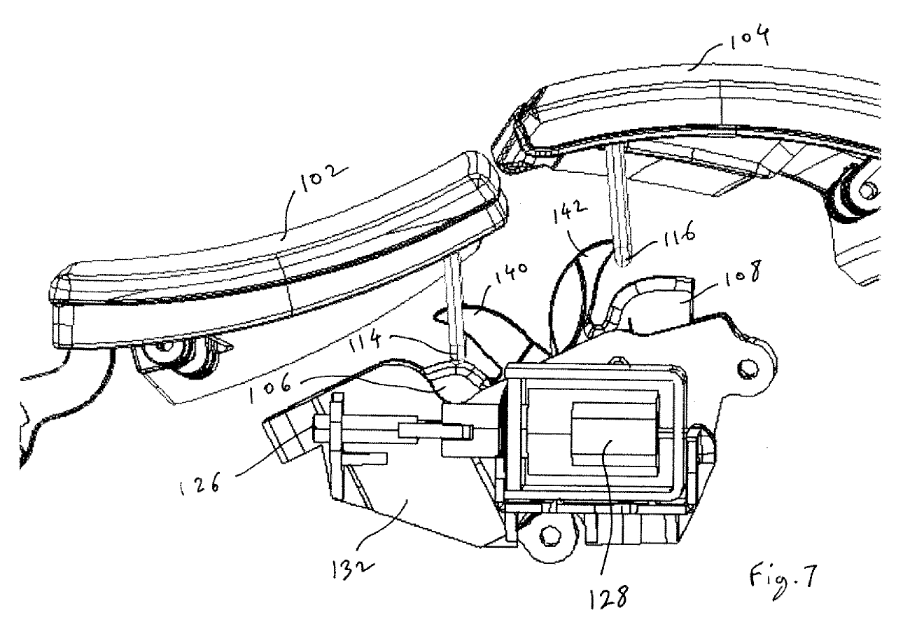

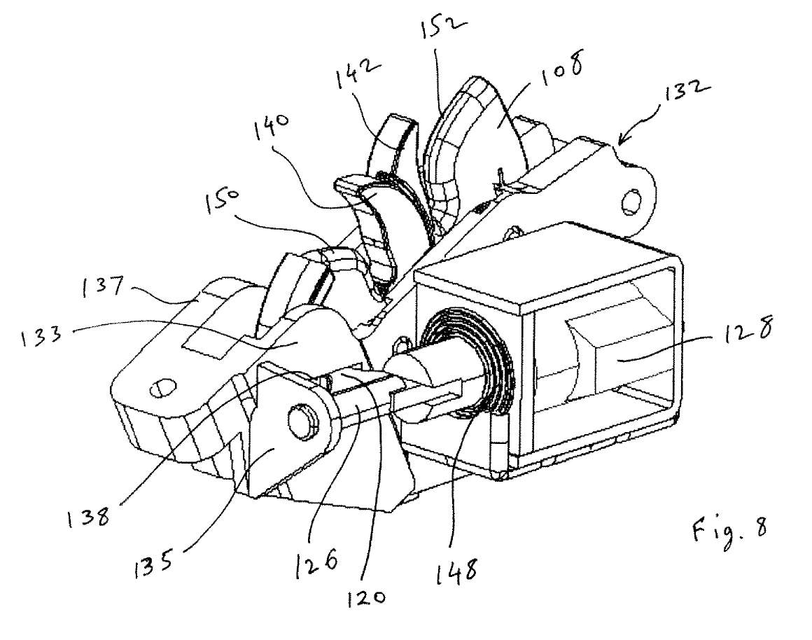

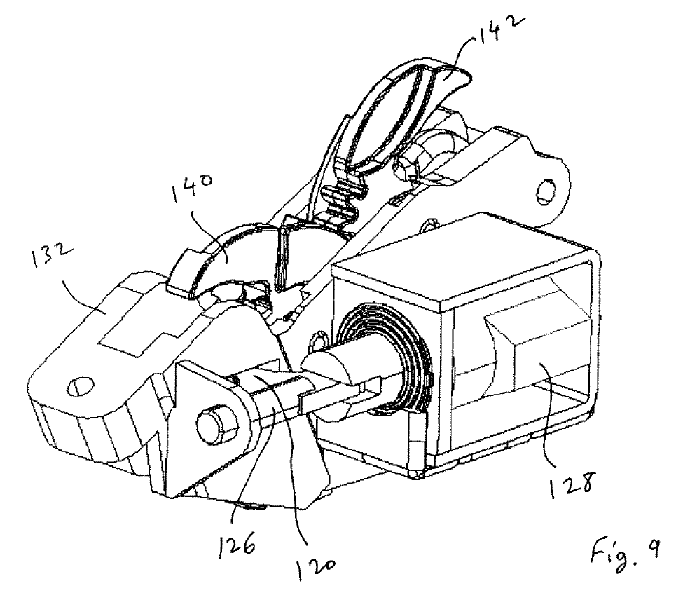

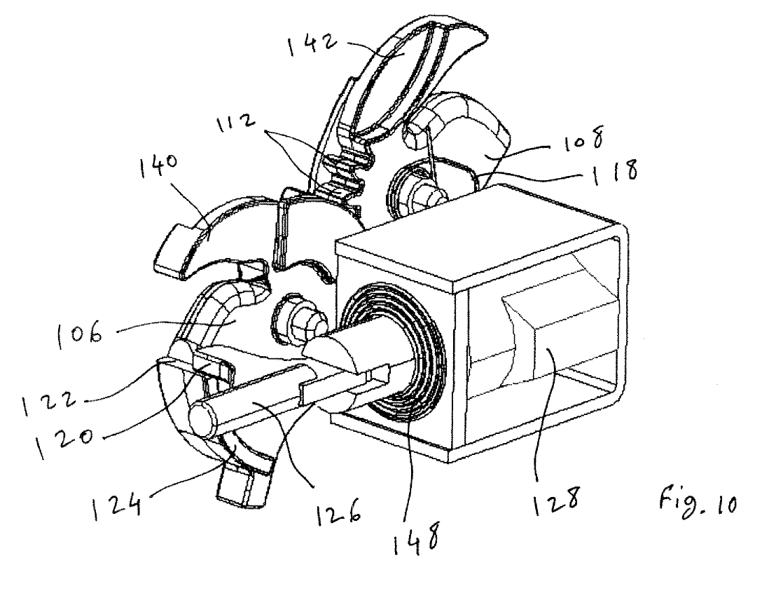

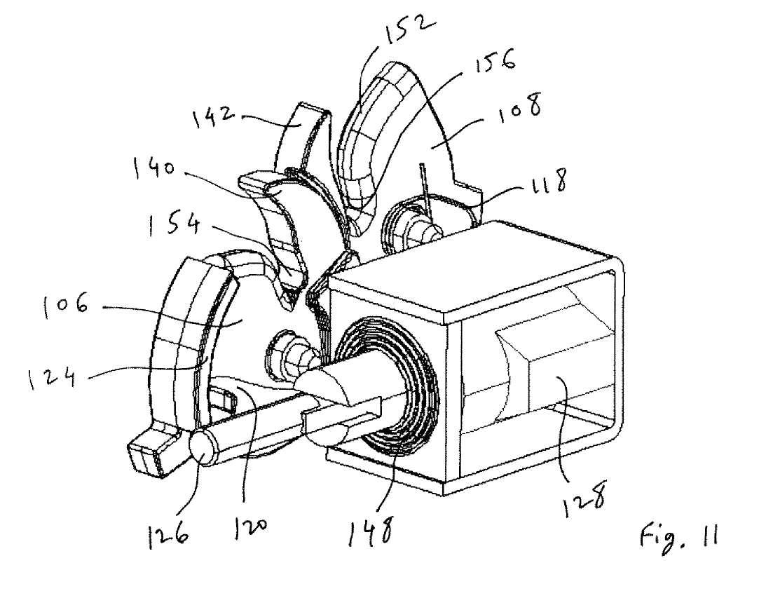

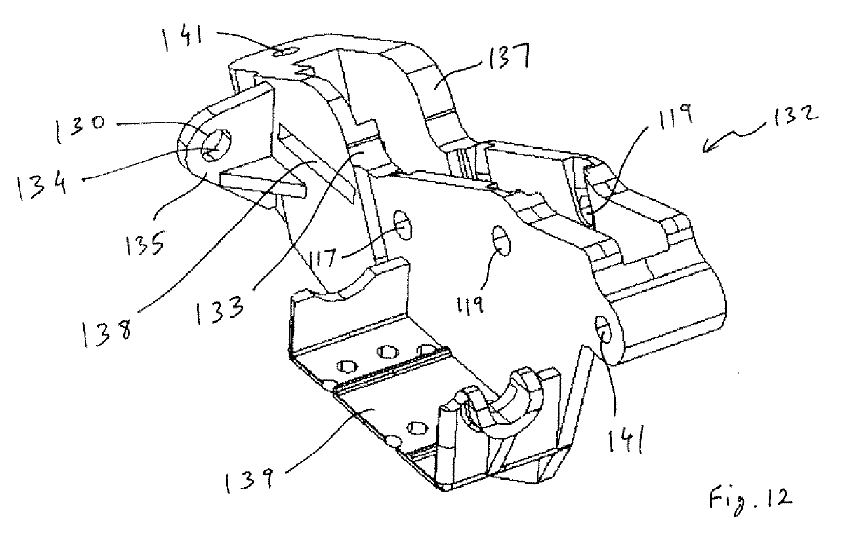

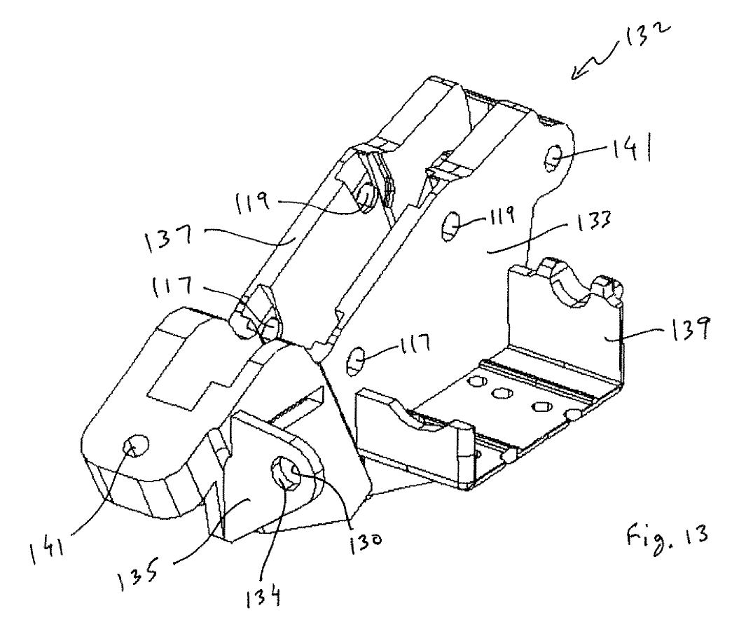

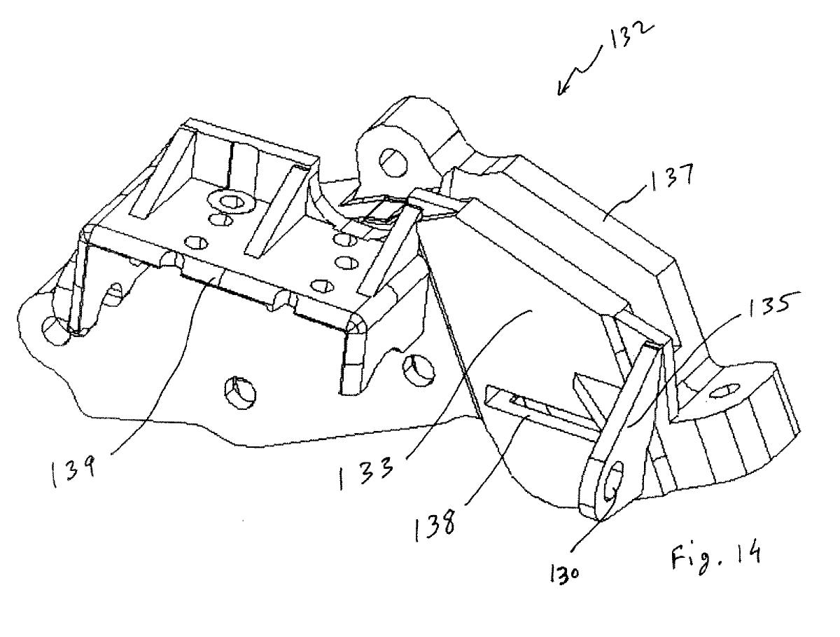

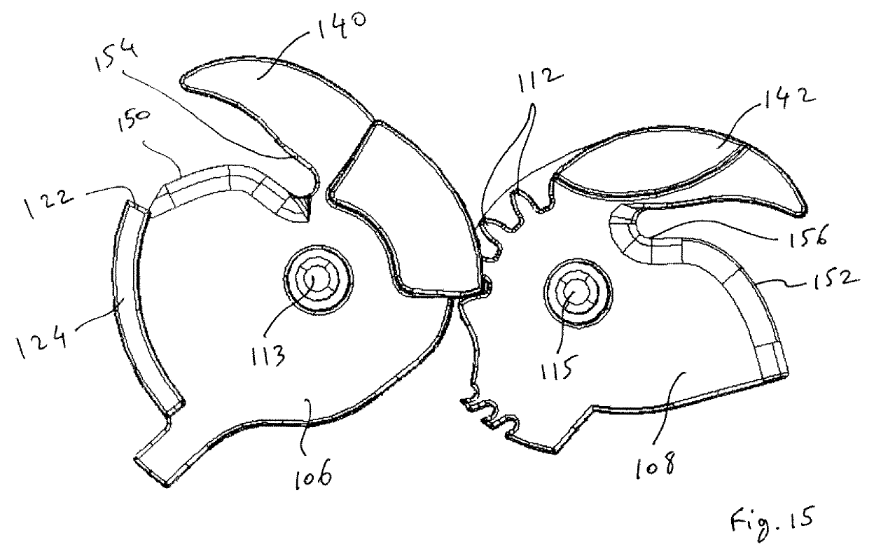

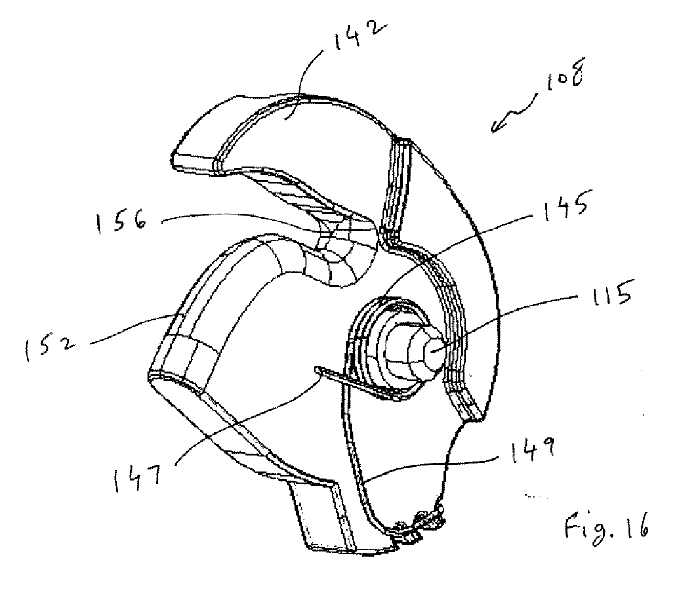

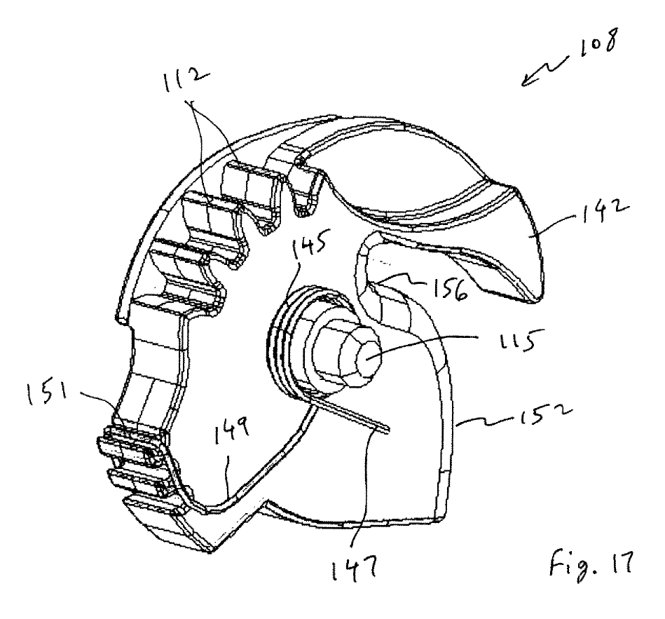

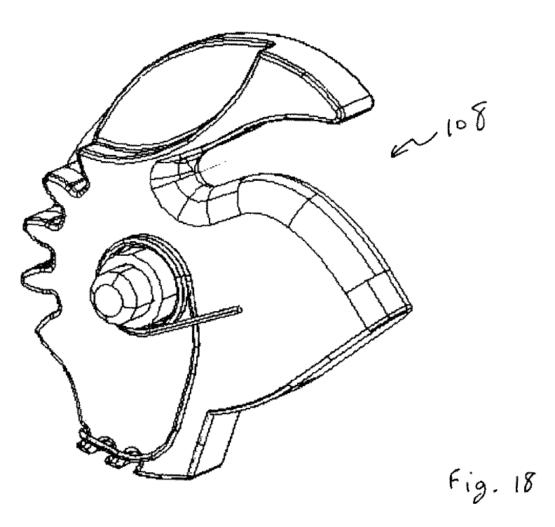

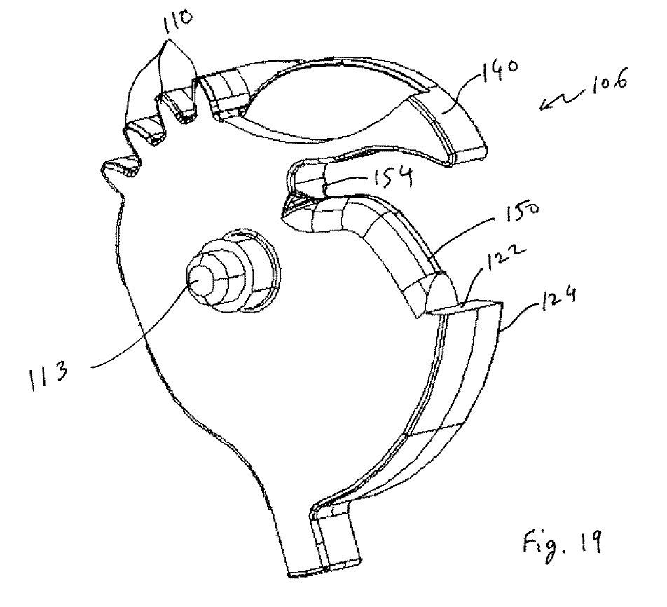

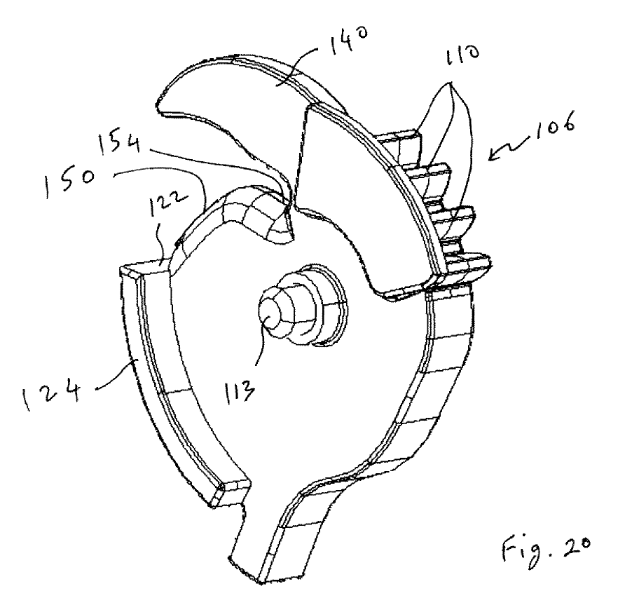

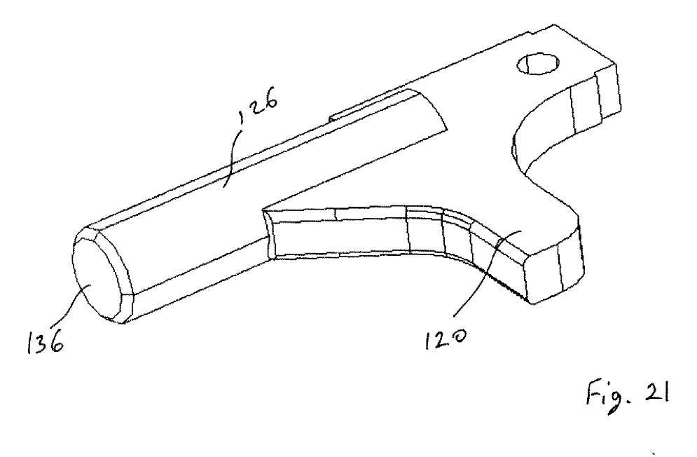

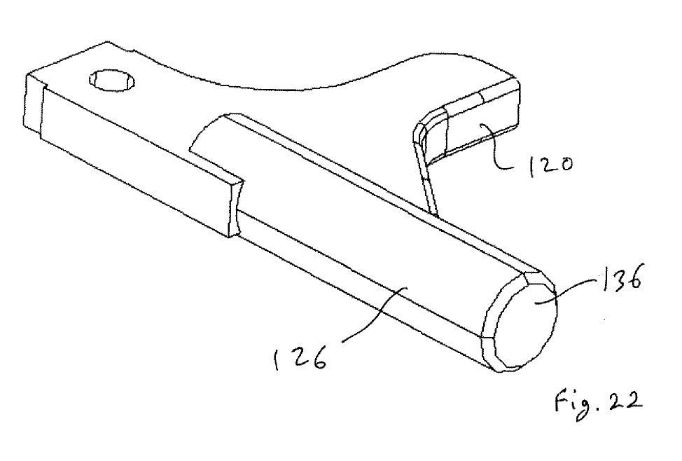

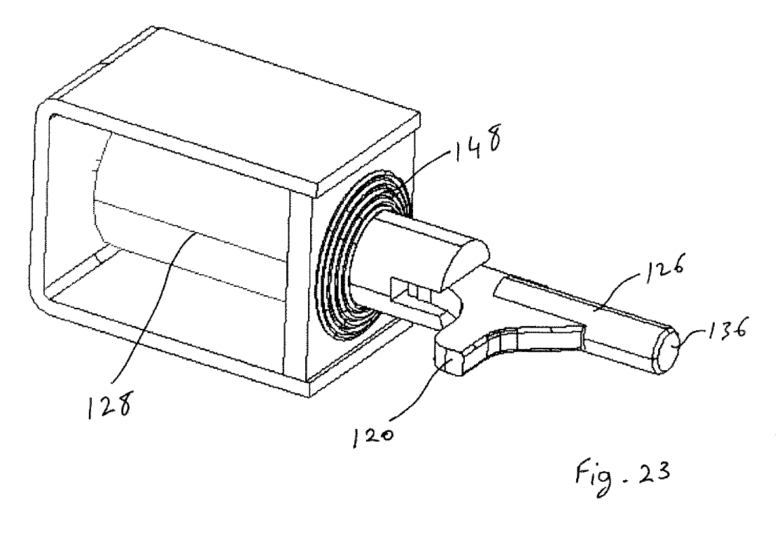

Referring to FIGS. 1-23, a first embodiment of a latch 100 with dual rotary pawls according to the present invention can be seen. The latch 100 is a solenoid operated latch designed to lock two doors 102 and 104 simultaneously, using two rotating pawls 106 and 108, and is situated between the pivots or hinges of the doors 102, 104 with the pawls 106, 108 rotating in the same plane. The pawls 106, 108 are provided with gear teeth 110, 112, respectively that are in mesh together and cause the pawls 106, 108 to rotate in opposite directions to latch and unlatch their respective striker rods 114 and 116. Therefore only one torsion spring 118 is required to bias both pawls 106, 108 toward their unlatched positions. Furthermore, only one locking bar 120 is required for keeping both pawls in the latched position, because once the locking bar 120 engages one of the pawls 106, 108 to retain that pawl in the latched position, the other pawl will also be retained in the latched position through the engagement of the gear teeth 110, 112. In the illustrated example, the locking bar 120 engages the pawl 106, and the torsion spring 118 is in contact with the pawl 108 such that the biasing force of the torsion spring 118 is exerted directly against the pawl 108. The locking bar 120 is rectilinearly movable between engaged and disengaged positions. In the engaged position the locking bar 120 engages the step 122 formed by the projecting, peripheral wall 124, when the pawl 106 is in the latched position, to maintain the pawl 106, and consequently the pawl 108, in their latched positions. In the disengaged position the locking bar 120 disengages from the step 122 thereby freeing the pawls 106, 108 to rotate to their respective unlatched positions under the biasing force of the torsion spring 118. The peripheral wall 124 projects out from a portion of the periphery of the pawl 106 in a direction parallel to the axis of rotation of the pawl 106. As the pawl 108 rotates to the unlatched position due to the biasing force exerted on the pawl 108 by the torsion spring 118, the gear teeth 110, 112 being in mesh, the pawl 106 also rotates to its unlatched position. The locking bar 120 is attached to the operating rod 126, which is in turn attached to the solenoid 128. The solenoid 128 is supported by the housing 132. The locking bar 120 moves rectilinearly between the engaged position and the disengaged position in response to the rectilinear movement of the operating rod 126 between a first position corresponding to the engaged position of the locking bar 120 and a second position corresponding to the disengaged position of the locking bar 120. The operating rod 126 is guided in its rectilinear movement by the hole 130 in the housing 132. The annular wall 134 that defines the perimeter of the hole 130 provides a bearing surface that movably supports the operating rod 126 intermediate the locking bar 120 and the end 136 of the operating rod 126 that is distal from the solenoid 128. The locking bar 120 is positioned to extend through a slot 138 provided in the housing 132. The operating rod 126 and the pawl 106 are positioned on opposite sides of the slot 138 and the slot 138 allows the locking bar 120 to have access to the pawl 106. The slot 138 is long enough to allow sufficient clearance to at least accommodate the range of movement of the locking bar 120 between the engaged position and the disengaged position without interference from any part of the housing 132. The slot 138 also aids in guiding the rectilinear movement of the locking bar 120 and of the operating rod 126.

The housing 132 is in the form of a main plate 133 having a second plate 135 attached thereto. The second plate 135 is perpendicular to the main plate 133. The solenoid 128 is supported on one side of the main plate 133 and the pawls 106, 108 are rotationally supported on the other side of the main plate 133. The slot 138 is formed in the plate 133. The hole 130 is formed in the plate 135. A third plate 137 is supported by the main plate 133 such that the plate 137 is parallel to but spaced apart from plate 133. The pawls 106, 108 are rotationally supported intermediate the plates 133 and 137 with the axis of rotation of each pawl being perpendicular to each of the plates 133 and 137. The axis of rotation of each pawl 106, 108 is parallel to and spaced apart from the axis of rotation of the other pawl. A solenoid support bracket 139 is provided on the side of the plate 133 opposite the side of the plate 133 on which the pawls 106, 108 are located. The housing 132 is also provided with mounting holes 141 for attachment of the latch 100 near the opening of the compartment secured by the doors 102, 104.

The pawl 106 is rotationally supported through the engagement of half shafts 113 with holes 117 for receiving the half shafts 113 provided in the housing 132. The half shafts 113 project outward from either side of the pawl 106. The pawl 108 is rotationally supported through the engagement of half shafts 115 with holes 119 for receiving the half shafts 115 provided in the housing 132. The half shafts 115 project outward from either side of the pawl 108. The torsion spring 118 has two coiled portions 145 each of which surrounds a respective half shaft 115. Extending from each coiled portion 145 is a first spring arm 147 and a second spring arm 149. The ends of the first spring arms 147 located distally from the respective coiled portion 145 are fixedly located relative to the housing 132. The ends of the second spring arms 149 located distally from the respective coiled portion 145 are connected by a cross bar 151. The cross bar 151 is engaged to a notch 153 formed in the pawl 108. Thus, ends of the second spring arms 149 located distally from the respective coiled portion 145 are fixedly located relative to the pawl 108.

In the unlatched position the pawl claws 140, 142, respectively, of both pawls 106, 108 are positioned, due to the biasing force of the torsion spring 118, such that the pawl claws 140, 142 point upward and are out of the way of the striker rods 114 and 116 as the doors 102, 104 move toward the closed position relative to the compartment opening. Each of the striker rods 114, 116 is in the form of an elongated rod supported at a distance from the interior surface of the respective door 102, 104, by legs extending from each end of the striker rod to the interior surface of the respective door. The return spring 148 of the de-energized solenoid pushes the locking bar 120 against the inner circumference of the peripheral wall 124 of the pawl 106 when the pawl 106 is not in the latched position. As the doors 102, 104 move toward their closed positions, the striker rods 114, 116 are bought into contact with the cam surfaces 150 and 152 of the pawls 106 and 108, respectively. Each of the pawls 106 and 108 is rotationally supported by the housing 132 such that each pawl rotates about its own axis of rotation. The contact point between each striker rod 114, 116 and the cam surface 150, 152 of the respective pawl 106, 108, and the path of each striker rod 114, 116, are offset from the axis of rotation of the respective pawl 106, 108. Therefore, as each striker rod 114, 116 impacts the respective cam surface 150, 152 due to the movement of the doors 102, 104 toward their closed positions, a torque tending to rotate the respective pawl 106, 108 toward the latched position is exerted by each striker rod 114, 116 on its respective pawl 106, 108. As a result, each pawl 106, 108 is rotated to its latched position due to the movement of the doors 102, 104 toward their closed positions. As each of the pawls 106, 108 rotates to its respective latched position due to the closing of the doors 102, 104, the claw 140, 142 of each pawl 106, 108 hooks around the respective striker rod 114, 116. Once the pawl 106 completes its rotation to its latched position, the locking bar 120 moves to the engaged position under the bias of the spring 148. In the engaged position the locking bar 120 is positioned over the step 122 to thereby prevent the rotation of the pawls 106, 108 out of their latched positions. Thus, the locking bar 120 holds the latch 100 in the latched configuration with the claws 140, 142 hooked around the striker rods 114, 116, respectively, and thereby secures the doors 102, 104 in the closed position.

When the pawl 106 is not in the latched position, but is at least very near the latched position, the locking bar 120 is maintained in the disengaged position by the peripheral wall 124. The locking bar 120 slides against the inner circumference of the peripheral wall 124 of the pawl 106 when the pawl 106 is not in the latched position.

To open the latch 100 the solenoid is energized. Energizing the solenoid 128 causes the operating rod 126 and the locking bar 120 to be retracted toward the solenoid 128 such that the locking bar 120 is moved to the disengaged position. Thus, energizing the solenoid 128 pulls the locking bar 120 clear of the step 122 and allows the pawls 106, 108 to rotate to their unlatched positions under spring force. The locking bar 120 will then come to rest against the inner circumference of the peripheral wall 124 of the pawl 106 when the solenoid 128 is de-energized. The striker rods 114, 116 are then free to move away from the latch 100, thus allowing the doors 102, 104 to be opened. As the pawls 106, 108 are geared to each other, they will move to the unlatched and latched positions together, irrespective of whether both striker rods 114, 116 are in contact with the cam surfaces 150, 152 of the pawls 106, 108. Each claw 140, 142 is spaced apart from the cam surface 150, 152 of the respective pawl 106, 108 such that each claw 140, 142 and the respective cam surface 150, 152 cooperatively define a respective pawl slot 154, 156. The striker rods 114, 116 are received in the pawl slots 154, 156, respectively, when the pawls 106, 108 are in the latched position and the doors 102, 104 are secured in the closed position. The pawl slots 154, 156 are wide enough near the tips of the claws 140, 142 such that even if only one of the striker rods 114, 116 contacts the respective cam surface 150, 152 of its respective pawl 106, 108 and the other striker rod lags the striker rod that is in contact with its respective cam surface, the lagging striker rod can be hooked and pulled into position by the claw 140, 142 of its respective pawl 106, 108 to allow the doors 102 and 104 to be secured in the closed position essentially simultaneously. By essentially simultaneous it is meant that there will be no lag between the securing of the door 102 and the securing of the door 104 in their closed positions that will be perceptible to a user during normal use. The achievement of this result is further facilitated by providing for the pawl slots 154, 156 to be tapering such that they are widest near the tips of the claws 140, 142 and become gradually narrower closer to the closed bottom of the pawl slot. With this geometry once the lagging striker rod is hooked by the respective pawl claw 140, 142, the lagging rod is accelerated such that the lagging rod catches up to the other rod as the pawls 106, 108 rotate to their latched positions. The doors 102 and 104 are linked by a mechanism (not shown) such that moving one door to the closed position also moves the other door to the closed position. If the doors 102, 104 are being closed by pushing either door by itself, the accumulation of play in the mechanism linking the doors results in one striker rod 114 or 116 lagging behind the other striker rod. In the illustrated example, the claws 140, 142 of the pawls 106, 108 are designed to hook and pull in their respective striker rod if it lags behind the other such that when the leading striker rod makes contact with its respective pawl the lagging striker rod can be out of the position where it would have made contact with its respective pawl by up to a distance of 5 mm. If the doors 102, 104 are being closed by pushing either door by itself, the striker rod of the door that is being pushed by the user will usually lead and the striker rod of the door that is being closed through the action of the linking mechanism will usually lag behind its nominal position. By nominal position it is meant the position the striker rod would have been in had both doors been pushed toward their closed positions in a synchronized manner by the user such that the striker rods would contact their respective pawls simultaneously.

The latch 100 can also be used in applications where the doors 102 and 104 are not symmetrical. For example, the distance between one striker rod and the hinge axis of its respective door may be greater than the distance between the other striker rod and the hinge axis of its respective door. This would result in the striker rods moving at different speeds as the doors move to their closed positions. The ratio of the speeds of rotation of the pawls 106, 108 can be selected to correspond to the ratio of the speeds of the striker rods 114, 116 by properly selecting the gear ratio between the pawls 106 and 108. In addition, a difference in speed of the striker rods can arise where the mechanism linking the doors 102 and 104 causes the doors 102 and 104 to rotate at different speeds such as when the range of motion of the doors are different by design. Again regardless of how the difference in speed of the striker rods arises, the gear ratio between the pawls 106, 108 can be changed, through selection of pawls having the desired gear ratio, to accommodate the difference in speed between the striker rods 114 and 116. In the illustrated example, the gear ratio between the pawls 106 and 108 is 3:2, since the angular speed of the door 102 is 1.5 times greater than the angular speed of the door 104. The difference in angular speed of the doors 102 and 104 is a function of the mechanism linking the doors in the illustrated application.

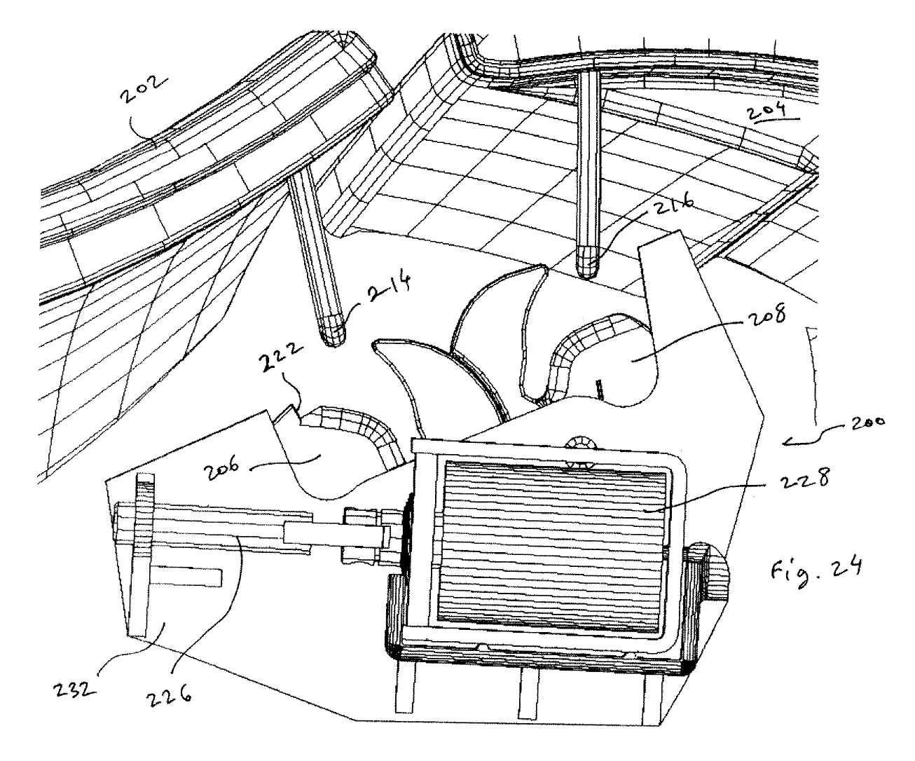

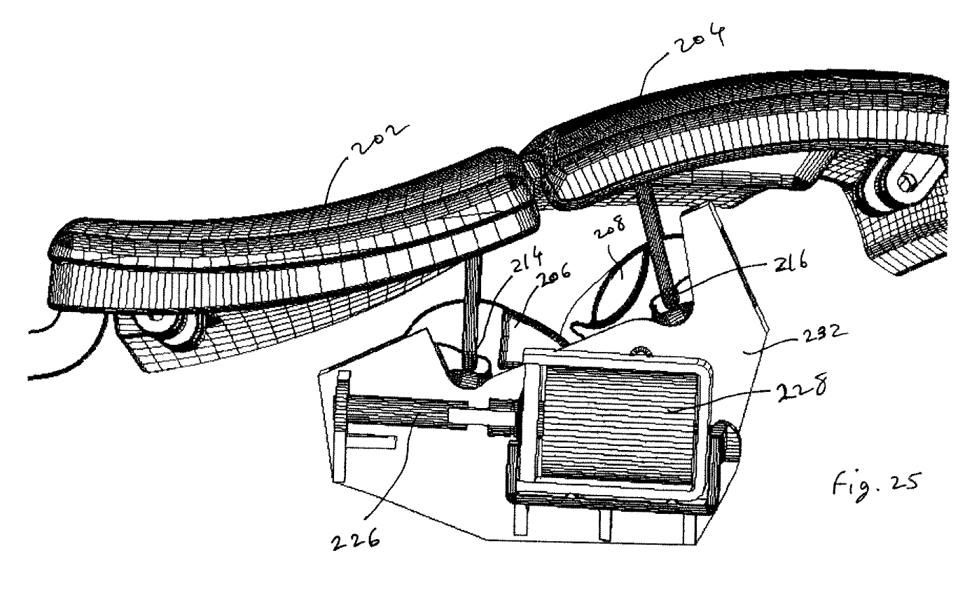

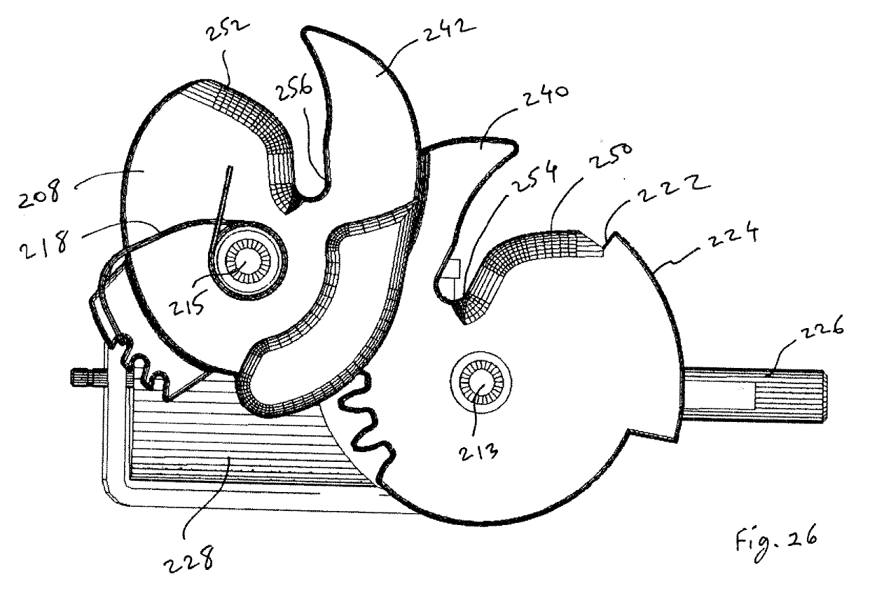

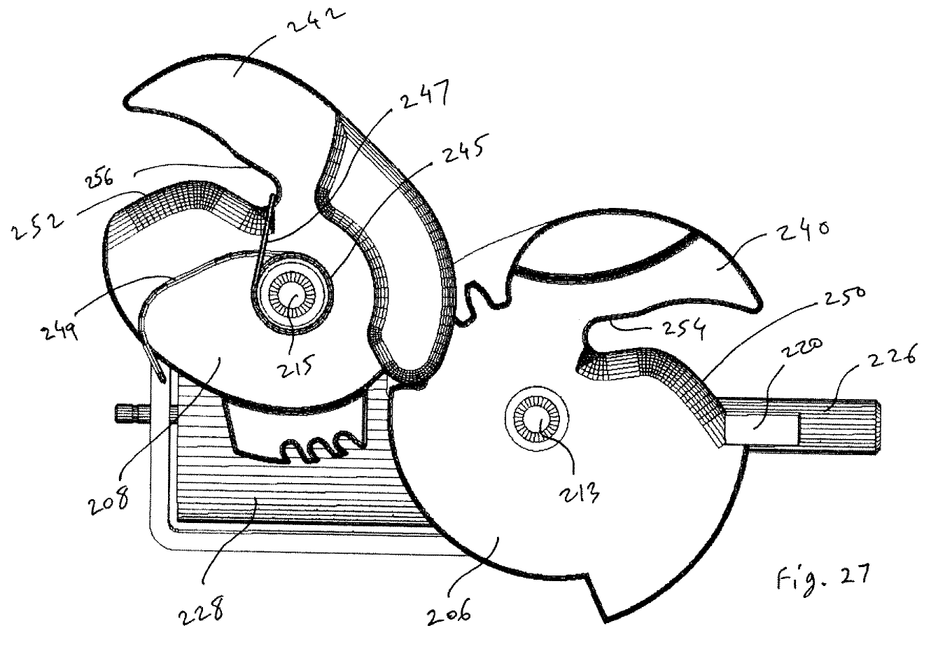

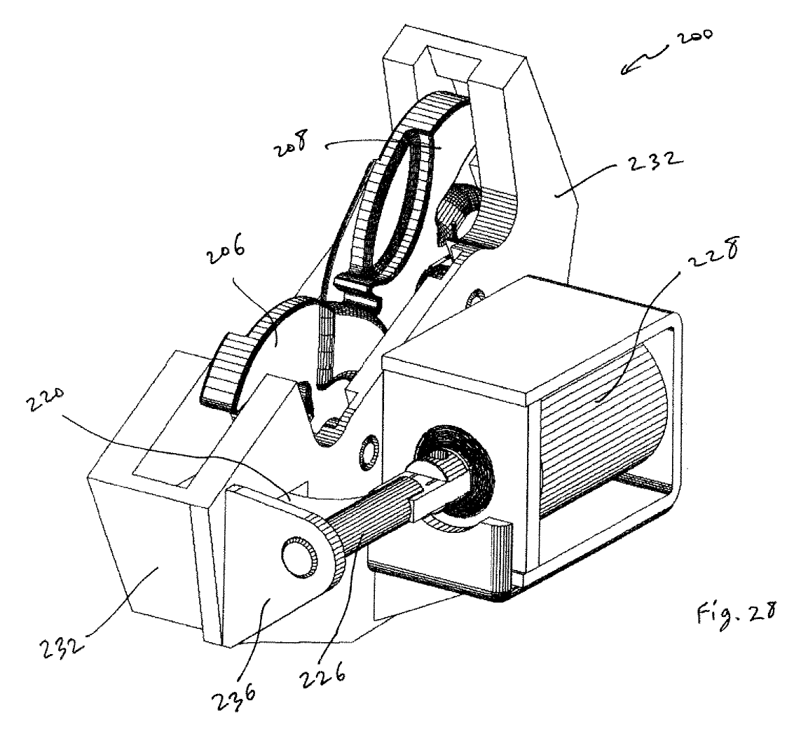

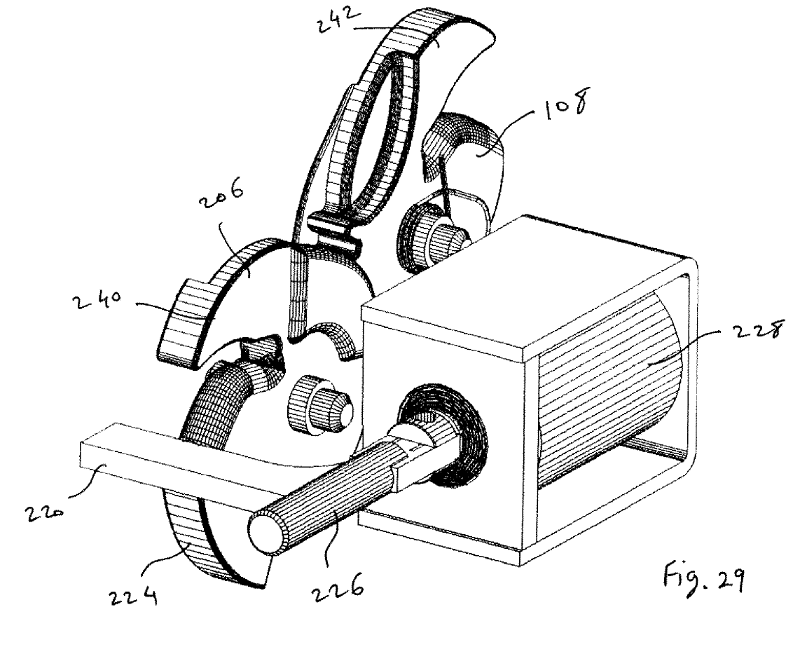

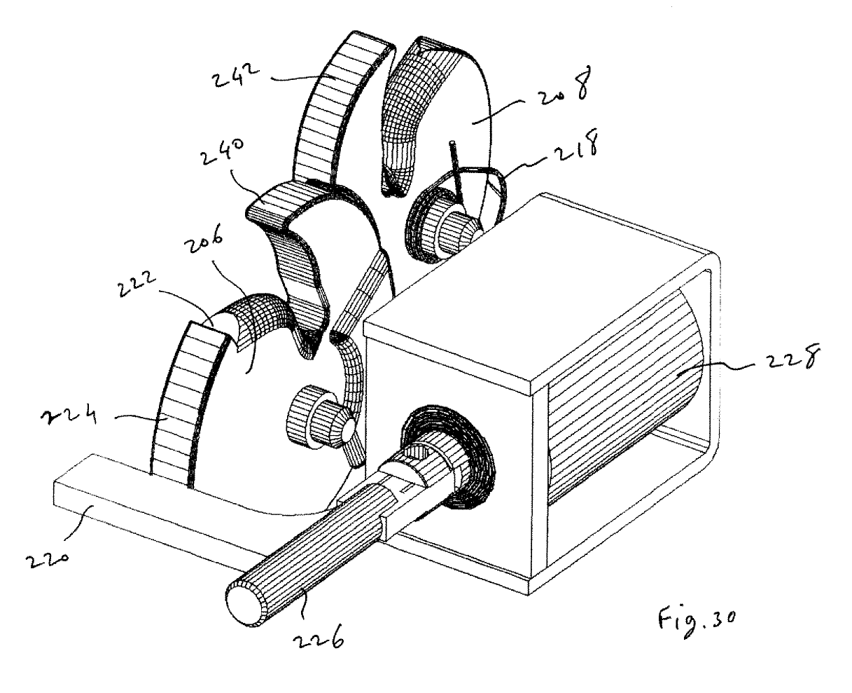

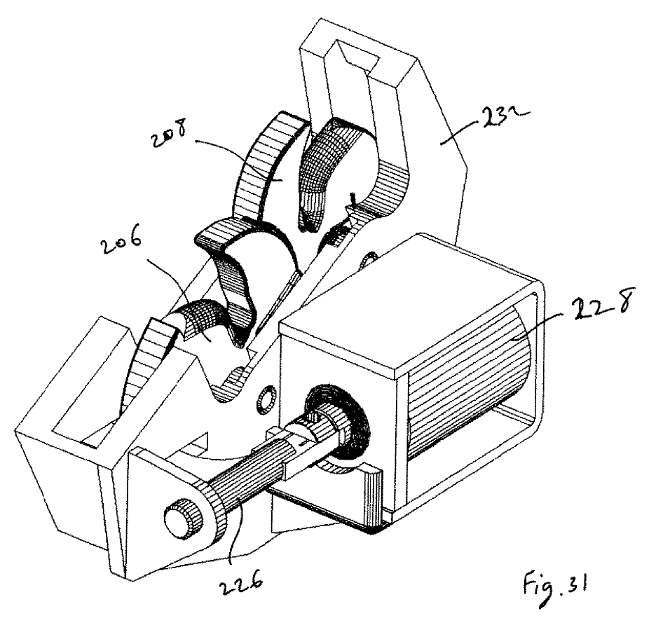

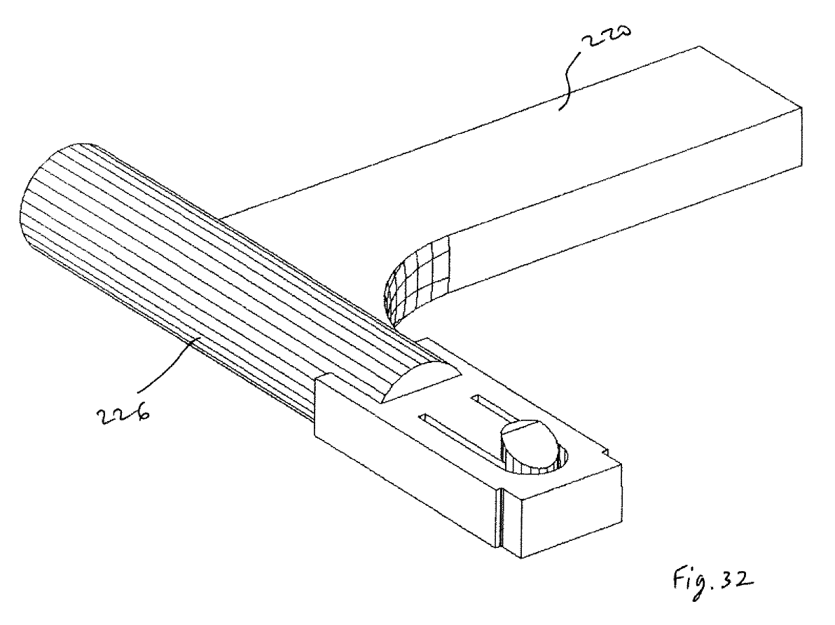

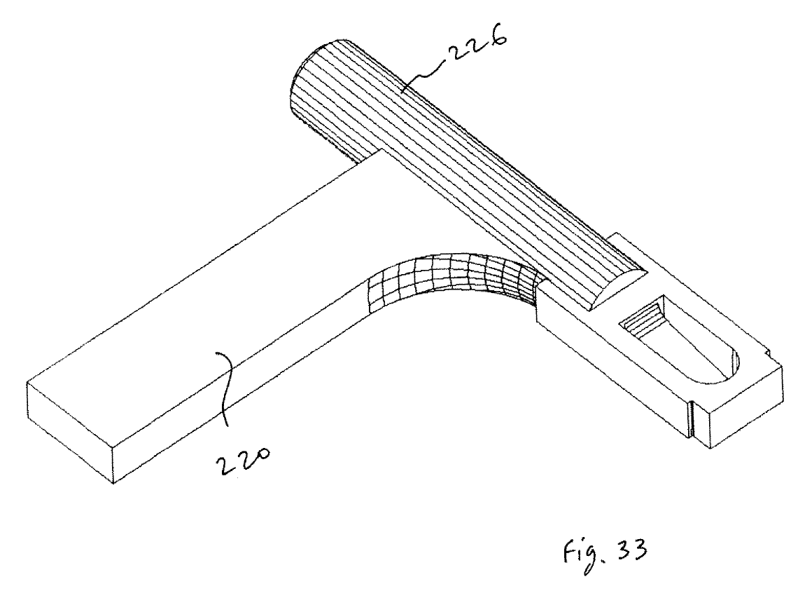

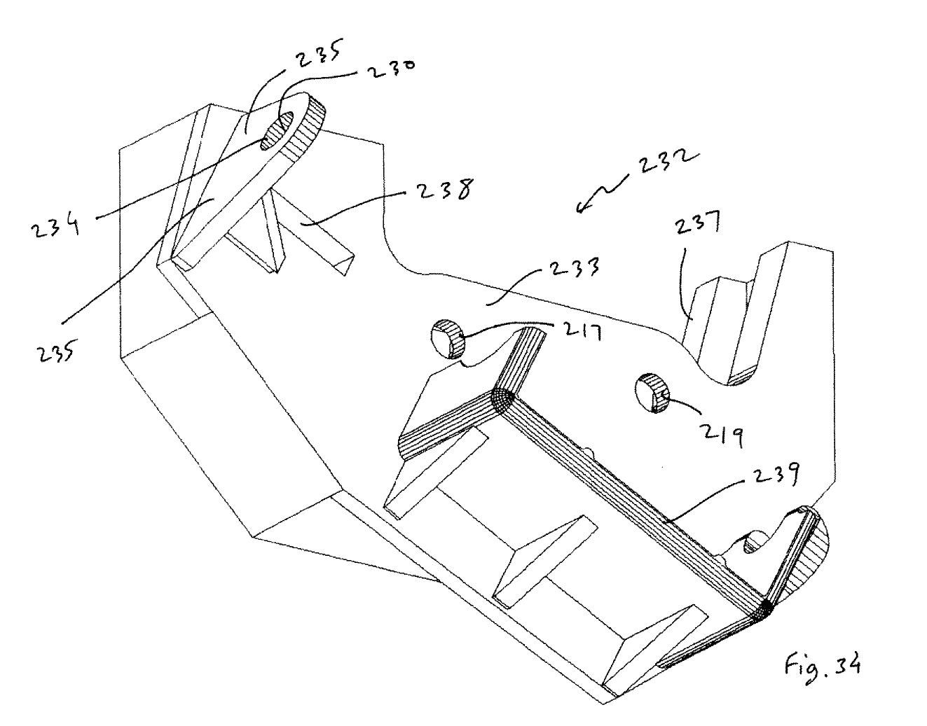

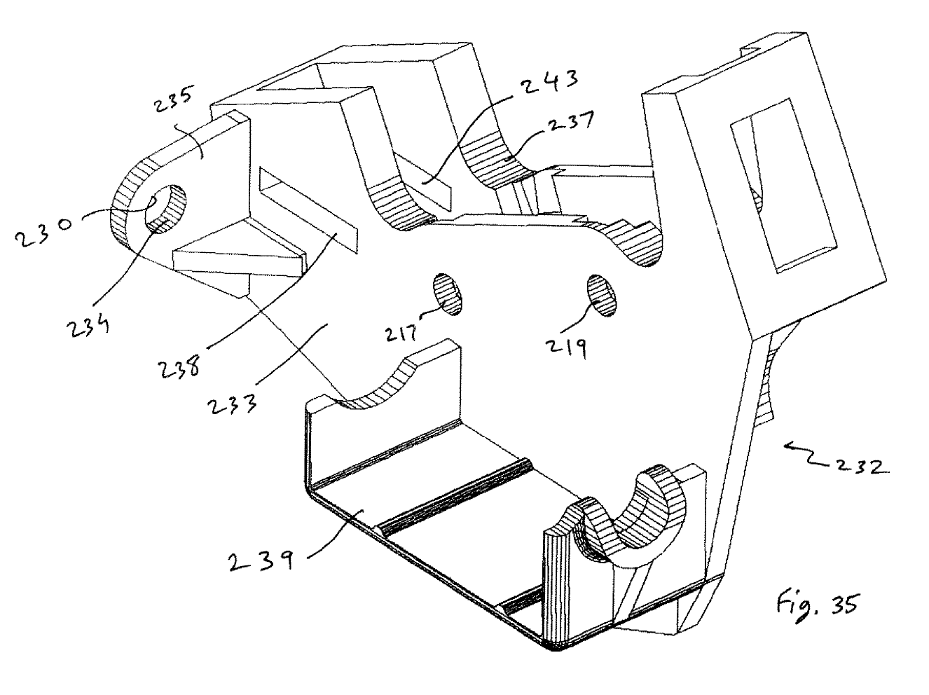

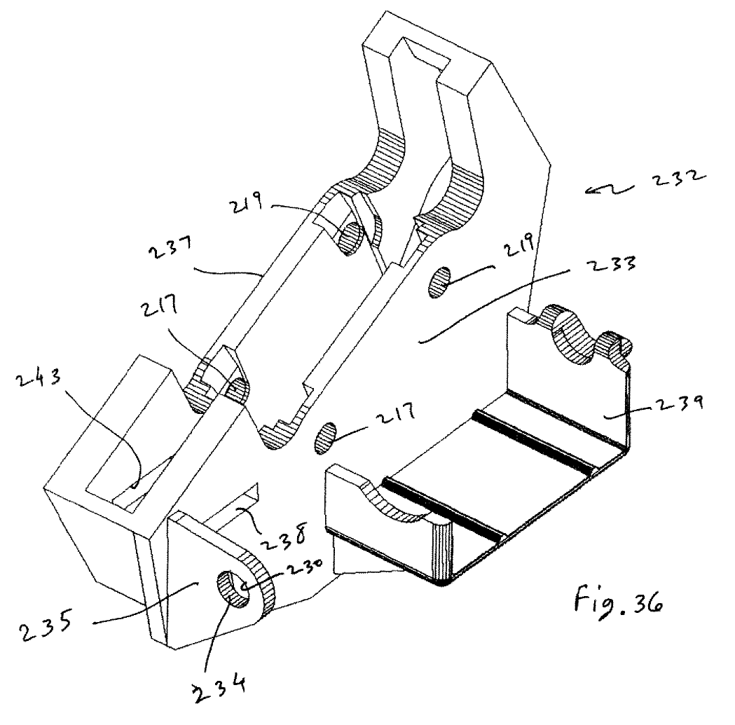

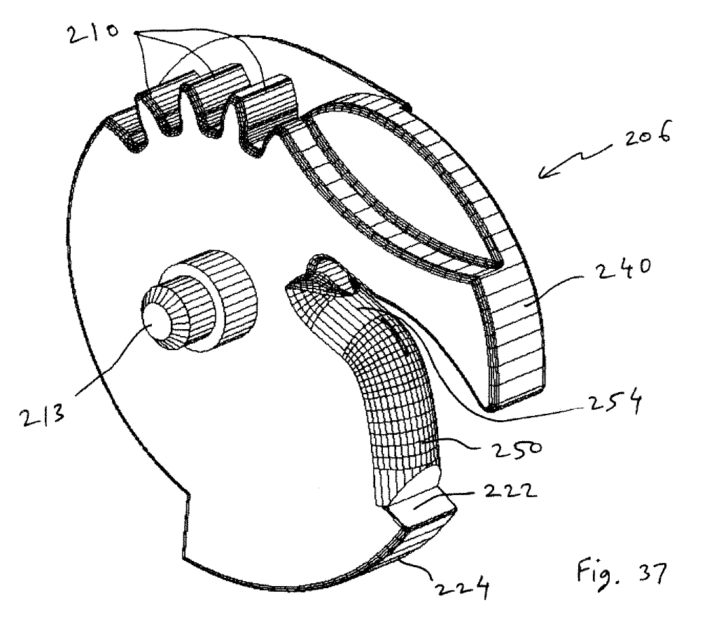

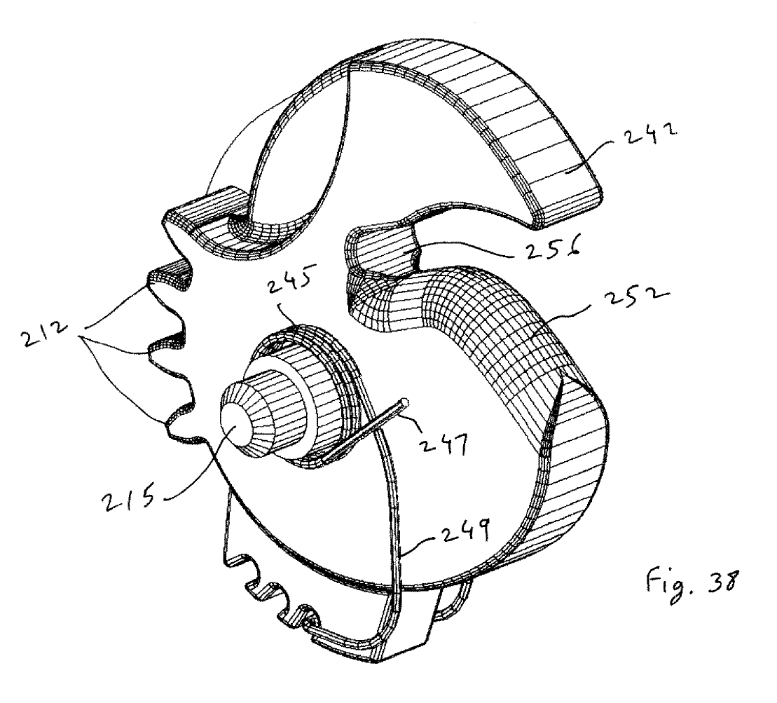

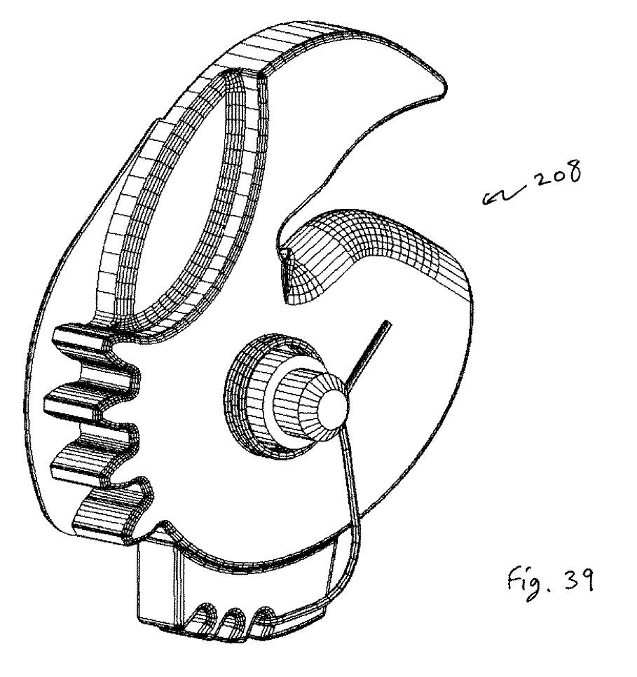

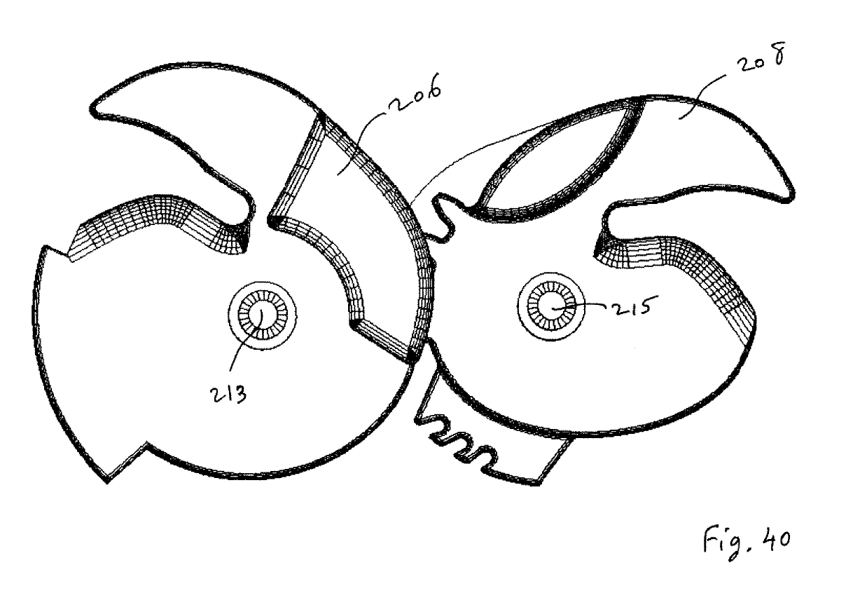

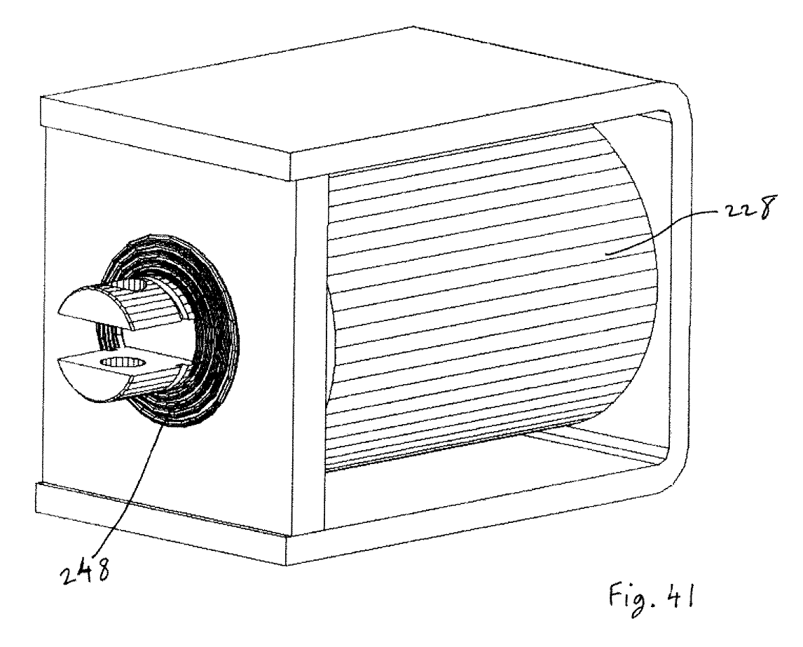

Referring to FIGS. 24-41, a second embodiment of a latch 200 with dual rotary pawls according to the present invention can be seen. The latch 200 is a solenoid operated latch designed to lock two doors 202 and 204 simultaneously, using two rotating pawls 206 and 208, and is situated between the pivots or hinges of the doors 202, 204 with the pawls 206, 208 rotating in the same plane. The pawls 206, 208 are provided with gear teeth 210, 212, respectively that are in mesh together and cause the pawls 206, 208 to rotate in opposite directions to latch and unlatch their respective striker rods 214 and 216. Therefore only one torsion spring 218 is required to bias both pawls 206, 208 toward their unlatched positions. Furthermore, only one locking bar 220 is required for keeping both pawls in the latched position, because once the locking bar 220 engages one of the pawls 206, 208 to retain that pawl in the latched position, the other pawl will also be retained in the latched position through the engagement of the gear teeth 210, 212. In the illustrated example, the locking bar 220 engages the pawl 206, and the torsion spring 218 is in contact with the pawl 208 such that the biasing force of the torsion spring 218 is exerted directly against the pawl 208. The locking bar 220 is rectilinearly movable between engaged and disengaged positions. In the engaged position the locking bar 220 engages the step or notch 222 formed in the pawl 206, when the pawl 206 is in the latched position, to maintain the pawl 206, and consequently the pawl 208, in their latched positions. In the disengaged position the locking bar 220 disengages from the step 222 thereby freeing the pawls 206, 208 to rotate to their respective unlatched positions under the biasing force of the torsion spring 218. As the pawl 208 rotates to the unlatched position due to the biasing force exerted on the pawl 208 by the torsion spring 218, the gear teeth 210, 212 being in mesh, the pawl 206 also rotates to its unlatched position. The locking bar 220 is attached to the operating rod 226, which is in turn attached to the solenoid 228. The solenoid 228 is supported by the housing 232. The locking bar 220 moves rectilinearly between the engaged position and the disengaged position in response to the rectilinear movement of the operating rod 226 between a first position corresponding to the engaged position of the locking bar 220 and a second position corresponding to the disengaged position of the locking bar 220. The operating rod 226 is guided in its rectilinear movement by the hole 230 in the housing 232. The annular wall 234 that defines the perimeter of the hole 230 provides a bearing surface that movably supports the operating rod 226 intermediate the locking bar 220 and the end 236 of the operating rod 226 that is distal from the solenoid 228. The locking bar 220 is positioned to extend through a slot 238 provided in the housing 232. The operating rod 226 and the pawl 206 are positioned on opposite sides of the slot 238 and the slot 238 allows the locking bar 220 to have access to the pawl 206. The slot 238 is long enough to allow sufficient clearance to at least accommodate the range of movement of the locking bar 220 between the engaged position and the disengaged position without interference from any part of the housing 232. The slot 238 also aids in guiding the rectilinear movement of the locking bar 220 and of the operating rod 226.

The housing 232 is in the form of a main plate 233 having a second plate 235 attached thereto. The second plate 235 is perpendicular to the main plate 233. The solenoid 228 is supported on one side of the main plate 233 and the pawls 206, 208 are rotationally supported on the other side of the main plate 233. The slot 238 is formed in the plate 233. The hole 230 is formed in the plate 235. A third plate 237 is supported by the main plate 233 such that the plate 237 is parallel to but spaced apart from plate 233. The pawls 206, 208 are rotationally supported intermediate the plates 233 and 237 with the axis of rotation of each pawl being perpendicular to each of the plates 233 and 237. The axis of rotation of each pawl 206, 208 is parallel to and spaced apart from the axis of rotation of the other pawl. A solenoid support bracket 239 is provided on the side of the plate 233 opposite the side of the plate 233 on which the pawls 206, 208 are located. The housing 232 is also provided with mounting holes 241 for attachment of the latch 200 near the opening of the compartment secured by the doors 202, 204. The third plate 237 is provided with a slot 243 that registers with and is coextensive with the slot 238. The locking bar 220 preferably extends through both the slots 238 and 243 such that the locking bar 220 is mechanically supported near both ends for added strength.

The pawl 206 is rotationally supported through the engagement of half shafts 213 with holes 217 for receiving the half shafts 213 provided in the housing 232. The half shafts 213 project outward from either side of the pawl 206. The pawl 208 is rotationally supported through the engagement of half shafts 215 with holes 219 for receiving the half shafts 215 provided in the housing 232. The half shafts 215 project outward from either side of the pawl 208. The torsion spring 218 has two coiled portions 245 each of which surrounds a respective half shaft 215. Extending from each coiled portion 245 is a first spring arm 247 and a second spring arm 249. The ends of the first spring arms 247 located distally from the respective coiled portion 245 are fixedly located relative to the housing 232. The ends of the second spring arms 249 located distally from the respective coiled portion 245 are connected by a cross bar 251. The cross bar 251 is engaged to a notch 253 formed in the pawl 208. Thus, ends of the second spring arms 249 located distally from the respective coiled portion 245 are fixedly located relative to the pawl 208.

In the unlatched position the pawl claws 240, 242, respectively, of both pawls 206, 208 are positioned, due to the biasing force of the torsion spring 218, such that the pawl claws 240, 242 point upward and are out of the way of the striker rods 214 and 216 as the doors 202, 204 move toward the closed position relative to the compartment opening. Each of the striker rods 214, 216 is in the form of an elongated rod supported at a distance from the interior surface of the respective door 202, 204, by legs extending from each end of the striker rod to the interior surface of the respective door. The return spring 248 of the de-energized solenoid pulls the locking bar 220 against the outer peripheral profile of the pawl 206 extending from the notch 222 in a direction away from the claw 240 for a portion 224 of the outer periphery of the pawl 206 when the pawl 206 is not in the latched position. As the doors 202, 204 move toward their closed positions, the striker rods 214, 216 are bought into contact with the cam surfaces 250 and 252 of the pawls 206 and 208, respectively. Each of the pawls 206 and 208 is rotationally supported by the housing 232 such that each pawl rotates about its own axis of rotation. The contact point between each striker rod 214, 216 and the cam surface 250, 252 of the respective pawl 206, 208, and the path of each striker rod 214, 216, are offset from the axis of rotation of the respective pawl 206, 208. Therefore, as each striker rod 214, 216 impacts the respective cam surface 250, 252 due to the movement of the doors 202, 204 toward their closed positions, a torque tending to rotate the respective pawl 206, 208 toward the latched position is exerted by each striker rod 214, 216 on its respective pawl 206, 208. As a result, each pawl 206, 208 is rotated to its latched position due to the movement of the doors 202, 204 toward their closed positions. As each of the pawls 206, 208 rotates to its respective latched position due to the closing of the doors 202, 204, the claw 240, 242 of each pawl 206, 208 hooks around the respective striker rod 214, 216. Once the pawl 206 completes its rotation to its latched position, the locking bar 220 moves to the engaged position under the bias of the spring 248. In the engaged position the locking bar 220 is positioned over and into the step 222 to thereby prevent the rotation of the pawls 206, 208 out of their latched positions. Thus, the locking bar 220 holds the latch 200 in the latched configuration with the claws 240, 242 hooked around the striker rods 214, 216, respectively, and thereby secures the doors 202, 204 in the closed position.

When the pawl 206 is not in the latched position, but is at least very near the latched position, the locking bar 220 is maintained in the disengaged position by the portion 224 of the outer periphery of the pawl 206. The locking bar 220 slides against and rides the portion 224 of the outer periphery of the pawl 206 when the pawl 206 is not in the latched position.

To open the latch 200 the solenoid is energized. Energizing the solenoid 228 causes the operating rod 226 and the locking bar 220 to be pushed away from the solenoid 228 such that the locking bar 220 is moved to the disengaged position. Thus, energizing the solenoid 228 pushes the locking bar 220 clear of the step 222 and allows the pawls 206, 208 to rotate to their unlatched positions under spring force. The locking bar 220 will then come to rest against the portion 224 of the outer periphery of the pawl 206 when the solenoid 228 is de-energized. The striker rods 214, 216 are then free to move away from the latch 200, thus allowing the doors 202, 204 to be opened. As the pawls 206, 208 are geared to each other, they will move to the unlatched and latched positions together, irrespective of whether both striker rods 214, 216 are in contact with the cam surfaces 250, 252 of the pawls 206, 208. Each claw 240, 242 is spaced apart from the cam surface 250, 252 of the respective pawl 206, 208 such that each claw 240, 242 and the respective cam surface 250, 252 cooperatively define a respective pawl slot 254, 256. The striker rods 214, 216 are received in the pawl slots 254, 256, respectively, when the pawls 206, 208 are in the latched position and the doors 202, 204 are secured in the closed position. The pawl slots 254, 256 are wide enough near the tips of the claws 240, 242 such that even if only one of the striker rods 214, 216 contacts the respective cam surface 250, 252 of its respective pawl 206, 208 and the other striker rod lags the striker rod that is in contact with its respective cam surface, the lagging striker rod can be hooked and pulled into position by the claw 240, 242 of its respective pawl 206, 208 to allow the doors 202 and 204 to be secured in the closed position essentially simultaneously. By essentially simultaneous it is meant that there will be no lag between the securing of the door 202 and the securing of the door 204 in their closed positions that will be perceptible to a user during normal use. The achievement of this result is further facilitated by providing for the pawl slots 254, 256 to be tapering such that they are widest near the tips of the claws 240, 242 and become gradually narrower closer to the closed bottom of the pawl slot. With this geometry once the lagging striker rod is hooked by the respective pawl claw 240, 242, the lagging rod is accelerated such that the lagging rod catches up to the other rod as the pawls 206, 208 rotate to their latched positions. The doors 202 and 204 are linked by a mechanism (not shown) such that moving one door to the closed position also moves the other door to the closed position. If the doors 202, 204 are being closed by pushing either door by itself, the accumulation of play in the mechanism linking the doors results in one striker rod 214 or 216 lagging behind the other striker rod. In the illustrated example, the claws 240, 242 of the pawls 206, 208 are designed to hook and pull in their respective striker rod if it lags behind the other such that when the leading striker rod makes contact with its respective pawl the lagging striker rod can be out of the position where it would have made contact with its respective pawl by up to a distance of 5 mm. If the doors 202, 204 are being closed by pushing either door by itself, the striker rod of the door that is being pushed by the user will usually lead and the striker rod of the door that is being closed through the action of the linking mechanism will usually lag behind its nominal position. By nominal position it is meant the position the striker rod would have been in had both doors been pushed toward their closed positions in a synchronized manner by the user such that the striker rods would contact their respective pawls simultaneously.

The latch 200 can also be used in applications where the doors 202 and 204 are not symmetrical. For example, the distance between one striker rod and the hinge axis of its respective door may be greater than the distance between the other striker rod and the hinge axis of its respective door. This would result in the striker rods moving at different speeds as the doors move to their closed positions. The ratio of the speeds of rotation of the pawls 206, 208 can be selected to correspond to the ratio of the speeds of the striker rods 214, 216 by properly selecting the gear ratio between the pawls 206 and 208. In addition, a difference in speed of the striker rods can arise where the mechanism linking the doors 202 and 204 causes the doors 202 and 204 to rotate at different speeds such as when the range of motion of the doors are different by design. Again regardless of how the difference in speed of the striker rods arises, the gear ratio between the pawls 206,208 can be changed, through selection of pawls having the desired gear ratio, to accommodate the difference in speed between the striker rods 214 and 216. In the illustrated example, the gear ratio between the pawls 206 and 208 is 3:2, since the angular speed of the door 202 is 1.5 times greater than the angular speed of the door 204. The difference in angular speed of the doors 202 and 204 is a function of the mechanism linking the doors in the illustrated application.

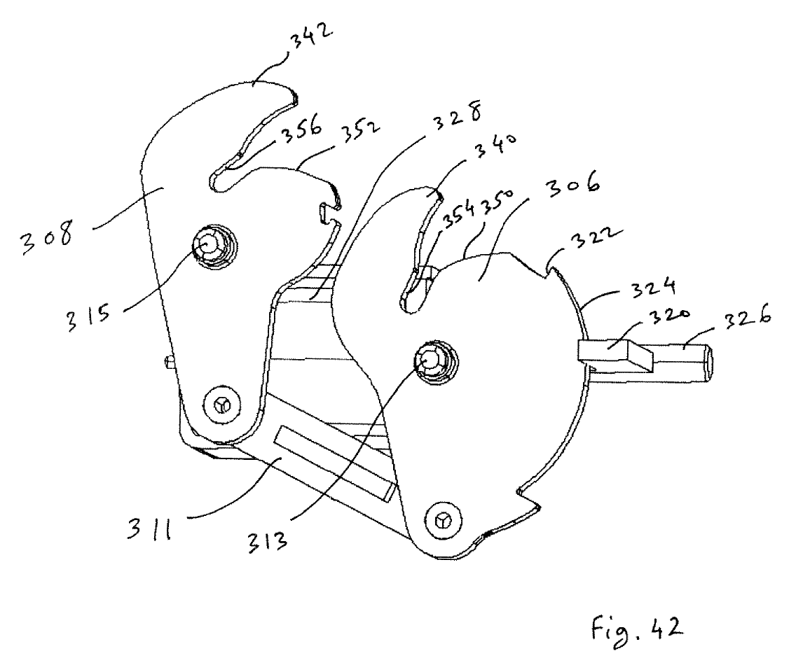

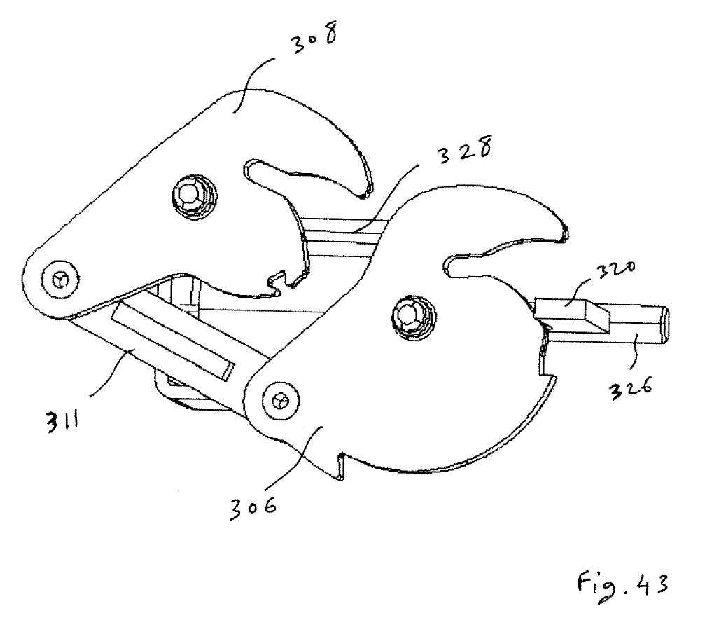

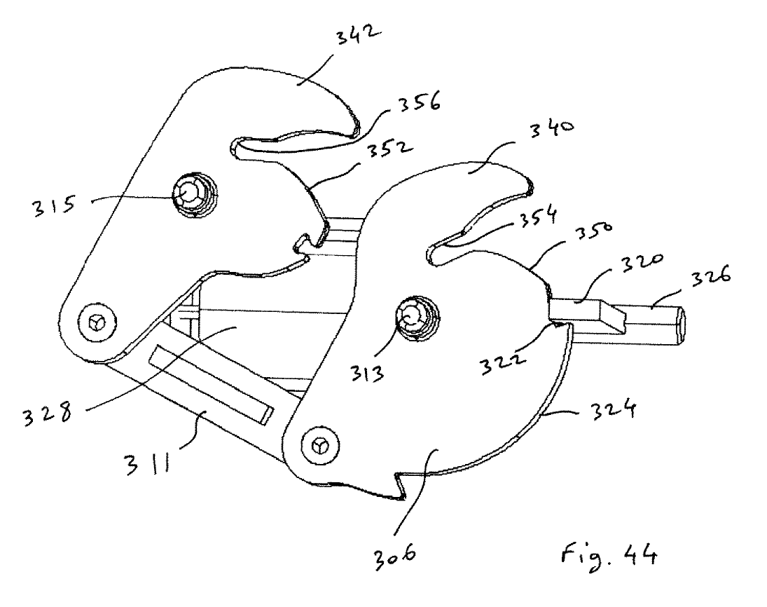

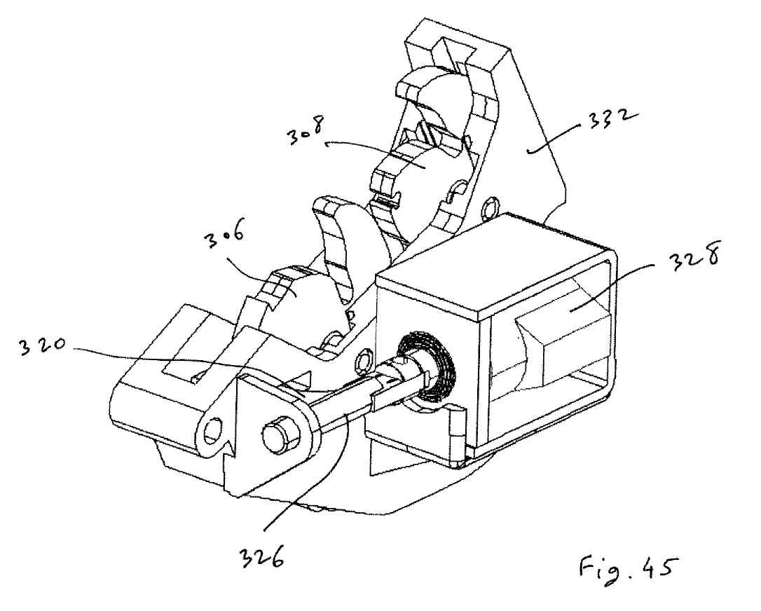

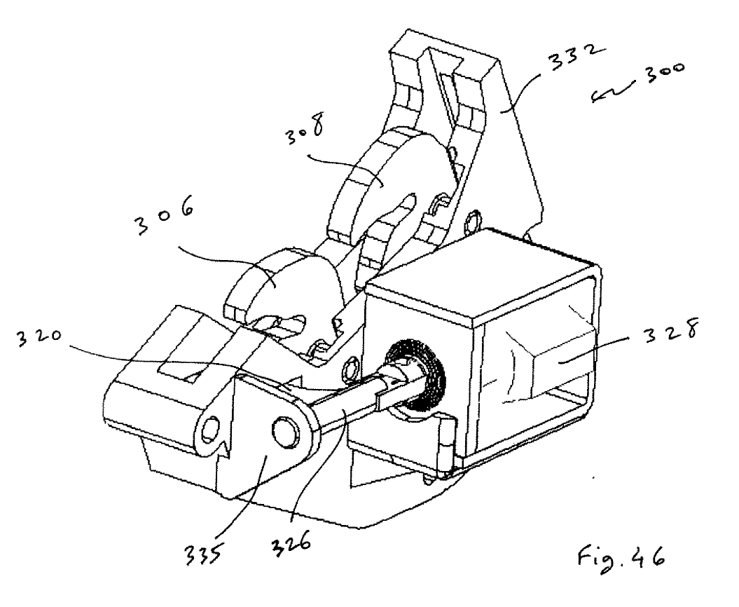

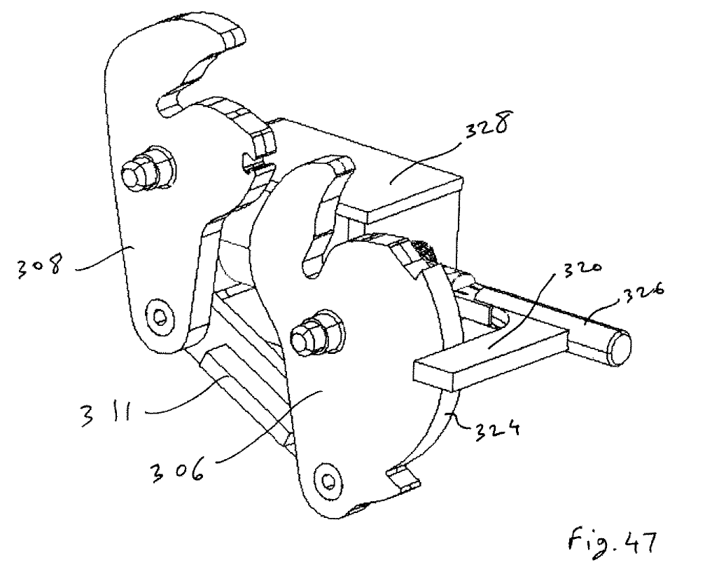

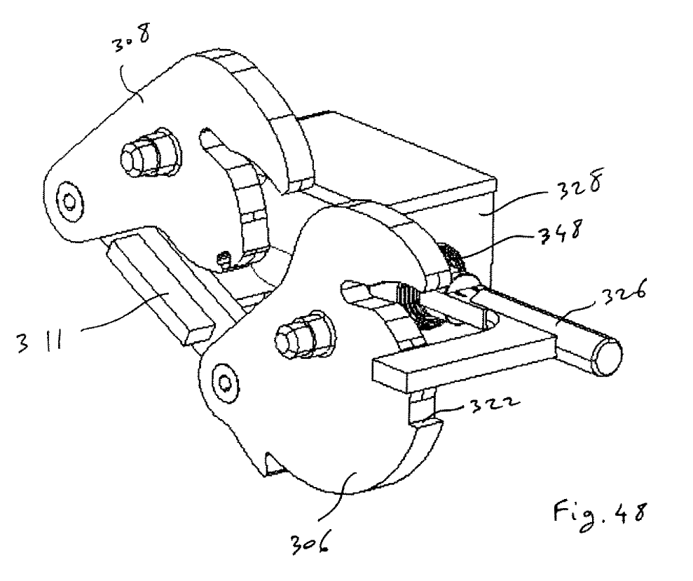

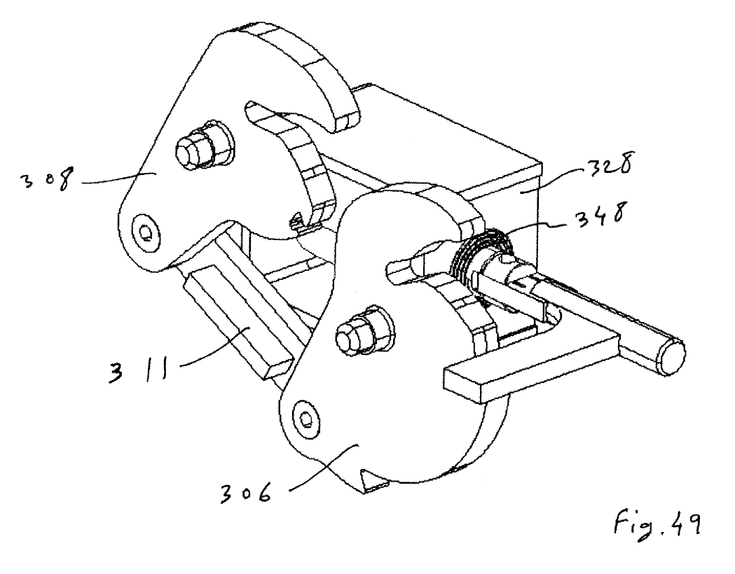

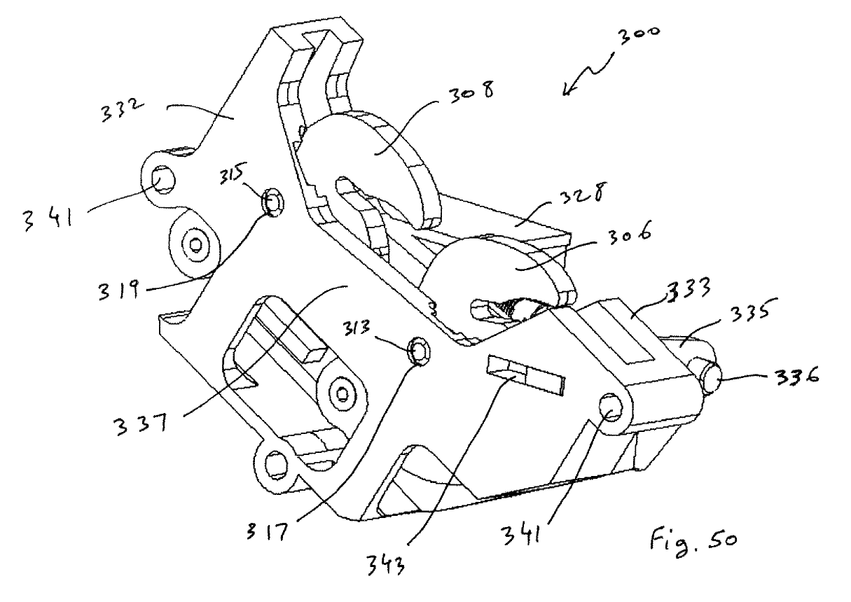

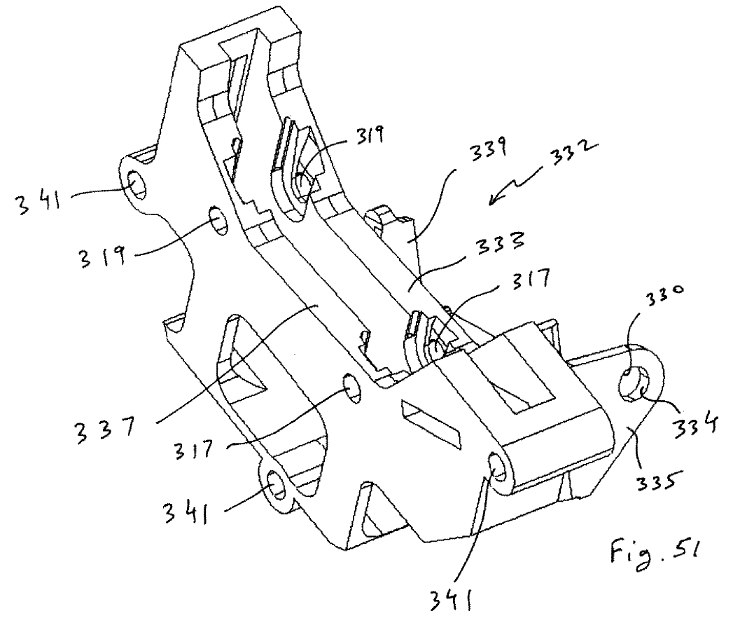

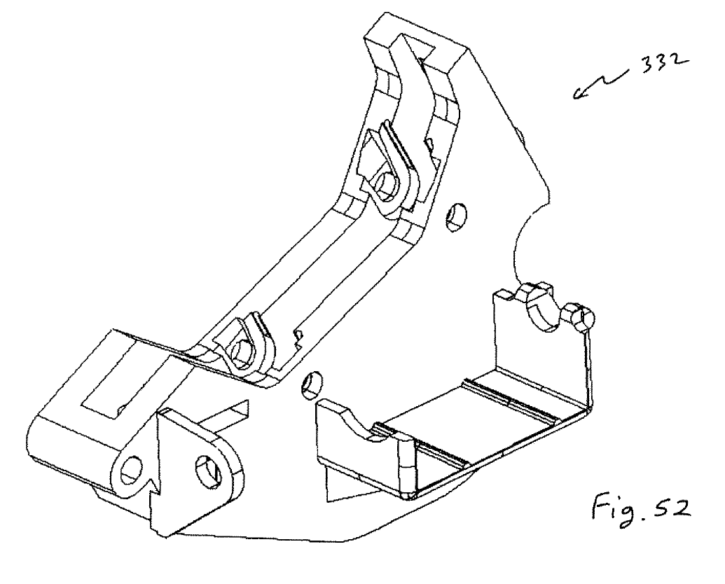

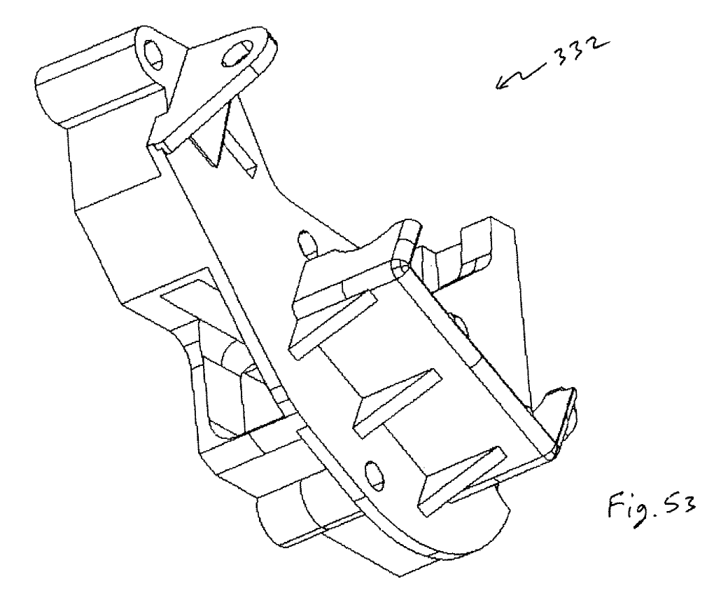

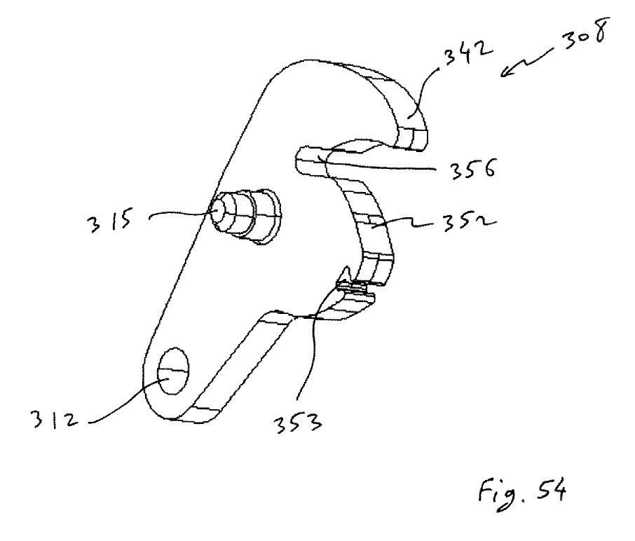

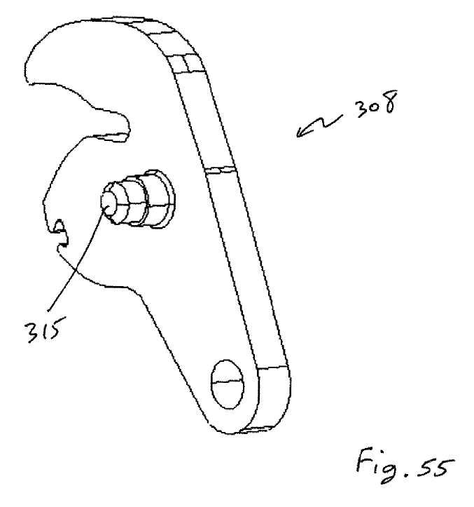

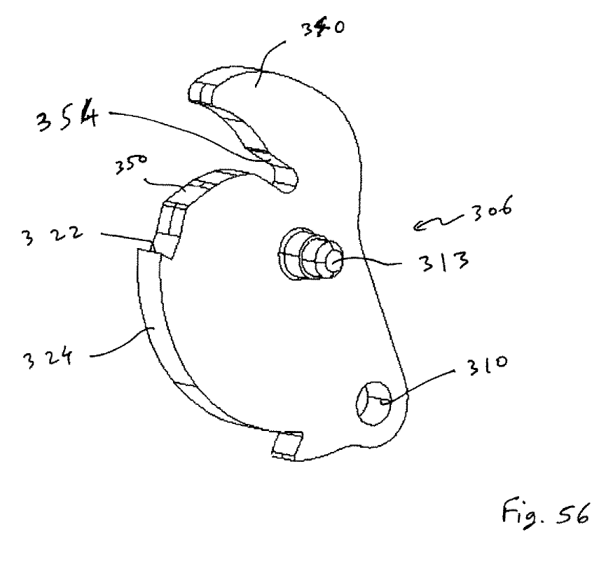

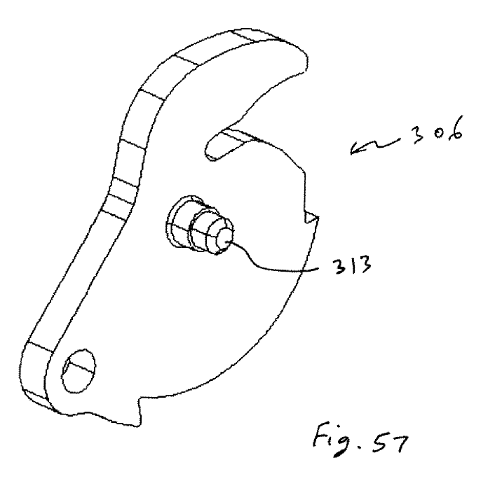

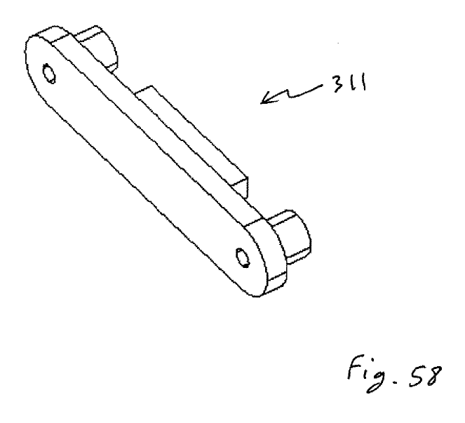

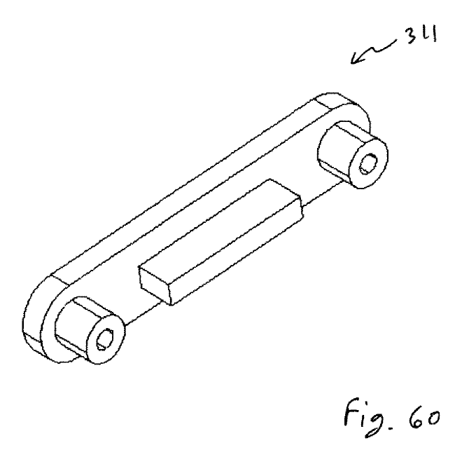

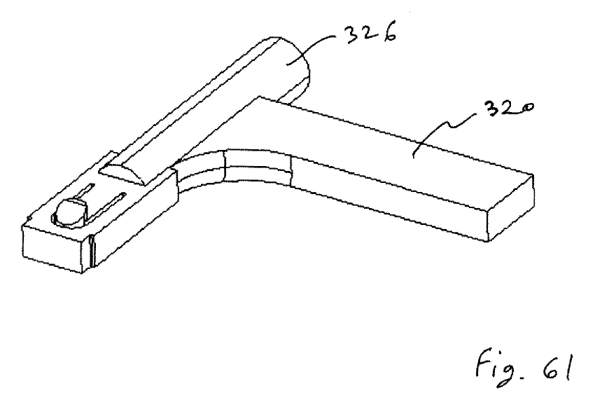

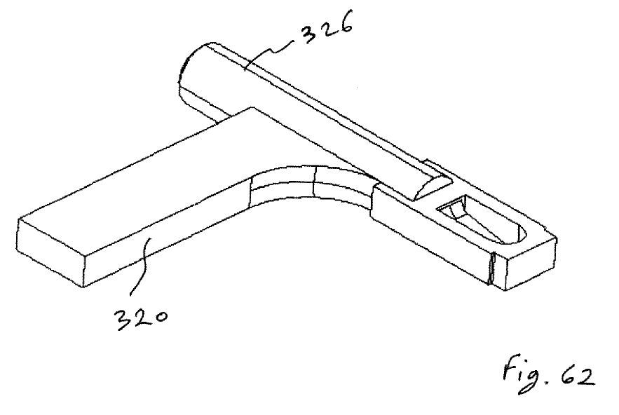

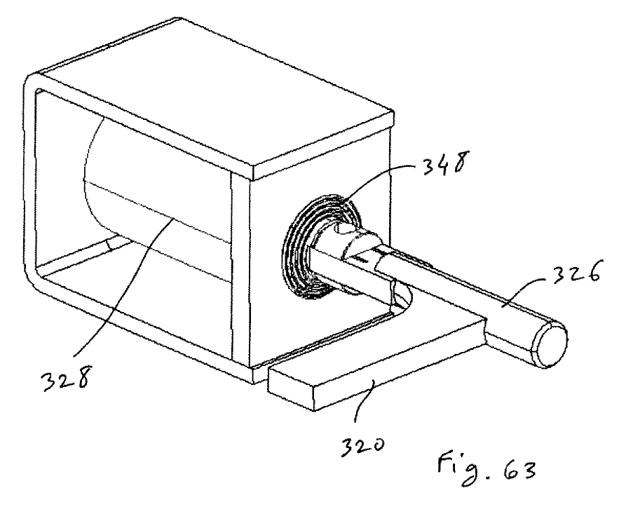

Referring to FIGS. 42-63, a third embodiment of a latch 300 with dual rotary pawls according to the present invention can be seen. The latch 300 is a solenoid operated latch designed to lock two doors 202 and 204 simultaneously, using two rotating pawls 306 and 308, and is situated between the pivots or hinges of the doors 202, 204 with the pawls 306, 308 rotating in the same plane. The latch 300 is essentially similar to the latch 200, and for the sake of brevity only those features of the latch 300 that are different from the latch 200 are discussed in detail below. The pawls 306, 308 are provided with holes 310, 312, respectively, that are offset or eccentric relative to the axis of rotation of the pawls 306, 308. The holes 310, 312 allow each end of the linking bar 311 to be pivotally connected to a respective one of the pawls 306, 308. The linking bar 311 links the pawls 306, 308 together such that rotation of one pawl causes the rotation of the other with both pawls 306, 308 to rotating in the same direction. The pawls 306, 308 are rotationally movable between respective latched and unlatched positions, where they respectively latch and unlatch their respective striker rods 214 and 216. Therefore only one torsion spring 218 is required to bias both pawls 306, 308 toward their unlatched positions. Furthermore, only one locking bar 320 is required for keeping both pawls in the latched position, because once the locking bar 320 engages one of the pawls 306, 308 to retain that pawl in the latched position, the other pawl will also be retained in the latched position through the linkage provided by the linking bar 311. In the illustrated example, the locking bar 320 engages the pawl 306, and the torsion spring 218 would be in contact with the pawl 308 such that the biasing force of the torsion spring 218 is exerted directly against the pawl 308. The locking bar 320 is rectilinearly movable between engaged and disengaged positions. In the engaged position the locking bar 320 engages the step or notch 322 formed in the pawl 306, when the pawl 306 is in the latched position, to maintain the pawl 306, and consequently the pawl 308, in their latched positions. In the disengaged position the locking bar 320 disengages from the step 322 thereby freeing the pawls 306, 308 to rotate to their respective unlatched positions under the biasing force of the torsion spring 218. As the pawl 308 rotates to the unlatched position due to the biasing force exerted on the pawl 308 by the torsion spring 218, due to the linkage provided by the linking bar 311, the pawl 306 also rotates to its unlatched position. The locking bar 320 is attached to the operating rod 326, which is in turn attached to the solenoid 328. The solenoid 328 is supported by the housing 332. The locking bar 320 moves rectilinearly between the engaged position and the disengaged position in response to the rectilinear movement of the operating rod 326 between a first position corresponding to the engaged position of the locking bar 320 and a second position corresponding to the disengaged position of the locking bar 320. The operating rod 326 is guided in its rectilinear movement by the hole 330 in the housing 332. The annular wall 334 that defines the perimeter of the hole 330 provides a bearing surface that movably supports the operating rod 326 intermediate the locking bar 320 and the end 336 of the operating rod 326 that is distal from the solenoid 328. The locking bar 320 is positioned to extend through a slot 338 provided in the housing 332. The operating rod 326 and the pawl 306 are positioned on opposite sides of the slot 338 and the slot 338 allows the locking bar 320 to have access to the pawl 306. The slot 338 is long enough to allow sufficient clearance to at least accommodate the range of movement of the locking bar 320 between the engaged position and the disengaged position without interference from any part of the housing 332. The slot 338 also aids in guiding the rectilinear movement of the locking bar 320 and of the operating rod 326.

The housing 332 is in the form of a main plate 333 having a second plate 335 attached thereto. The second plate 335 is perpendicular to the main plate 333. The solenoid 328 is supported on one side of the main plate 333 and the pawls 306, 308 are rotationally supported on the other side of the main plate 333. The slot 338 is formed in the plate 333. The hole 330 is formed in the plate 335. A third plate 337 is supported by the main plate 333 such that the plate 337 is parallel to but spaced apart from plate 333. The pawls 306, 308 are rotationally supported intermediate the plates 333 and 337 with the axis of rotation of each pawl being perpendicular to each of the plates 333 and 337. The axis of rotation of each pawl 306, 308 is parallel to and spaced apart from the axis of rotation of the other pawl. A solenoid support bracket 339 is provided on the side of the plate 333 opposite the side of the plate 333 on which the pawls 306, 308 are located. The housing 332 is also provided with mounting holes 341 for attachment of the latch 300 near the opening of the compartment secured by the doors 202, 204. The third plate 337 is provided with a slot 343 that registers with and is coextensive with the slot 338. The locking bar 320 preferably extends through both the slots 338 and 343 such that the locking bar 320 is mechanically supported near both ends for added strength.

The pawl 306 is rotationally supported through the engagement of half shafts 313 with holes 317 for receiving the half shafts 313 provided in the housing 332. The half shafts 313 project outward from either side of the pawl 306. The pawl 308 is rotationally supported through the engagement of half shafts 315 with holes 319 for receiving the half shafts 315 provided in the housing 332. The half shafts 315 project outward from either side of the pawl 308. The torsion spring 218 has two coiled portions 245 each of which would surround a respective half shaft 315 as shown for latch 200. Extending from each coiled portion 245 is a first spring arm 247 and a second spring arm 249. The ends of the first spring arms 247 located distally from the respective coiled portion 245 would be fixedly located relative to the housing 332 as was shown in the case of latch 200. The ends of the second spring arms 249 located distally from the respective coiled portion 245 are connected by a cross bar 251. The cross bar 251 would be engaged to a notch 353 formed in the pawl 308. Thus, ends of the second spring arms 249 located distally from the respective coiled portion 245 would be fixedly located relative to the pawl 308.

In the unlatched position the pawl claws 340, 342, respectively, of both pawls 306, 308 are positioned, due to the biasing force of the torsion spring 218, such that the pawl claws 340, 342 point upward and are out of the way of the striker rods 214 and 216 as the doors 202, 204 move toward the closed position relative to the compartment opening. Each of the striker rods 214, 216 is in the form of an elongated rod supported at a distance from the interior surface of the respective door 202, 204, by legs extending from each end of the striker rod to the interior surface of the respective door. The return spring 348 of the de-energized solenoid pulls the locking bar 320 against the outer peripheral profile of the pawl 306 extending from the notch 322 in a direction away from the claw 340 for a portion 324 of the outer periphery of the pawl 306 when the pawl 306 is not in the latched position. As the doors 202, 204 move toward their closed positions, the striker rods 214, 216 are bought into contact with the cam surfaces 350 and 352 of the pawls 306 and 308, respectively. Each of the pawls 306 and 308 is rotationally supported by the housing 332 such that each pawl rotates about its own axis of rotation. The contact point between each striker rod 214, 216 and the cam surface 350, 352 of the respective pawl 306, 308, and the path of each striker rod 214, 216, are offset from the axis of rotation of the respective pawl 306, 308. Therefore, as each striker rod 214, 216 impacts the respective cam surface 350, 352 due to the movement of the doors 202, 204 toward their closed positions, a torque tending to rotate the respective pawl 306, 308 toward the latched position is exerted by each striker rod 214, 216 on its respective pawl 306, 308. As a result, each pawl 306, 308 is rotated to its latched position due to the movement of the doors 202, 204 toward their closed positions. As each of the pawls 306, 308 rotates to its respective latched position due to the closing of the doors 202, 204, the claw 340, 342 of each pawl 306, 308 hooks around the respective striker rod 214, 216. Once the pawl 306 completes its rotation to its latched position, the locking bar 320 moves to the engaged position under the bias of the spring 348. In the engaged position the locking bar 320 is positioned over and into the step 322 to thereby prevent the rotation of the pawls 306, 308 out of their latched positions. Thus, the locking bar 320 holds the latch 300 in the latched configuration with the claws 340, 342 hooked around the striker rods 214, 216, respectively, and thereby secures the doors 202, 204 in the closed position.

When the pawl 306 is not in the latched position, but is at least very near the latched position, the locking bar 320 is maintained in the disengaged position by the portion 324 of the outer periphery of the pawl 306. The locking bar 320 slides against and rides the portion 324 of the outer periphery of the pawl 306 when the pawl 306 is not in the latched position.

To open the latch 300 the solenoid is energized. Energizing the solenoid 328 causes the operating rod 326 and the locking bar 320 to be pushed away from the solenoid 328 such that the locking bar 320 is moved to the disengaged position. Thus, energizing the solenoid 328 pushes the locking bar 320 clear of the step 322 and allows the pawls 306, 308 to rotate to their unlatched positions under spring force. The locking bar 320 will then come to rest against the portion 324 of the outer periphery of the pawl 306 when the solenoid 328 is de-energized. The striker rods 214, 216 are then free to move away from the latch 300, thus allowing the doors 202, 204 to be opened. As the pawls 306, 308 are linked to each other, they will move to the unlatched and latched positions together, irrespective of whether both striker rods 214, 216 are in contact with the cam surfaces 350, 352 of the pawls 306, 308. Each claw 340, 342 is spaced apart from the cam surface 350, 352 of the respective pawl 306, 308 such that each claw 340, 342 and the respective cam surface 350, 352 cooperatively define a respective pawl slot 354, 356. The striker rods 214, 216 are received in the pawl slots 354, 356, respectively, when the pawls 306, 308 are in the latched position and the doors 202, 204 are secured in the closed position. The pawl slots 354, 356 are wide enough near the tips of the claws 340, 342 such that even if only one of the striker rods 214, 216 contacts the respective cam surface 350, 352 of its respective pawl 306, 308 and the other striker rod lags the striker rod that is in contact with its respective cam surface, the lagging striker rod can be hooked and pulled into position by the claw 340, 342 of its respective pawl 306, 308 to allow the doors 202 and 204 to be secured in the closed position essentially simultaneously. By essentially simultaneous it is meant that there will be no lag between the securing of the door 202 and the securing of the door 204 in their closed positions that will be perceptible to a user during normal use. The achievement of this result is further facilitated by providing for the pawl slots 354, 356 to be tapering such that they are widest near the tips of the claws 340, 342 and become gradually narrower closer to the closed bottom of the pawl slot. With this geometry once the lagging striker rod is hooked by the respective pawl claw 340, 342, the lagging rod is accelerated such that the lagging rod catches up to the other rod as the pawls 306, 308 rotate to their latched positions. The doors 202 and 204 are linked by a mechanism (not shown) such that moving one door to the closed position also moves the other door to the closed position. If the doors 202, 204 are being closed by pushing either door by itself, the accumulation of play in the mechanism linking the doors results in one striker rod 214 or 216 lagging behind the other striker rod. In the illustrated example, the claws 340, 342 of the pawls 306, 308 are designed to hook and pull in their respective striker rod if it lags behind the other such that when the leading striker rod makes contact with its respective pawl the lagging striker rod can be out of the position where it would have made contact with its respective pawl by up to a distance of 5 mm. If the doors 202, 204 are being closed by pushing either door by itself, the striker rod of the door that is being pushed by the user will usually lead and the striker rod of the door that is being closed through the action of the door linking mechanism will usually lag behind its nominal position. By nominal position it is meant the position the striker rod would have been in had both doors been pushed toward their closed positions in a synchronized manner by the user such that the striker rods would contact their respective pawls simultaneously.

In the illustrated example, the ratio of angular displacement between the pawls 306 and 308 is 1:1.

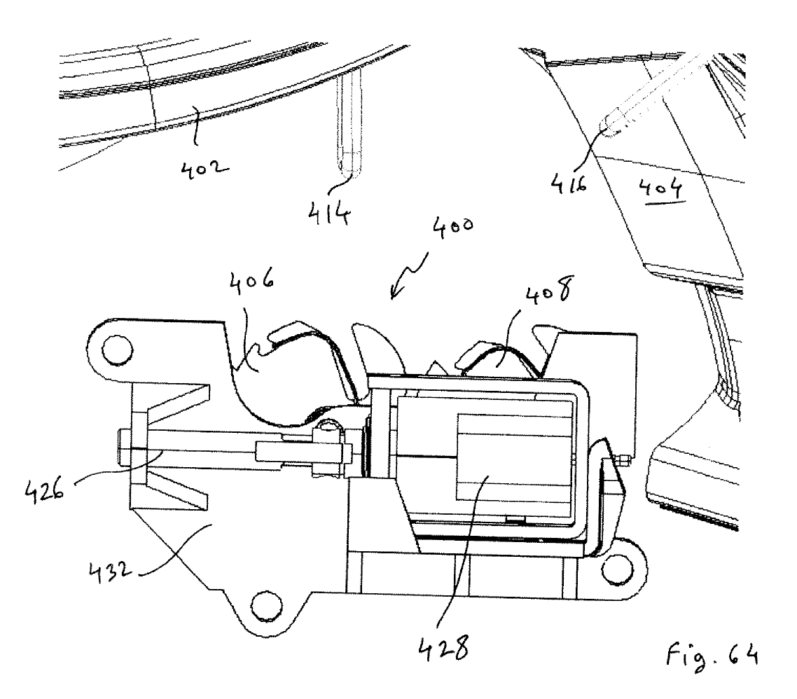

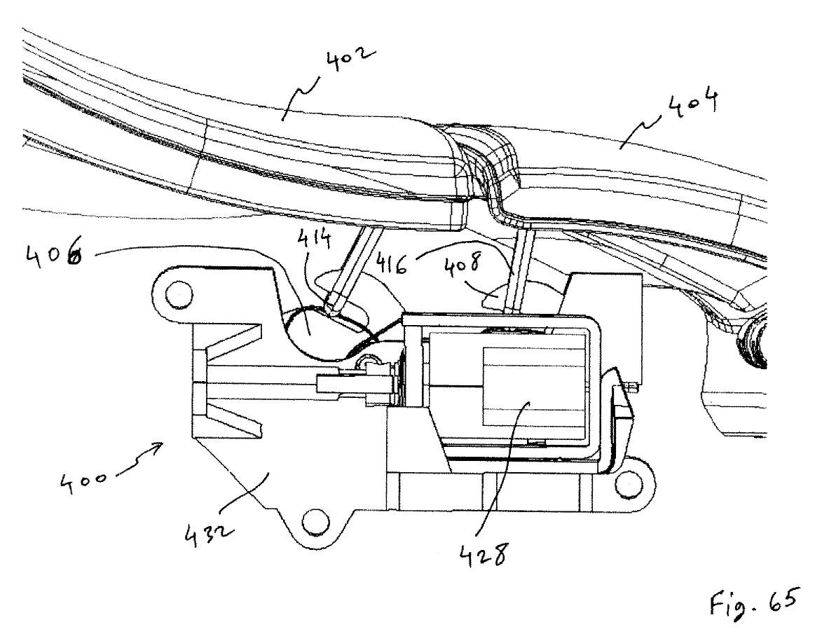

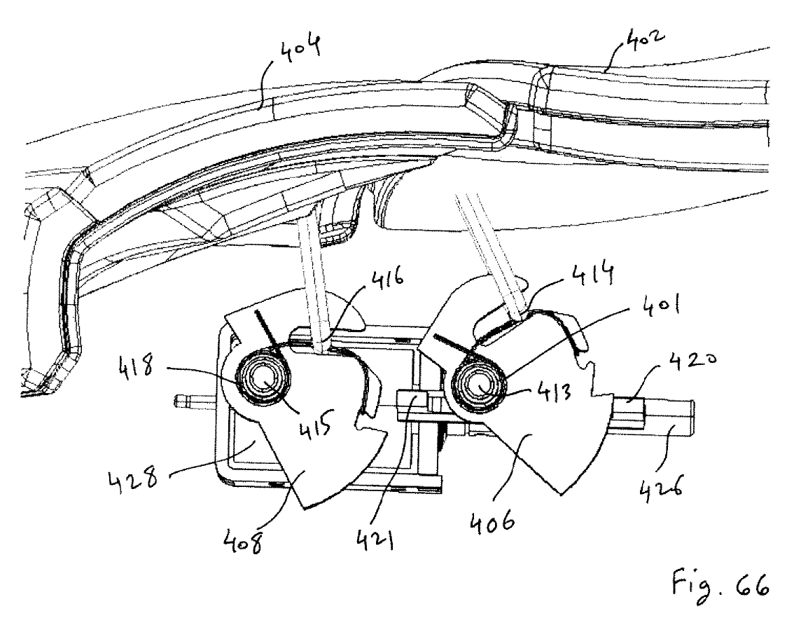

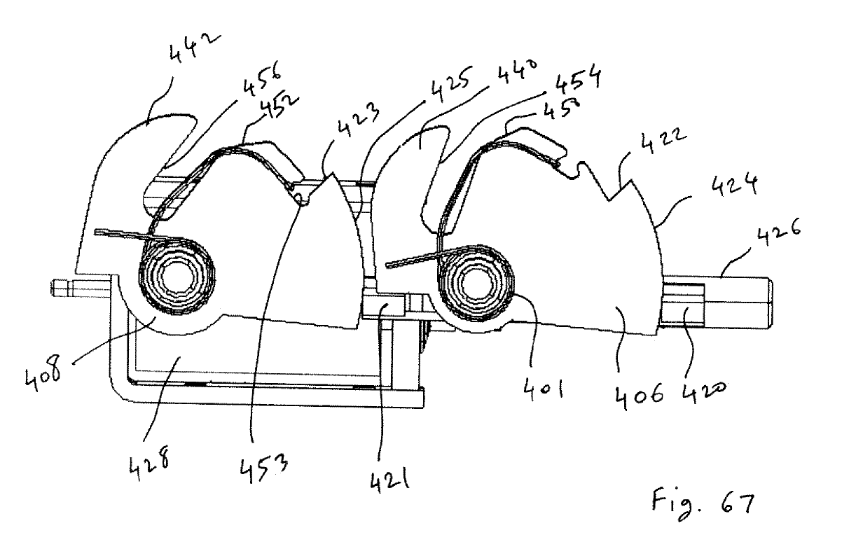

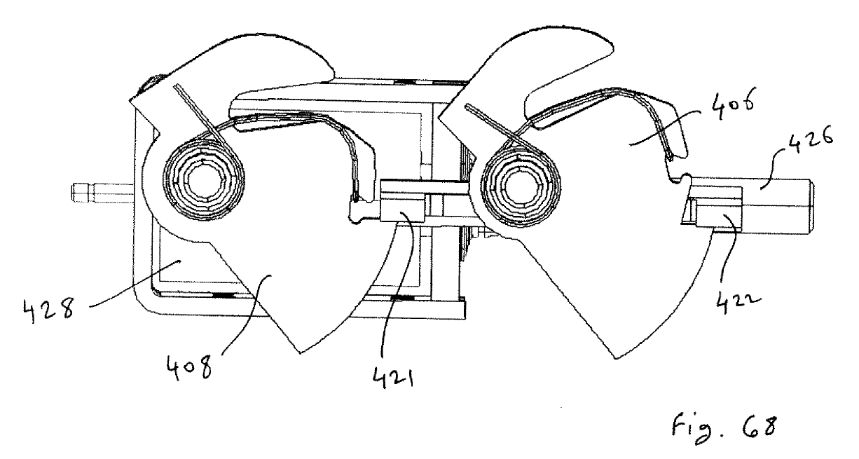

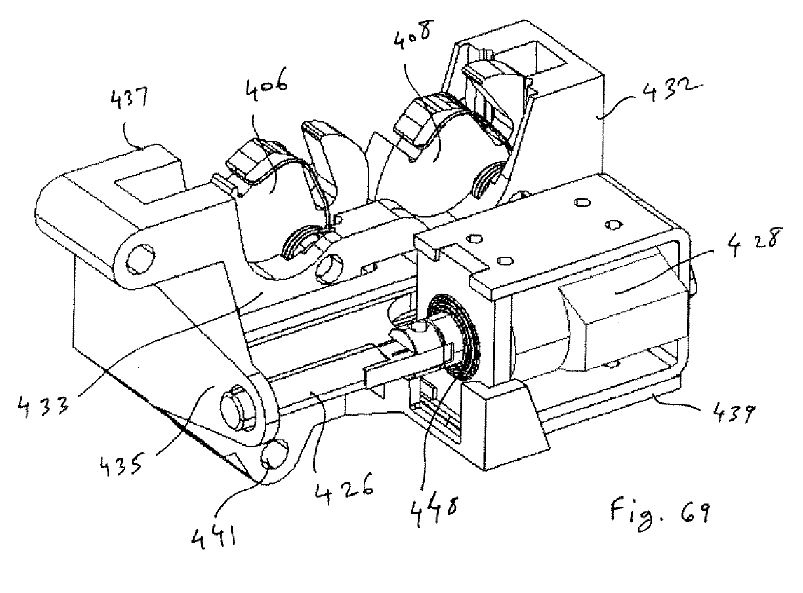

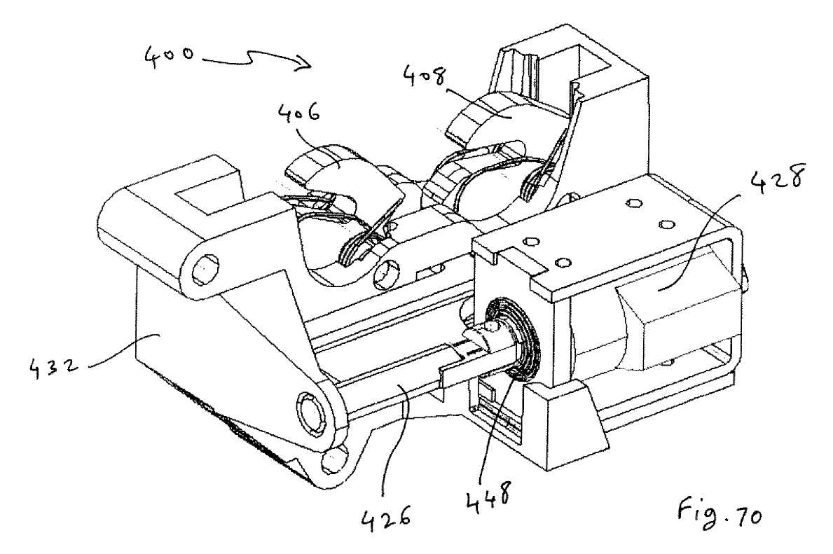

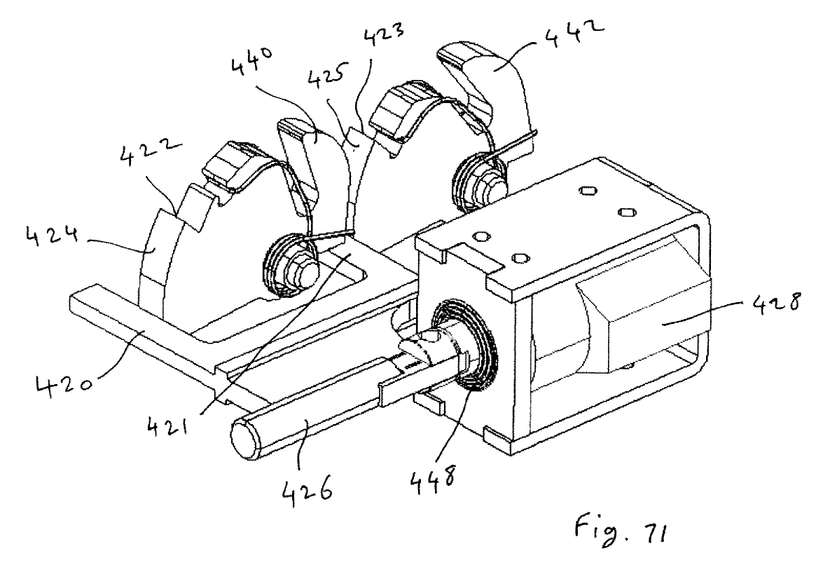

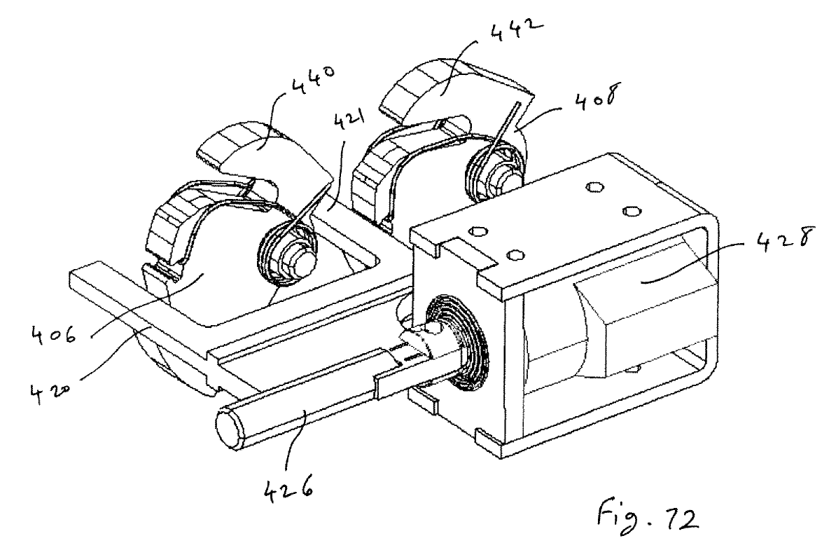

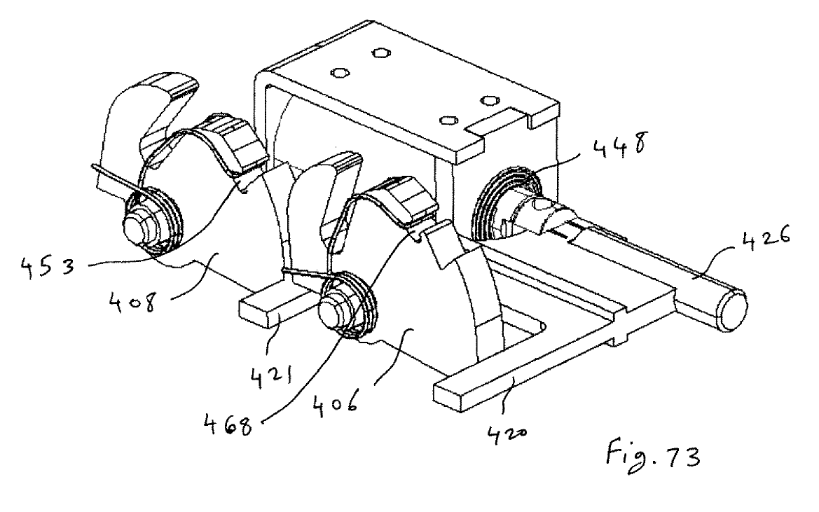

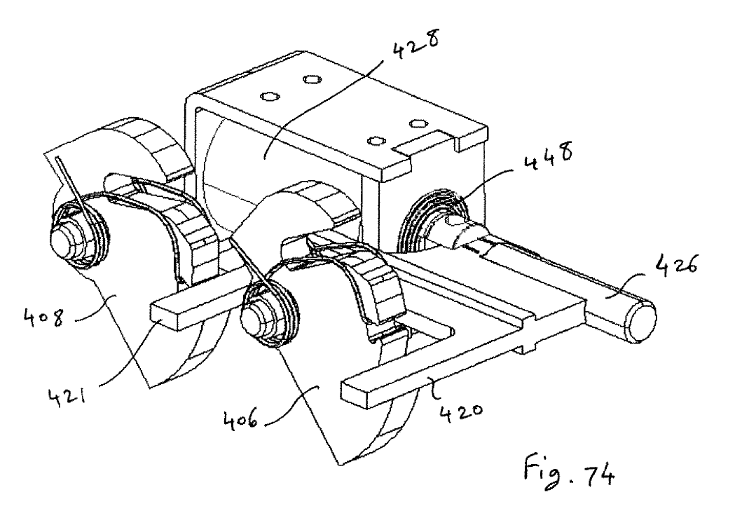

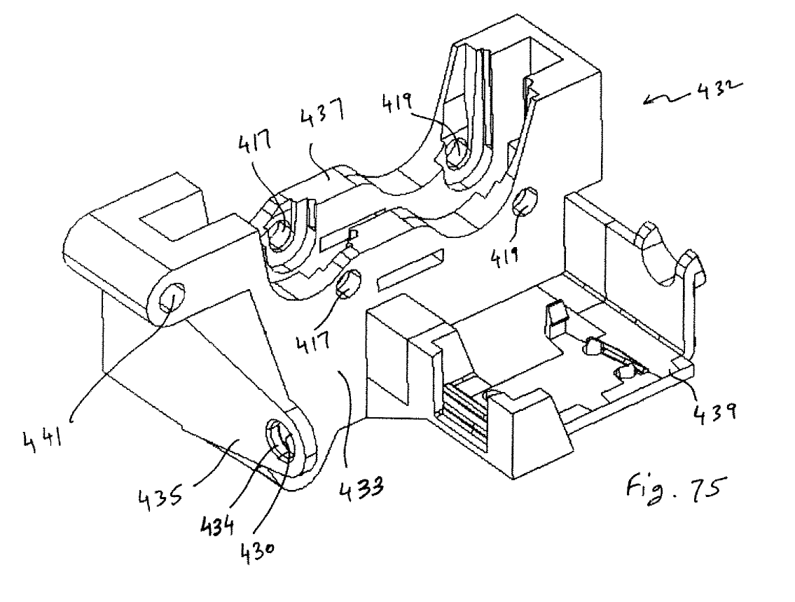

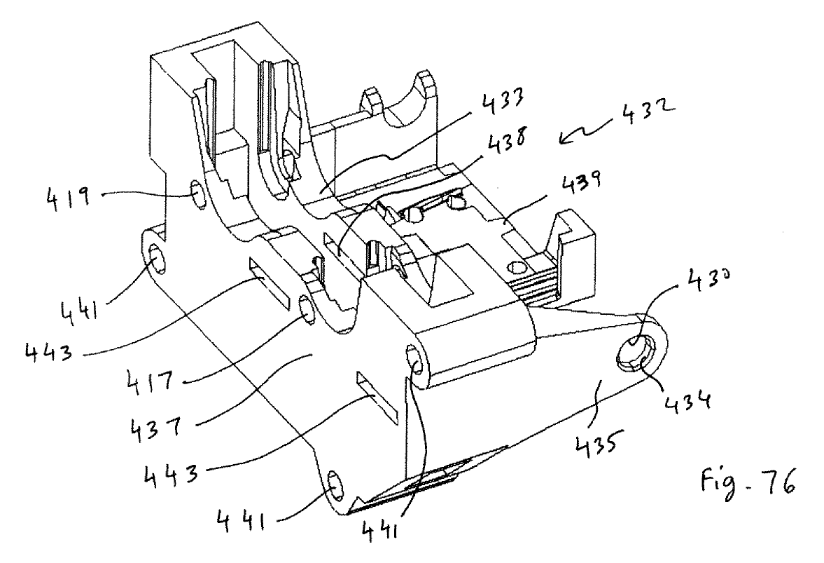

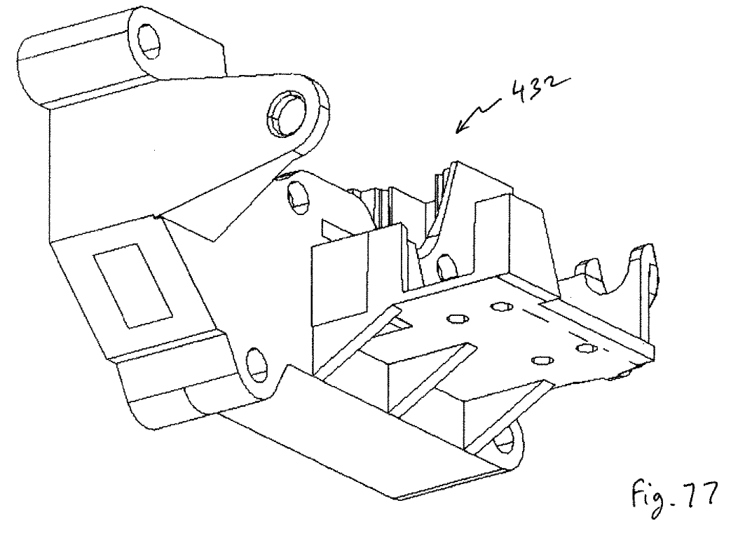

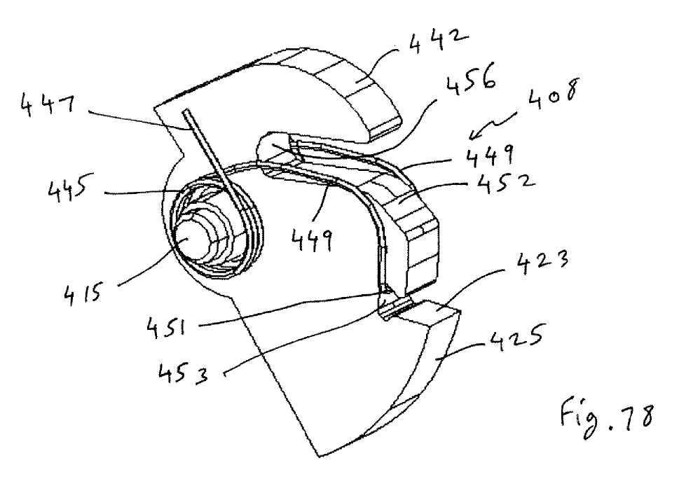

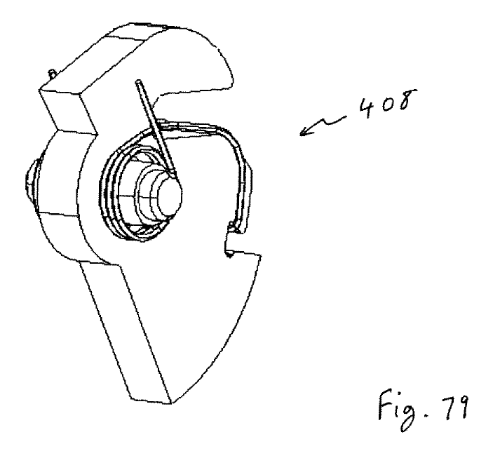

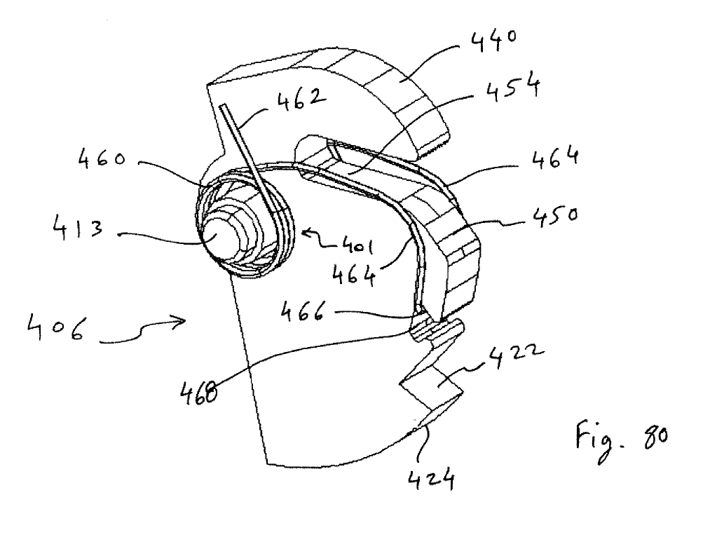

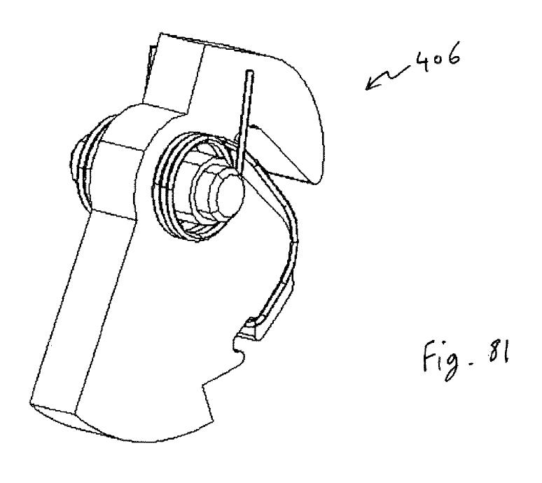

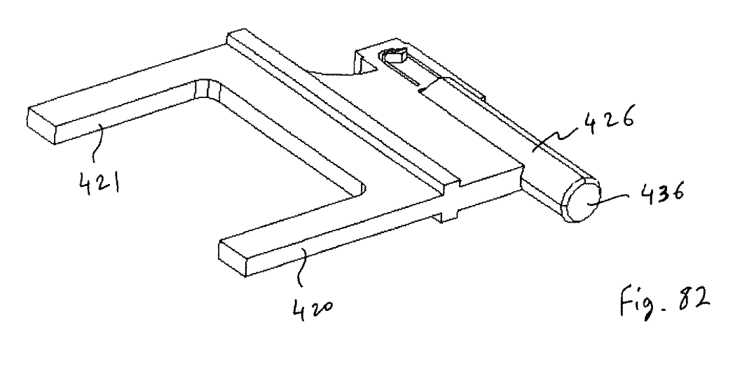

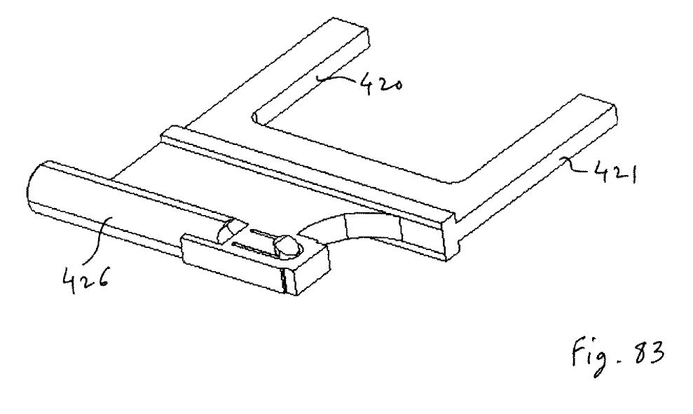

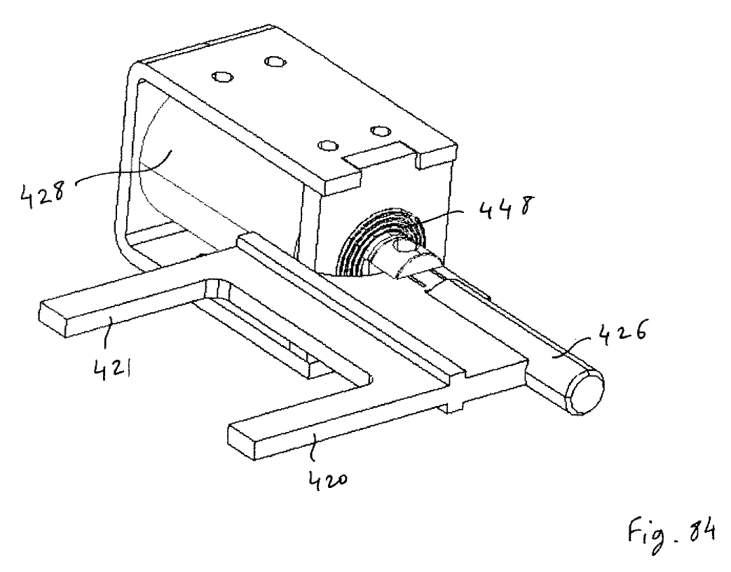

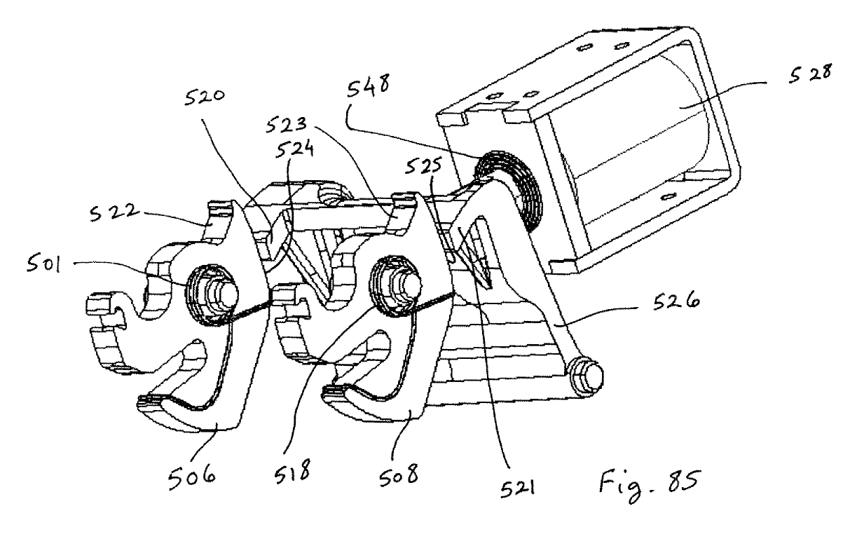

Referring to FIGS. 64-84, a fourth embodiment of a latch 400 with dual rotary pawls according to the present invention can be seen. The latch 400 is a solenoid operated latch designed to lock two doors 402 and 404 simultaneously, using two rotating pawls 406 and 408, and is situated between the pivots or hinges of the doors 402, 404 with the pawls 406, 408 rotating in the same plane. The latch 400 is essentially similar to the latch 300, except that there is no linkage between the pawls 406 and 408. Accordingly, pawls 406 and 408 are completely independent, which requires that one torsion spring 418, 401 be provided for each pawl 406, 408, respectively. Also, two locking bars 420 and 421 are provided, one for each pawl 406, 408. For the sake of brevity only those features of the latch 400 that are different from the latch 300 are discussed in detail below. The pawls 406, 408 are rotationally movable between respective latched and unlatched positions, where they respectively latch and unlatch their respective striker rods 414 and 416. The torsion springs 418, 401 bias the pawls 406, 408 toward their unlatched positions. The locking bar 420 is rectilinearly movable between engaged and disengaged positions. In the engaged position the locking bar 420 engages the step or notch 422 formed in the pawl 406, when the pawl 406 is in the latched position, to maintain the pawl 406 in its latched position. In the disengaged position the locking bar 420 disengages from the step 422 thereby freeing the pawl 406 to rotate to its unlatched position under the biasing force of the torsion spring 418. The locking bar 421 is rectilinearly movable between engaged and disengaged positions. In the engaged position the locking bar 421 engages the step or notch 423 formed in the pawl 408, when the pawl 408 is in the latched position, to maintain the pawl 408 in its latched position. In the disengaged position the locking bar 421 disengages from the step 423 thereby freeing the pawl 408 to rotate to its unlatched position under the biasing force of the torsion spring 401. The locking bars 420, 421 are attached to the operating rod 426, which is in turn attached to the solenoid 428. The solenoid 428 is supported by the housing 432. The locking bars 420, 421 move rectilinearly between the engaged position and the disengaged position in response to the rectilinear movement of the operating rod 426 between a first position corresponding to the engaged position of the locking bars 420, 421 and a second position corresponding to the disengaged position of the locking bars 420, 421. The operating rod 426 is guided in its rectilinear movement by the hole 430 in the housing 432. The annular wall 434 that defines the perimeter of the hole 430 provides a bearing surface that movably supports the operating rod 426 intermediate the locking bar 420 and the end 436 of the operating rod 426 that is distal from the solenoid 428. The locking bars 420, 421 are positioned to extend through slots 438 (only one shown) provided in the housing 432. The operating rod 426 and the pawls 406, 408 are positioned on opposite sides of the slots 438 and the slots 438 allow the locking bars 420, 421 to have access to the pawls 406, 408, respectively. The slots 438 are long enough to allow sufficient clearance to at least accommodate the range of movement of the locking bars 420, 421 between the engaged position and the disengaged position without interference from any part of the housing 432. The slots 438 also aid in guiding the rectilinear movement of the locking bars 420, 421 and of the operating rod 426.

The housing 432 is in the form of a main plate 433 having a second plate 435 attached thereto. The second plate 435 is perpendicular to the main plate 433. The solenoid 428 is supported on one side of the main plate 433 and the pawls 406, 408 are rotationally supported on the other side of the main plate 433. The slot 438 is formed in the plate 433. The hole 430 is formed in the plate 435. A third plate 437 is supported by the main plate 433 such that the plate 437 is parallel to but spaced apart from plate 433. The pawls 406, 408 are rotationally supported intermediate the plates 433 and 437 with the axis of rotation of each pawl being perpendicular to each of the plates 433 and 437. The axis of rotation of each pawl 406, 408 is parallel to and spaced apart from the axis of rotation of the other pawl. A solenoid support bracket 439 is provided on the side of the plate 433 opposite the side of the plate 433 on which the pawls 406, 408 are located. The housing 432 is also provided with mounting holes 441 for attachment of the latch 400 near the opening of the compartment secured by the doors 402, 404. The third plate 437 is provided with slots 443 that register with and is coextensive with the slots 438. The locking bars 420, 421 preferably extend through both the slots 438 and 443 such that the locking bars 420, 421 are mechanically supported near both ends for added strength.

The pawl 406 is rotationally supported through the engagement of half shafts 413 with holes 417 for receiving the half shafts 413 provided in the housing 432. The half shafts 413 project outward from either side of the pawl 406. The torsion spring 401 has two coiled portions 460 each of which surround a respective half shaft 413. Extending from each coiled portion 460 is a first spring arm 462 and a second spring arm 464. The ends of the first spring arms 462 located distally from the respective coiled portion 460 are fixedly located relative to the housing 432. The ends of the second spring arms 464 located distally from the respective coiled portion 460 are connected by a cross bar 466. The cross bar 466 is engaged to a notch 468 formed in the pawl 406. Thus, ends of the second spring arms 464 located distally from the respective coiled portion 460 are fixedly located relative to the pawl 406. The pawl 408 is rotationally supported through the engagement of half shafts 415 with holes 419 for receiving the half shafts 415 provided in the housing 432. The half shafts 415 project outward from either side of the pawl 408. The torsion spring 418 has two coiled portions 445 each of which surround a respective half shaft 415 as shown for latch 400. Extending from each coiled portion 445 is a first spring arm 447 and a second spring arm 449. The ends of the first spring arms 447 located distally from the respective coiled portion 445 are fixedly located relative to the housing 432. The ends of the second spring arms 449 located distally from the respective coiled portion 445 are connected by a cross bar 451. The cross bar 451 is engaged to a notch 453 formed in the pawl 408. Thus, ends of the second spring arms 449 located distally from the respective coiled portion 445 are fixedly located relative to the pawl 408.

In the unlatched position the pawl claws 440, 442, respectively, of both pawls 406, 408 are positioned, due to the biasing force of the torsion springs 418, 401, such that the pawl claws 440, 442 point upward and are out of the way of the striker rods 414 and 416 as the doors 402, 404 move toward the closed position relative to the compartment opening. Each of the striker rods 414, 416 is in the form of an elongated rod supported at a distance from the interior surface of the respective door 402, 404, by legs extending from each end of the striker rod to the interior surface of the respective door. The return spring 448 of the de-energized solenoid pulls the locking bars 420, 421 against the outer peripheral profile of the pawls 406, 408, respectively, extending from the notches 422, 423 in a direction away from the claws 440, 442 for a portion 424, 425 of the outer periphery of the pawls 406, 408 when the pawls 406, 408 are not in their latched positions. As the doors 402, 404 move toward their closed positions, the striker rods 414, 416 are bought into contact with the cam surfaces 450 and 452 of the pawls 406 and 408, respectively. Each of the pawls 406 and 408 is rotationally supported by the housing 432 such that each pawl rotates about its own axis of rotation. The contact point between each striker rod 414, 416 and the cam surface 450, 452 of the respective pawl 406, 408, and the path of each striker rod 414, 416, are offset from the axis of rotation of the respective pawl 406, 408. Therefore, as each striker rod 414, 416 impacts the respective cam surface 450, 452 due to the movement of the doors 402, 404 toward their closed positions, a torque tending to rotate the respective pawl 406, 408 toward the latched position is exerted by each striker rod 414, 416 on its respective pawl 406, 408. As a result, each pawl 406, 408 is rotated to its latched position due to the movement of the doors 402, 404 toward their closed positions. As each of the pawls 406, 408 rotates to its respective latched position due to the closing of the doors 402, 404, the claw 440, 442 of each pawl 406, 408 hooks around the respective striker rod 414, 416. Once the pawls 406, 408 complete their rotation to their latched positions, the locking bars 420, 421 move to their engaged positions under the bias of the spring 448. In the engaged positions the locking bars 420, 421 are positioned over and into the steps 422, 423 to thereby prevent the rotation of the pawls 406, 408 out of their latched positions. Thus, the locking bars 420, 421 hold the latch 400 in the latched configuration with the claws 440, 442 hooked around the striker rods 414, 416, respectively, and thereby secure the doors 402, 404 in the closed position.

To open the latch 400 the solenoid is energized. Energizing the solenoid 428 causes the operating rod 426 and the locking bars 420, 421 to be pushed away from the solenoid 428 such that the locking bars 420, 421 are moved to their disengaged positions. Thus, energizing the solenoid 428 pushes the locking bars 420, 421 clear of the steps 422, 423, respectively, and allows the pawls 406, 408 to rotate to their unlatched positions under spring force. The locking bars 420, 421 will then come to rest against the portions 424, 425, respectively, of the outer periphery of the pawls 406, 408 when the solenoid 428 is de-energized. The striker rods 414, 416 are then free to move away from the latch 400, thus allowing the doors 402, 404 to be opened. Each claw 440, 442 is spaced apart from the cam surface 450, 452 of the respective pawl 406, 408 such that each claw 440, 442 and the respective cam surface 450, 452 cooperatively define a respective pawl slot 454, 456. The striker rods 414, 416 are received in the pawl slots 454, 456, respectively, when the pawls 406, 408 are in the latched position and the doors 402, 404 are secured in the closed position.

The doors 402 and 404 are linked by a mechanism (not shown) such that moving one door to the closed position also moves the other door to the closed position. If the doors 402, 404 are being closed by pushing either door by itself, the accumulation of play in the mechanism linking the doors results in one striker rod 414 or 416 lagging behind the other striker rod. In the latch 400 the two pawls are independent of each other and therefore this embodiment does not provide simultaneous closing when one striker rod lags behind. The latch 400 relies on the doors 402 and 404 to have a large over travel to allow the lagging striker rod to finally reach its fully latched position via the help of the mechanism linking the doors.

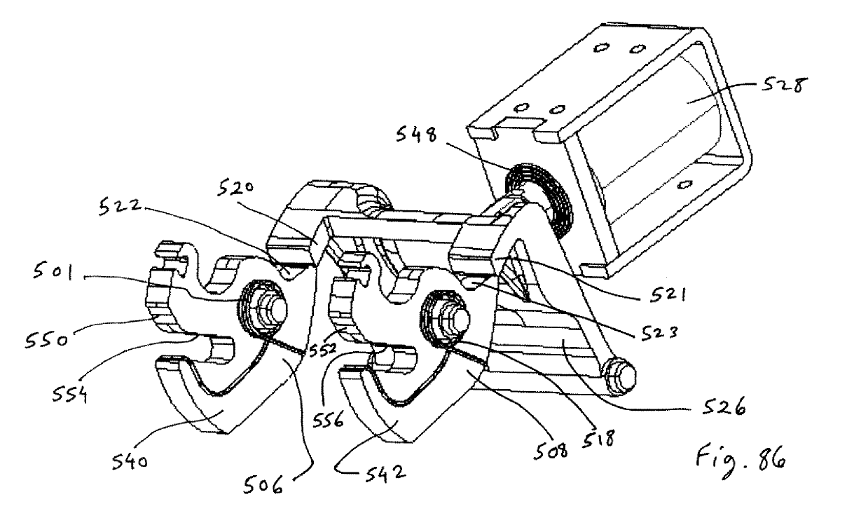

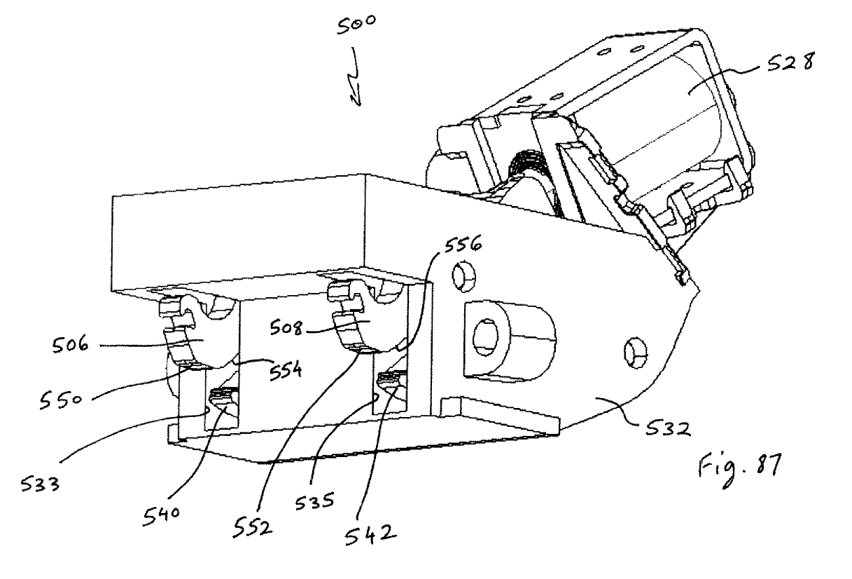

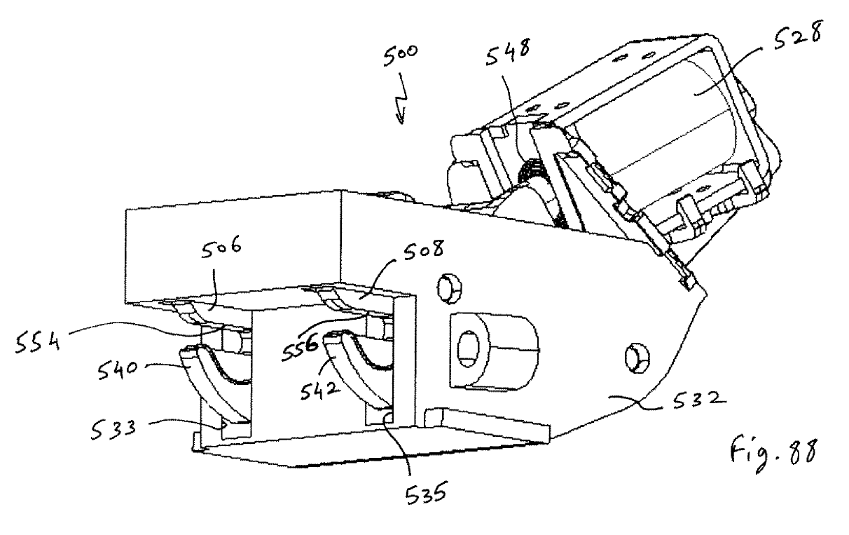

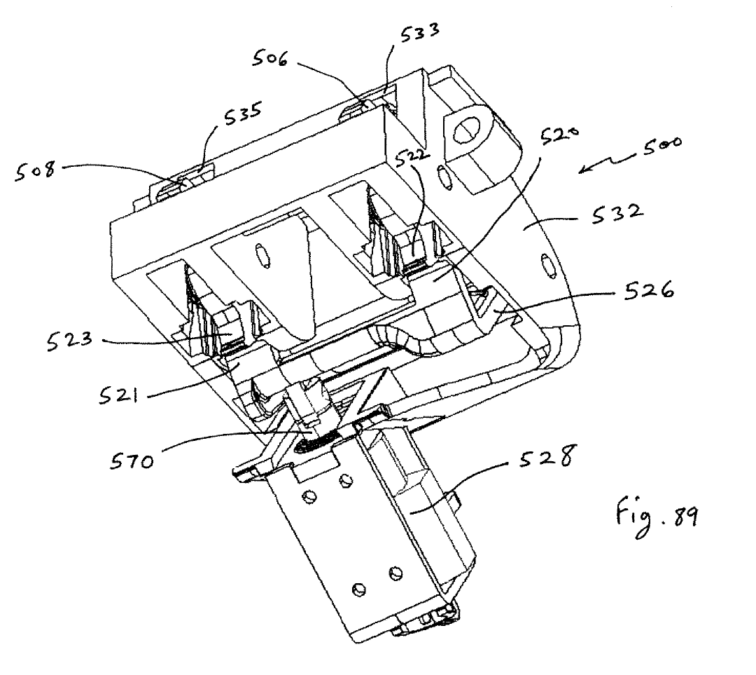

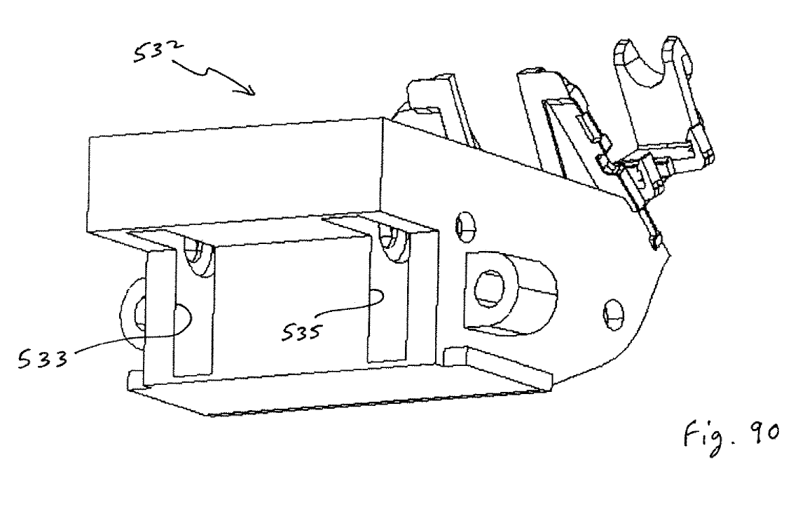

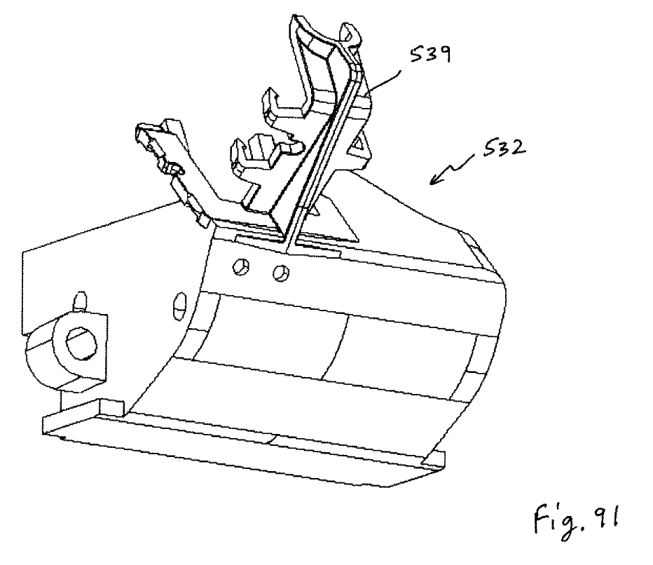

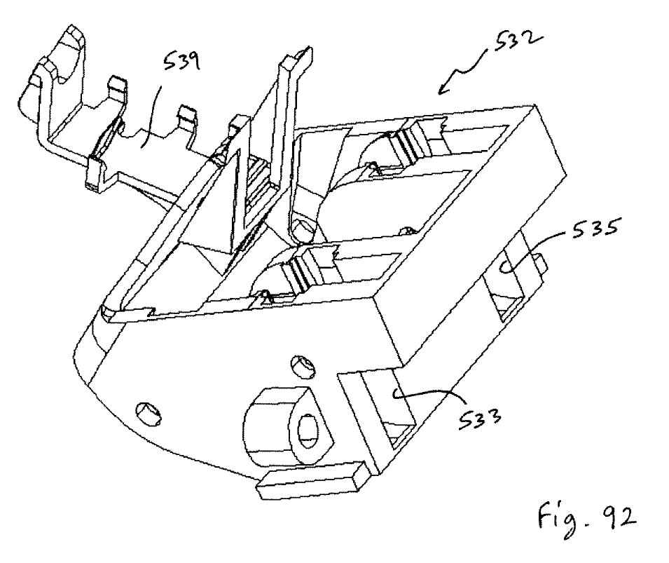

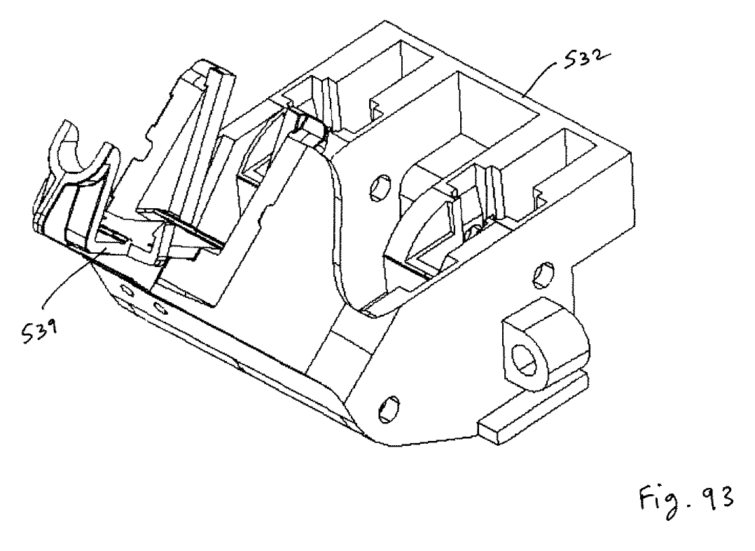

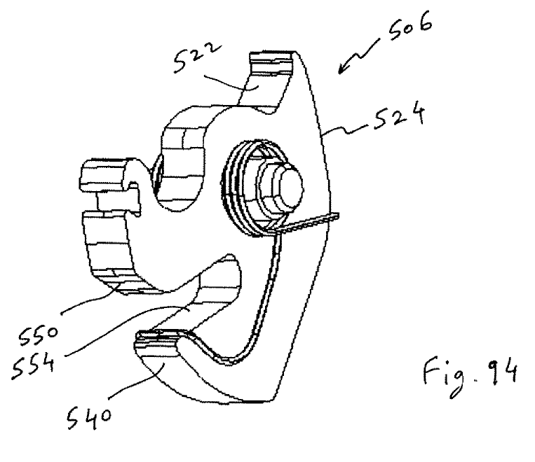

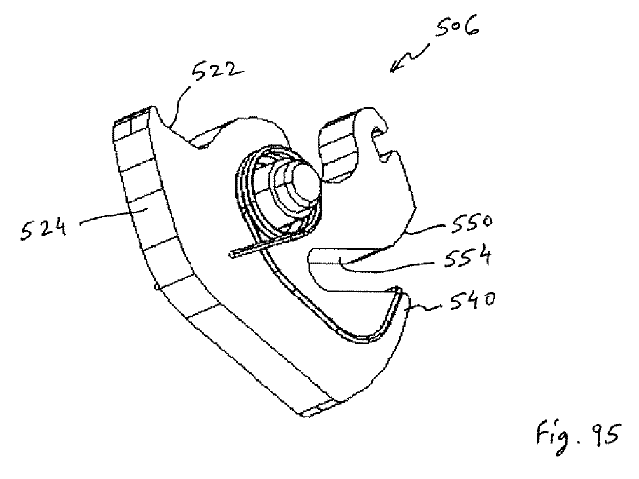

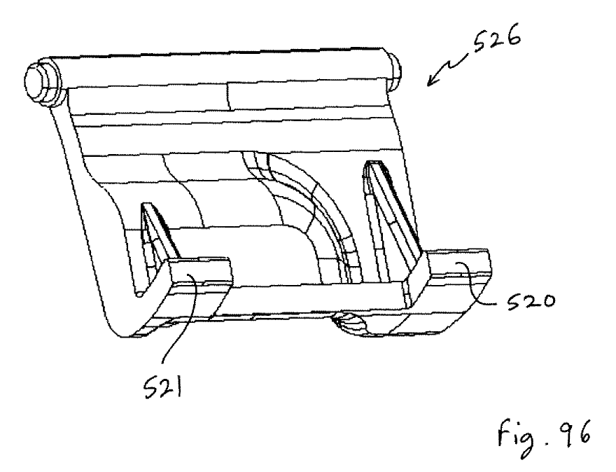

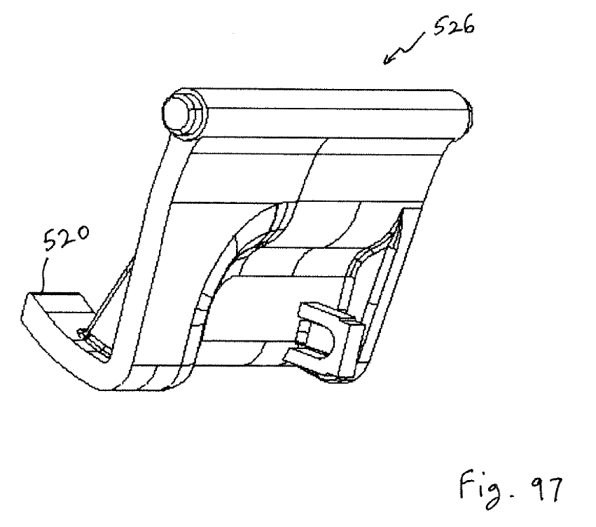

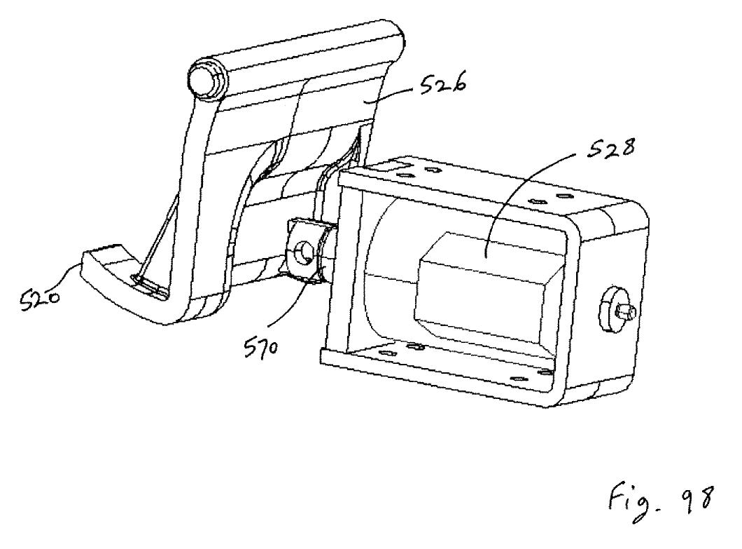

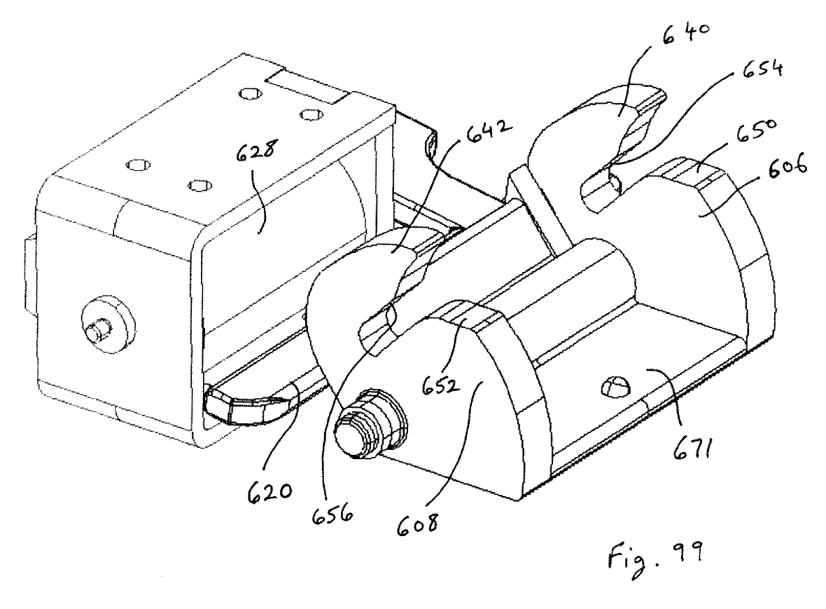

Referring to FIGS. 85-98, a fifth embodiment of a latch 500 with dual rotary pawls according to the present invention can be seen. The latch 500 is a solenoid operated latch designed to lock two doors, using two rotating pawls 506 and 508, and is situated between the pivots or hinges of the doors with the pawls 506, 508 rotating in parallel, spaced apart planes. The latch 500 is essentially similar to the latch 400, except that the axis of rotation of the pawls 506 and 508 are coincident rather than parallel and the locking bars 520 and 521 move pivotally rather than rectilinearly. The latch 500 is designed to engage striker rods that are in line rather than parallel. The pawls 506 and 508 are completely independent, which requires that one torsion spring 518, 501 be provided for each pawl 506, 508, respectively. Also, two locking bars 520 and 521 are provided, one for each pawl 506, 508. For the sake of brevity only those features of the latch 500 that are different from the latch 400 are discussed in detail below. The pawls 506, 508 are rotationally movable between respective latched and unlatched positions, where they respectively latch and unlatch their respective striker rods. The torsion springs 518, 501 bias the pawls 506, 508 toward their unlatched positions. The locking bar 520 is pivotally movable between engaged and disengaged positions. In the engaged position the locking bar 520 engages the step or notch 522 formed in the pawl 506, when the pawl 506 is in the latched position, to maintain the pawl 506 in its latched position. In the disengaged position the locking bar 520 disengages from the step 522 thereby freeing the pawl 506 to rotate to its unlatched position under the biasing force of the torsion spring 518. The locking bar 521 is pivotally movable between engaged and disengaged positions. In the engaged position the locking bar 521 engages the step or notch 523 formed in the pawl 508, when the pawl 508 is in the latched position, to maintain the pawl 508 in its latched position. In the disengaged position the locking bar 521 disengages from the step 523 thereby freeing the pawl 508 to rotate to its unlatched position under the biasing force of the torsion spring 501. The locking bars 520, 521 are attached to the plate 526, which is pivotally supported by the housing 532. The solenoid 528 is also supported by the housing 532. The solenoid shaft 570 is pivotally attached to the plate 526 such that rectilinear movement of the solenoid shaft 570 causes pivotal movement of the plate 526. The locking bars 520, 521 move pivotally between the engaged position and the disengaged position in response to the pivotal movement of the plate 526 between a first position corresponding to the engaged position of the locking bars 520, 521 and a second position corresponding to the disengaged position of the locking bars 520, 521.

The housing 532 has a pair of slots 533 and 535 through which the pawls 506, 508 can engage their respective striker rods. A solenoid support bracket 539 is provided on the side of housing 532.

In the unlatched position the pawl claws 540, 542, respectively, of both pawls 506, 508 are positioned, due to the biasing force of the torsion springs 518, 501, such that the pawl claws 540, 542 point upward and are out of the way of the striker rods as the doors move toward the closed position relative to the compartment opening.

The return spring 548 of the de-energized solenoid pushes the locking bars 520, 521 against the outer peripheral profile of the pawls 506, 508, respectively, extending from the notches 522, 523 in a direction toward the claws 540, 542 for a portion 524, 525 of the outer periphery of the pawls 506, 508 when the pawls 506, 508 are not in their latched positions. As the doors move toward their closed positions, the striker rods are bought into contact with the cam surfaces 550 and 552 of the pawls 506 and 508, respectively. Each of the pawls 506 and 508 is rotationally supported by the housing 532 such that each pawl rotates about its own axis of rotation. The contact point between each striker rod and the cam surface 550, 552 of the respective pawl 506, 508, and the path of each striker rod, are offset from the axis of rotation of the respective pawl 506, 508. Therefore, as each striker rod impacts the respective cam surface 550, 552 due to the movement of the doors toward their closed positions, a torque tending to rotate the respective pawl 506, 508 toward the latched position is exerted by each striker rod on its respective pawl 506, 508. As a result, each pawl 506, 508 is rotated to its latched position due to the movement of the doors toward their closed positions. As each of the pawls 506, 508 rotates to its respective latched position due to the closing of the doors, the claw 540, 542 of each pawl 506, 508 hooks around the respective striker rod. Once the pawls 506, 508 complete their rotation to their latched positions, the locking bars 520, 521 move to their engaged positions under the bias of the spring 548. In the engaged positions the locking bars 520, 521 are positioned over and into the steps 522, 523 to thereby prevent the rotation of the pawls 506, 508 out of their latched positions. Thus, the locking bars 520, 521 hold the latch 500 in the latched configuration with the claws 540, 542 hooked around their respective striker rods, and thereby secure the doors in the closed position.

To open the latch 500 the solenoid is energized. Energizing the solenoid 528 causes the plate 526 and the locking bars 520, 521 to be pulled toward the solenoid 528 such that the locking bars 520, 521 are moved to their disengaged positions. Thus, energizing the solenoid 528 pulls the locking bars 520, 521 clear of the steps 522, 523, respectively, and allows the pawls 506, 508 to rotate to their unlatched positions under spring force. The locking bars 520, 521 will then come to rest against the portions 524, 525, respectively, of the outer periphery of the pawls 506, 508 when the solenoid 528 is de-energized. The striker rods are then free to move away from the latch 500, thus allowing the doors to be opened. Each claw 540, 542 is spaced apart from the cam surface 550, 552 of the respective pawl 506, 508 such that each claw 540, 542 and the respective cam surface 550, 552 cooperatively define a respective pawl slot 554, 556. The striker rods are received in the pawl slots 554, 556, respectively, when the pawls 506, 508 are in the latched position and the doors are secured in the closed position.

In the latch 500 the two pawls are independent of each other and therefore this embodiment does not provide simultaneous closing when one striker rod lags behind. The latch 500 relies on the doors to have a large over travel to allow the lagging striker rod to finally reach its fully latched position via the help of the mechanism linking the doors.

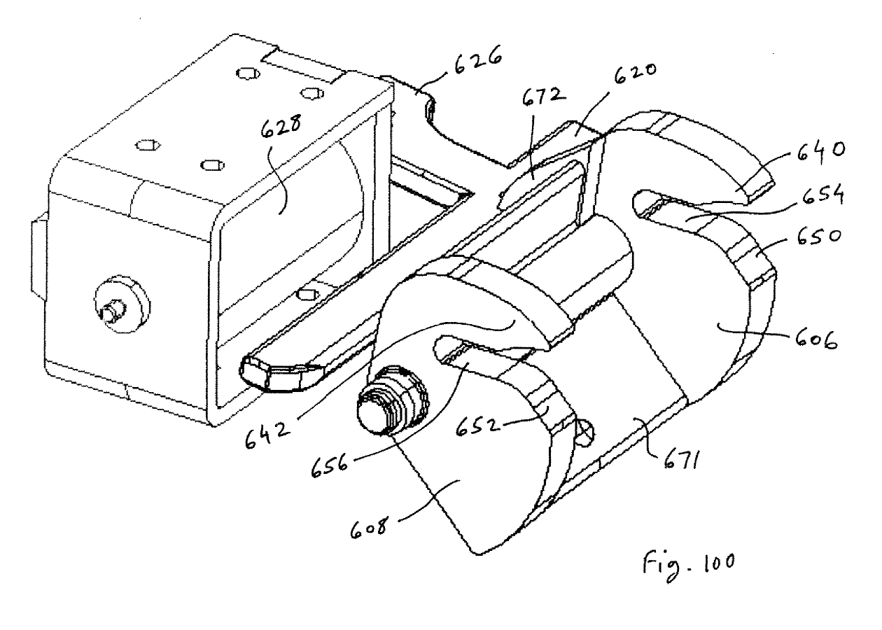

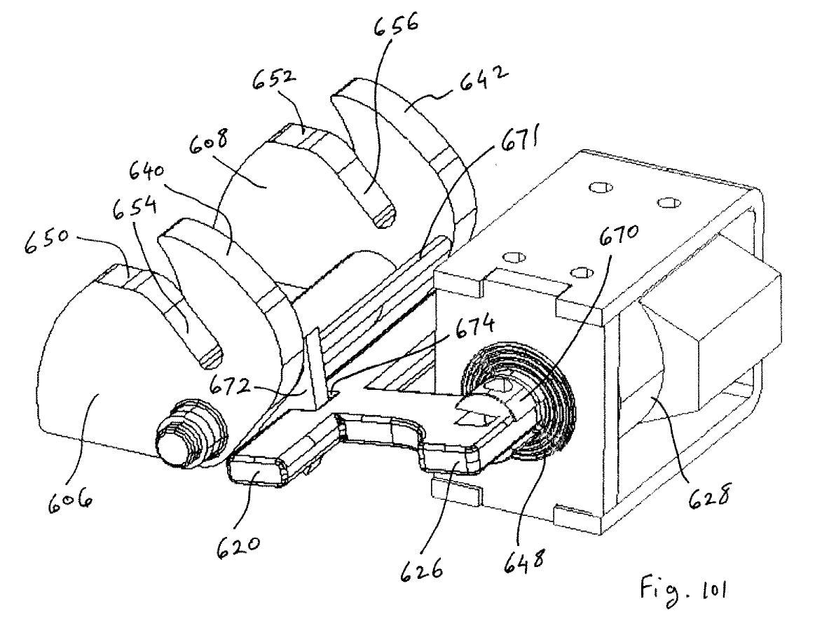

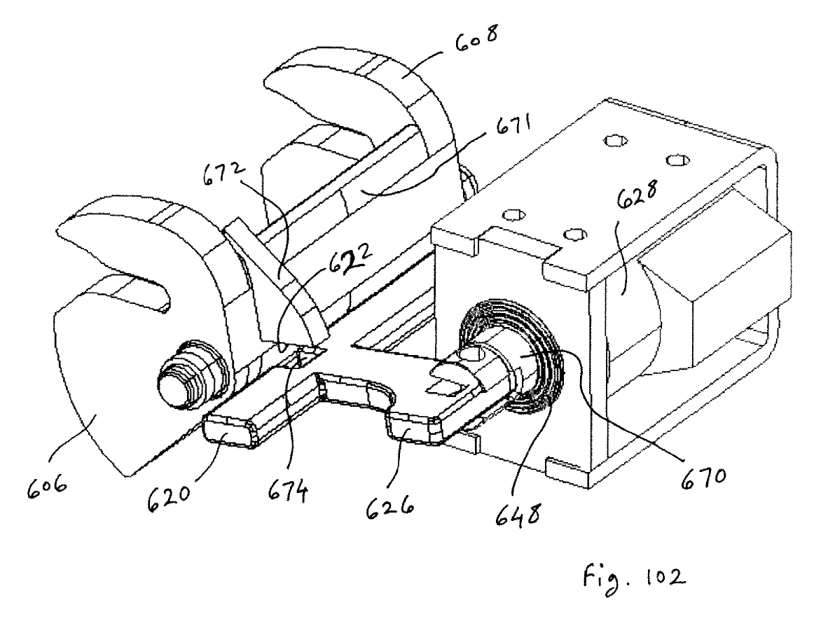

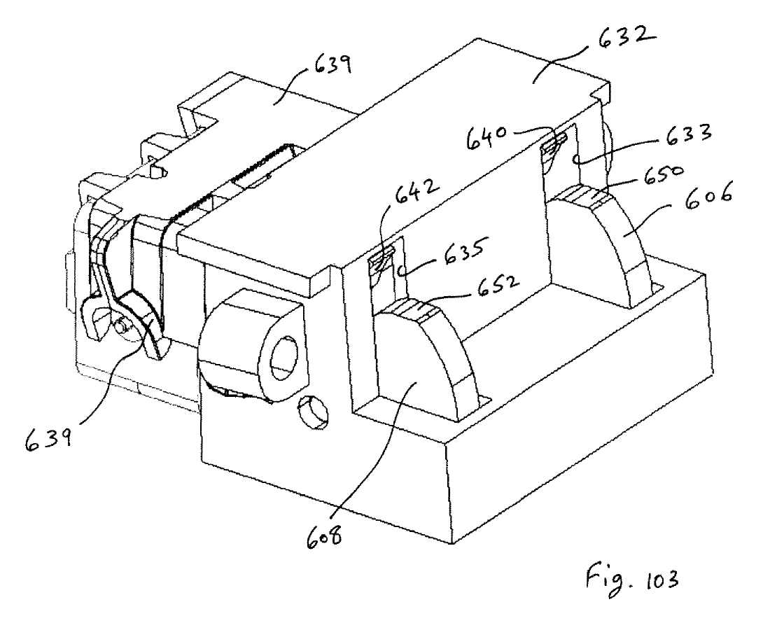

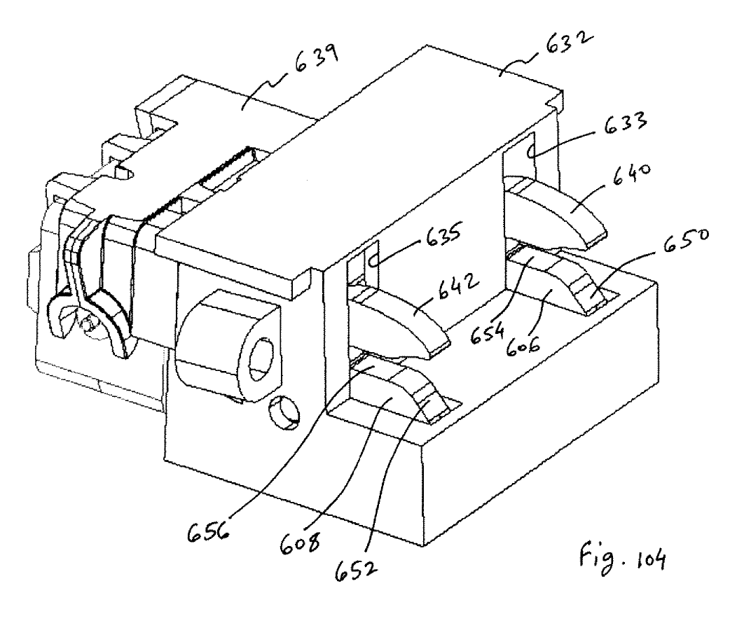

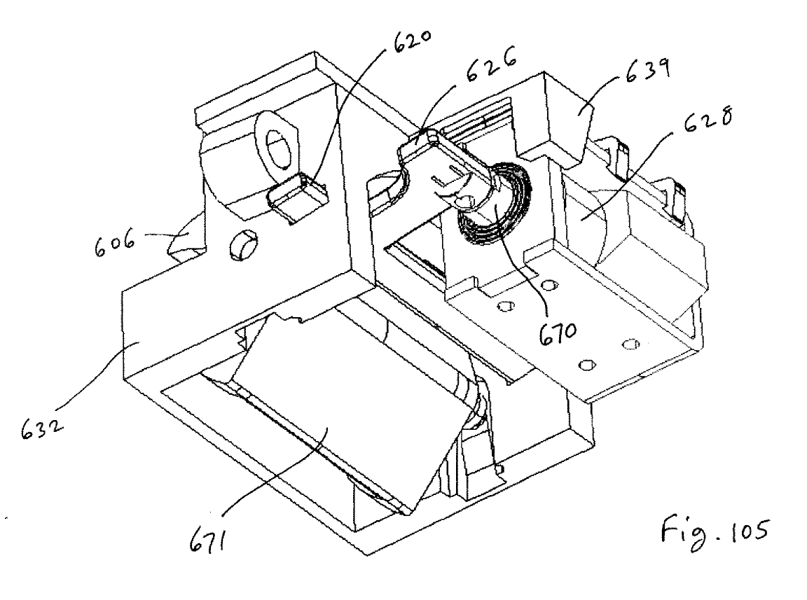

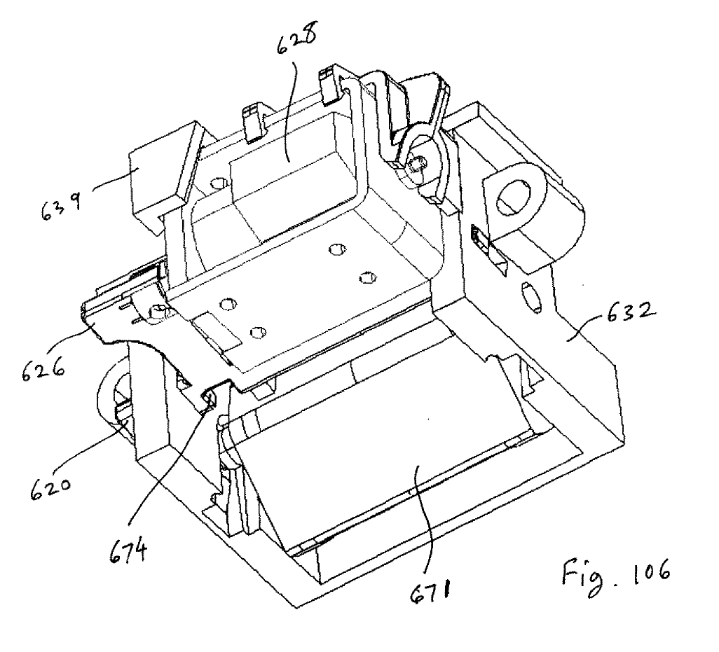

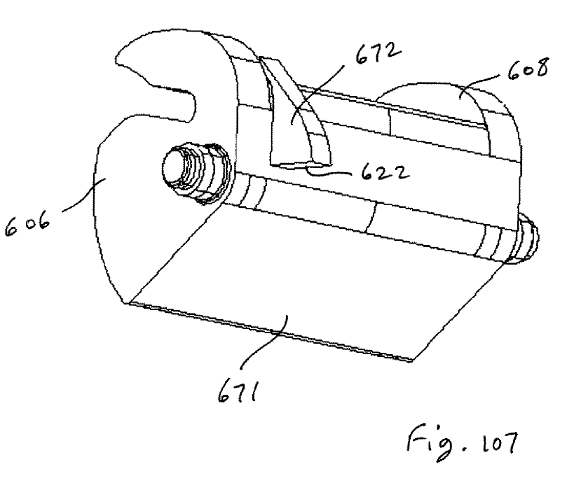

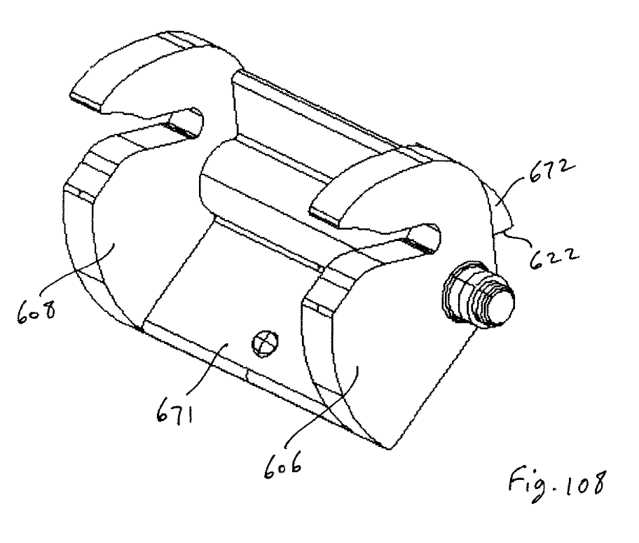

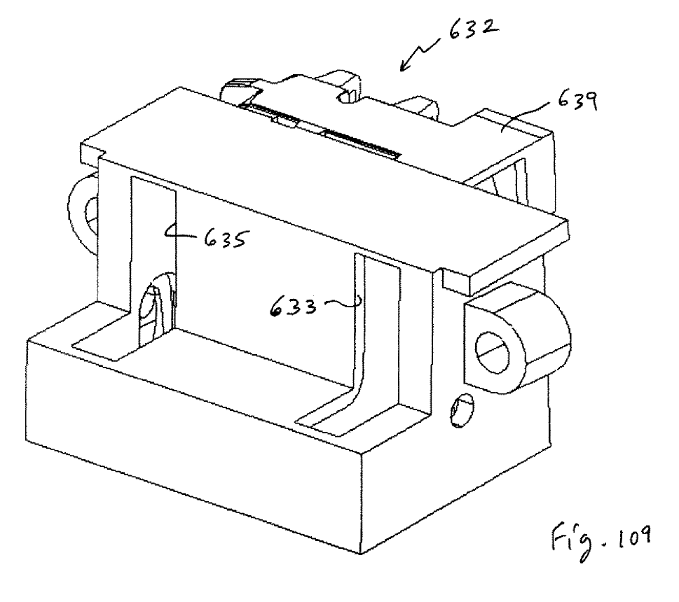

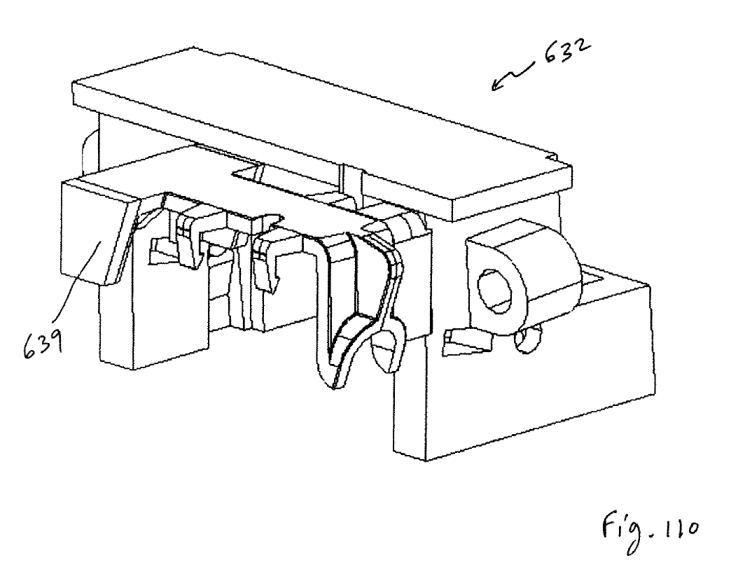

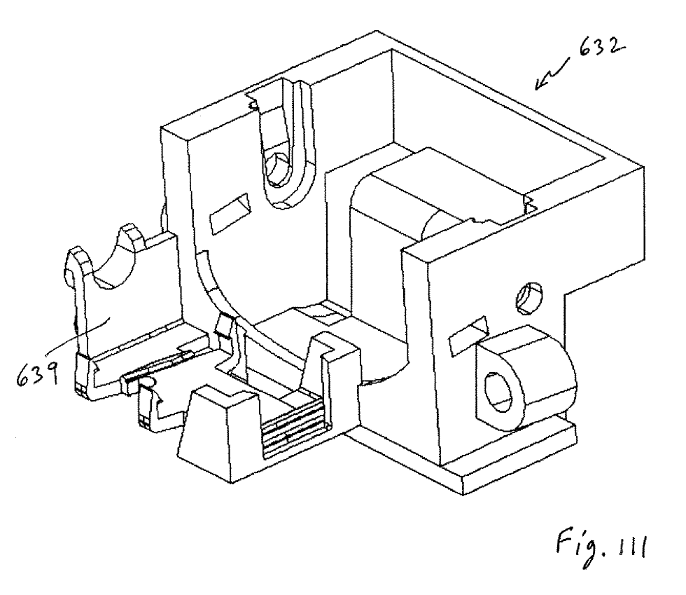

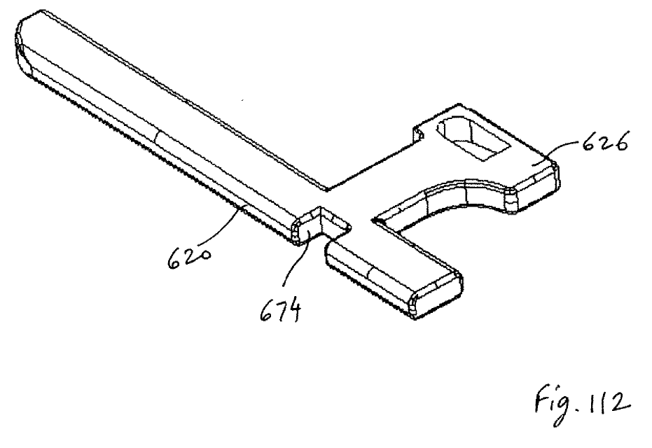

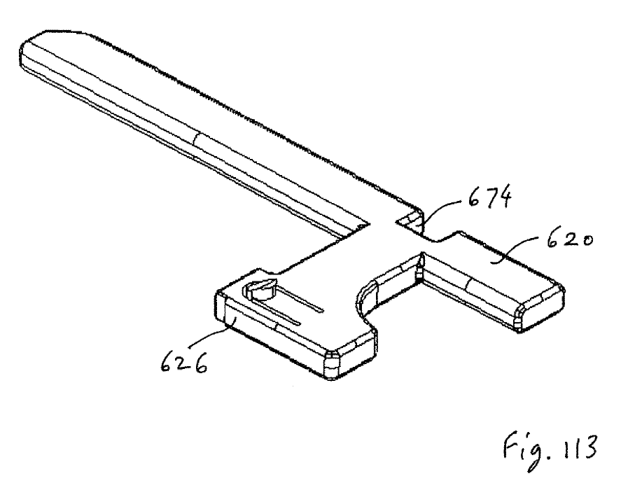

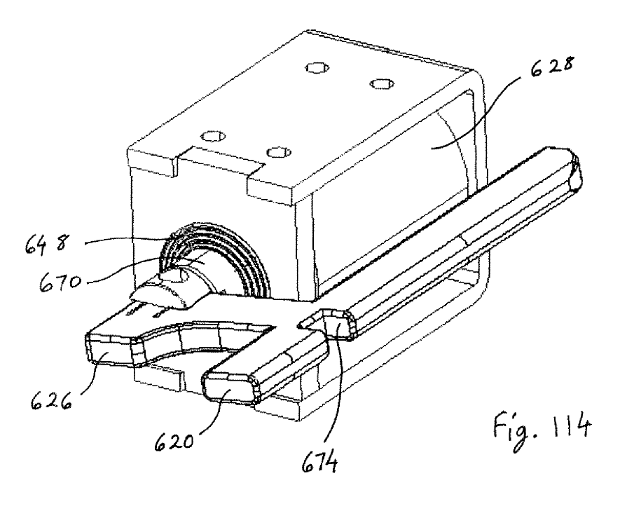

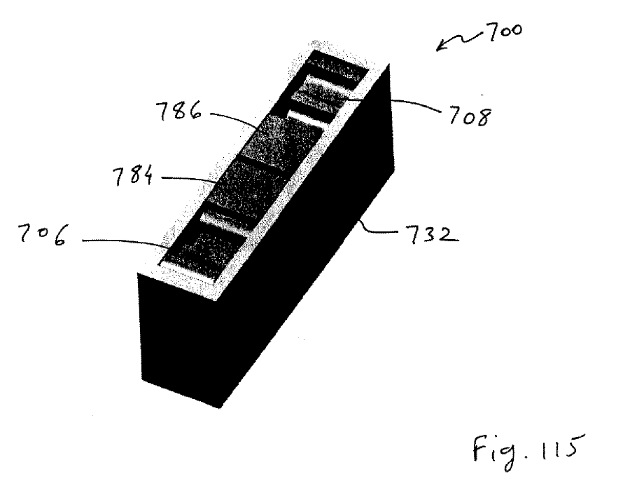

Referring to FIGS. 99-114, a sixth embodiment of a latch 600 with dual rotary pawls according to the present invention can be seen. The latch 600 is a solenoid operated latch designed to lock two doors, using two rotating pawls 606 and 608, and is situated between the pivots or hinges of the doors with the pawls 606, 608 rotating in parallel, spaced apart planes. The latch 600 is similar to the latch 500, except that the pawls are rigidly connected by an angle bracket 671 extending between the pawls and rigidly connecting the pawls together, thus the latch 600 provides for simultaneous latching of double doors. The axis of rotation of the pawls 606 and 608 are coincident as with the latch 500, but the pawls are not independent. The latch 600 is designed to engage striker rods that are in line rather than parallel. The pawls 606 and 608 are linked such that they move pivotally as one unit, which means that one torsion spring and only one locking bar 620 is required. For the sake of brevity only those features of the latch 600 that are different from the latch 500 are discussed in detail below. The pawls 606, 608 are rotationally movable between respective latched and unlatched positions, where they respectively latch and unlatch their respective striker rods. One or two torsion springs (not shown) bias the pawls 606, 608 toward their unlatched positions. The bracket 671 rigidly connects the pawls 606, 608 as one unit, which may be of one-piece construction. The back of the bracket 671 has a projecting fin 672 that forms a step 622 at one end. The locking bar 620 is rectilinearly movable between engaged and disengaged positions. In the engaged position the locking bar 620 engages the step or notch 622, when the pawl 606 is in the latched position, to maintain the pawl 606 in its latched position. In the disengaged position a notch 674 in the locking bar 620 registers with the fin 672 and allows the fin 672 to clear the locking bar 620 and for the locking bar 620 to disengage from the step 622 thereby freeing the pawls 606, 608 to rotate to their unlatched positions under the biasing force of the torsion spring. The locking bar 620 is attached to the operating rod 626, which is attached to the solenoid shaft 670 for rectilinear movement with the solenoid shaft 670. The solenoid 628 is also supported by the housing 632. The locking bar 620 moves rectilinearly between the engaged position and the disengaged position in response to the rectilinear movement of the operating rod 626 between a first position corresponding to the engaged position of the locking bar 620 and a second position corresponding to the disengaged position of the locking bar 620.

The housing 632 has a pair of slots 633 and 635 through which the pawls 606, 608 can engage their respective striker rods. A solenoid support bracket 639 is provided on the side of housing 632.

In the unlatched position the pawl claws 640, 642, respectively, of both pawls 606, 608 are positioned, due to spring bias such that the pawl claws 640, 642 point upward and are out of the way of the striker rods as the doors move toward the closed position relative to the compartment opening.

The return spring 648 of the de-energized solenoid can set up to push or pull the locking bar 620 against the sides of the fin 672 when the pawls 606, 608 are not in their latched positions. As the doors move toward their closed positions, the striker rods are bought into contact with the cam surfaces 650 and 652 of the pawls 606 and 608, respectively. Each of the pawls 606 and 608 is rotationally supported by the housing 632 such that each pawl rotates about its own axis of rotation. The contact point between each striker rod and the cam surface 650, 652 of the respective pawl 606, 608, and the path of each striker rod, are offset from the axis of rotation of the respective pawl 606, 608. Therefore, as each striker rod impacts the respective cam surface 650, 652 due to the movement of the doors toward their closed positions, a torque tending to rotate the respective pawl 606, 608 toward the latched position is exerted by each striker rod on its respective pawl 606, 608. As a result, each pawl 606, 608 is rotated to its latched position due to the movement of the doors toward their closed positions. As each of the pawls 606, 608 rotates to its respective latched position due to the closing of the doors, the claw 640, 642 of each pawl 606, 608 hooks around the respective striker rod. Once the pawls 606, 608 complete their rotation to their latched positions, the locking bar 620 moves to its engaged position under the bias of the spring 648. In the engaged positions the locking bar 620 is positioned under and into engagement with the step 622 to thereby prevent the rotation of the pawls 606, 608 out of their latched positions. Thus, the locking bar 620 holds the latch 600 in the latched configuration with the claws 640, 642 hooked around their respective striker rods, and thereby secures the doors in the closed position.

To open the latch 600 the solenoid is energized. Energizing the solenoid 628 causes the operating rod 626 to move rectilinearly and position the notch 674 in registry with the fin 672, thus freeing the pawls 606 and 608 to rotate to their respective unlatched positions. The striker rods are then free to move away from the latch 600, thus allowing the doors to be opened. Each claw 640, 642 is spaced apart from the cam surface 650, 652 of the respective pawl 606, 608 such that each claw 640, 642 and the respective cam surface 650, 652 cooperatively define a respective pawl slot 654, 656. The striker rods are received in the pawl slots 654, 656, respectively, when the pawls 606, 608 are in the latched position and the doors are secured in the closed position.

In the latch 600 the two pawls move as one unit and therefore this embodiment provides for simultaneous latching when one striker rod lags behind. The pawl slots 654, 656 are wide enough near the tips of the claws 640, 642 such that even if only one of the striker rods contacts the respective cam surface 650, 652 of its respective pawl 606, 608 and the other striker rod lags the striker rod that is in contact with its respective cam surface, the lagging striker rod can be hooked and pulled into position by the claw 640, 642 of its respective pawl 606, 608 to allow the doors to be secured in the closed position essentially simultaneously. The achievement of this result is further facilitated by providing for the pawl slots 654, 656 to be tapering such that they are widest near the tips of the claws 640, 642 and become gradually narrower closer to the closed bottom of the pawl slot. With this geometry once the lagging striker rod is hooked by the respective pawl claw 640, 642, the lagging striker rod is accelerated such that the lagging rod catches up to the other rod as the pawls 606, 608 rotate to their latched positions.

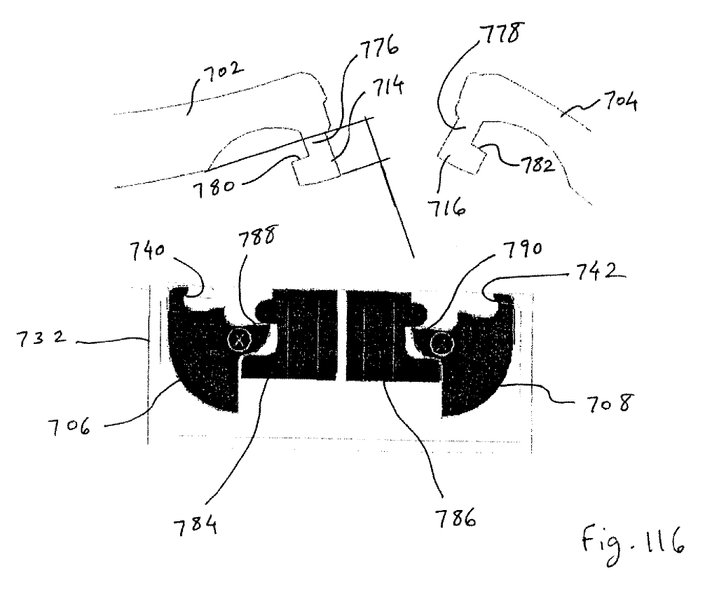

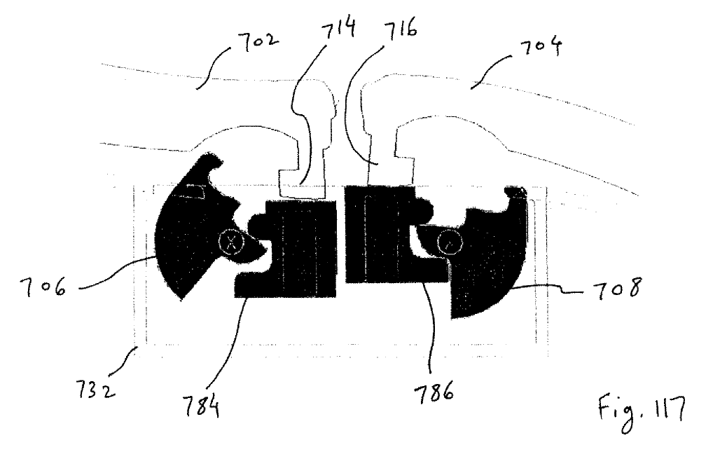

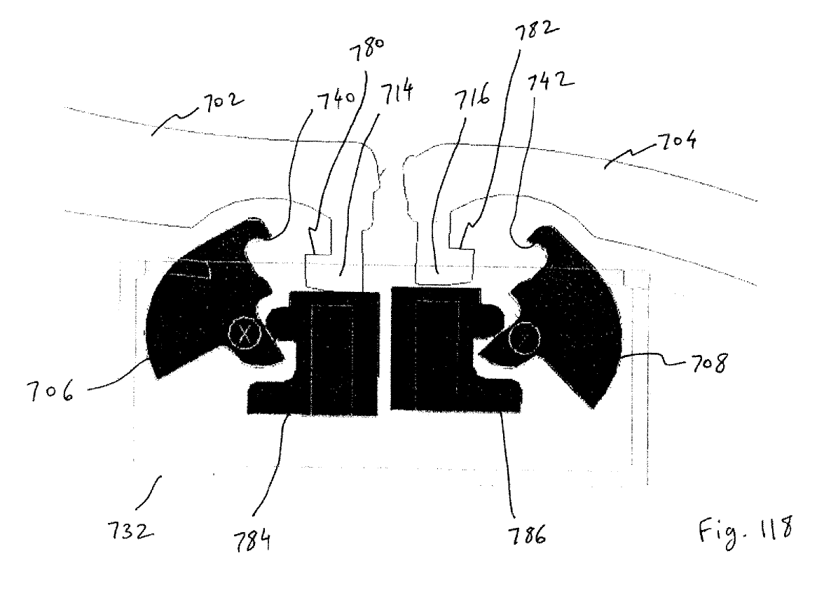

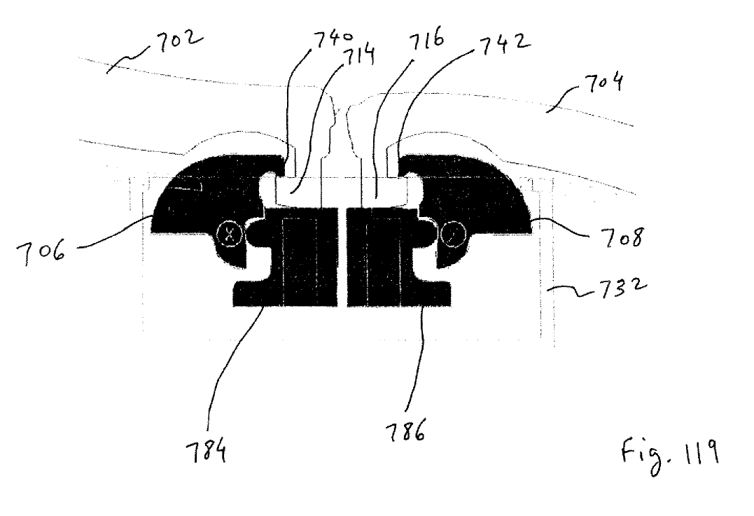

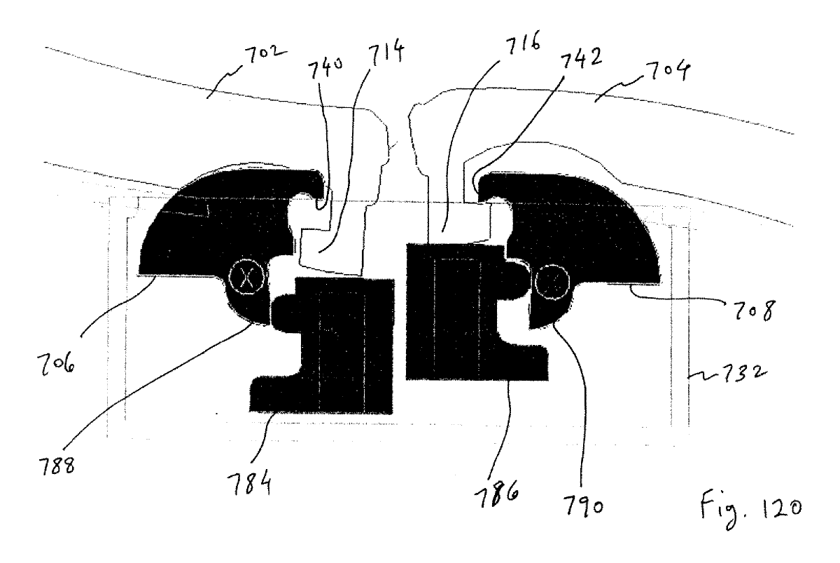

Referring to FIGS. 115-120, a seventh embodiment of a latch 700 with dual rotary pawls according to the present invention can be seen. The latch 700 is a solenoid operated latch designed to lock two doors 702 and 704 simultaneously, using two rotating pawls 706 and 708, and is situated between the pivots or hinges of the doors 702, 704 with the pawls 706, 708 rotating in the same plane. The latch 700 is essentially similar to the latch 400, but it is more compact. The pawls 706 and 708 are completely independent. For the sake of brevity only those features of the latch 700 that are different from the latch 400 are discussed in detail below. The pawls 706, 708 are rotationally movable between respective latched and unlatched positions, where they respectively latch and unlatch their respective strikers 714 and 716. The strikers are L-shaped and are formed by a supporting post 776, 778 and an overhanging catch surface 780, 782. The latch 700 includes a housing 732 that houses a pair of slides 784, 786 that are supported for rectilinear movement within the housing 732. The slides 784, 786 have recesses that receive projections 788, 790 of the pawls 706, 708 such that rectilinear motion of the slides 784, 786 causes rotational motion of the pawls 706, 708 between their respective latched and unlatched positions. The slides 784, 786 can be spring biased toward the open top of the housing 732 to thereby bias the pawls 706, 708 toward their unlatched positions. Arrangements similar to that used for latch 400 may be used to selectively retain the pawls 706, 708 in their latched positions, or locking bars and a solenoid may be provided that engage the slides 784, 786.

In the unlatched position the pawl claws 740, 742, respectively, of both pawls 706, 708 are positioned, due to the spring bias applied to the slides 784, 786, such that the pawl claws 740, 742 point upward and are out of the way of the strikers 714 and 716 as the doors 702, 704 move toward the closed position relative to the compartment opening. As the doors 702, 704 move toward their closed positions, the strikers 714, 716 are bought into contact with the slides 784, 786, which are pushed into the housing 732. The contact between each slide and the projections 788, 790 causes the rotation of the pawls 706, 708 toward the latched position as each slide is pushed into the housing 732. As a result, each pawl 706, 708 is rotated to its latched position due to the movement of the doors 702, 704 toward their closed positions. As each of the pawls 706, 708 rotates to its respective latched position due to the closing of the doors 702, 704, the claw 740, 742 of each pawl 706, 708 hooks under the catch surface of the respective striker 714, 716. Once the pawls 706, 708 complete their rotation to their latched positions, the pawls are selectively retained in the latched position by an appropriate mechanism as previously discussed.

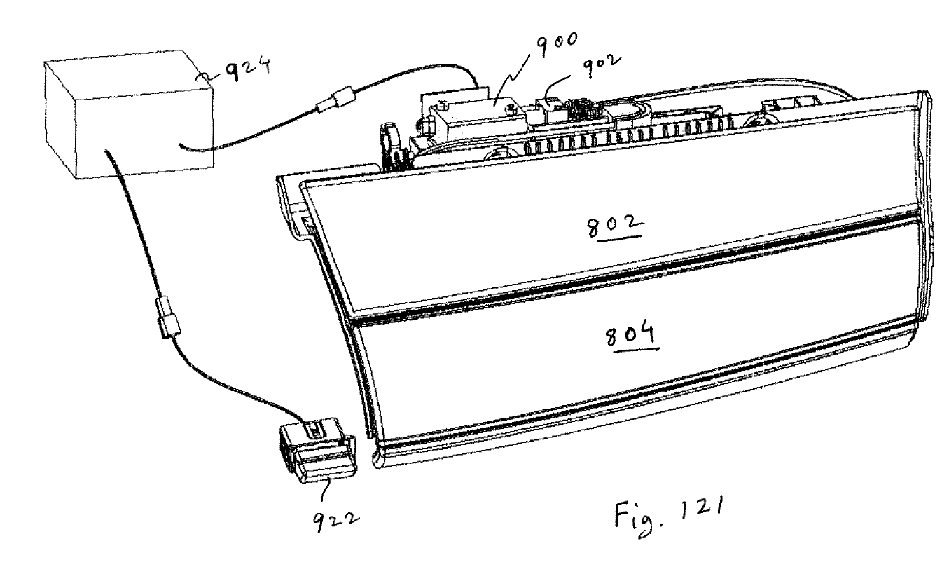

In the latch 700 the two pawls are independent of each other and therefore this embodiment does not provide simultaneous closing when one striker rod lags behind. The latch 700 relies on the doors 702 and 704 to have a large over travel (as shown in FIG. 120) to allow the lagging striker rod to finally reach its fully latched position via the help of the mechanism linking the doors.

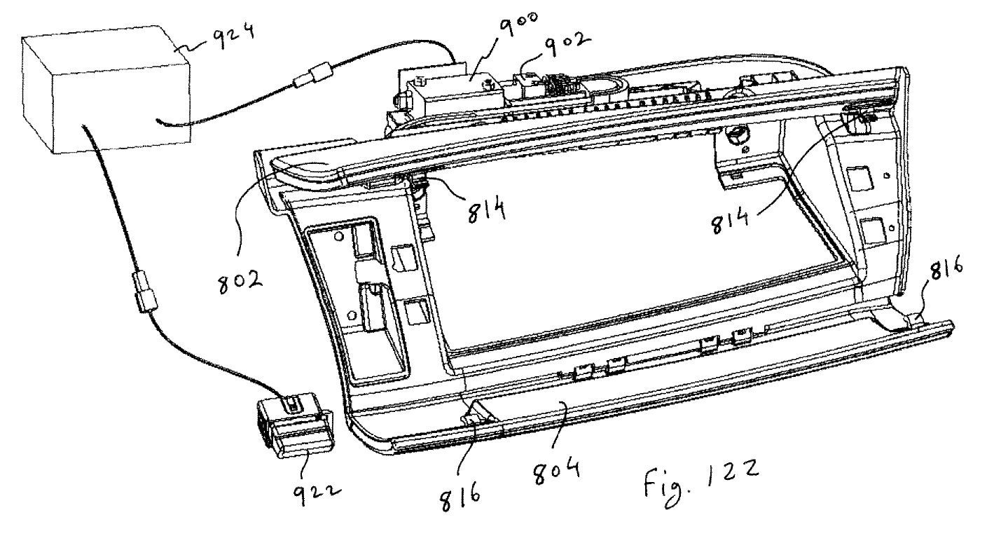

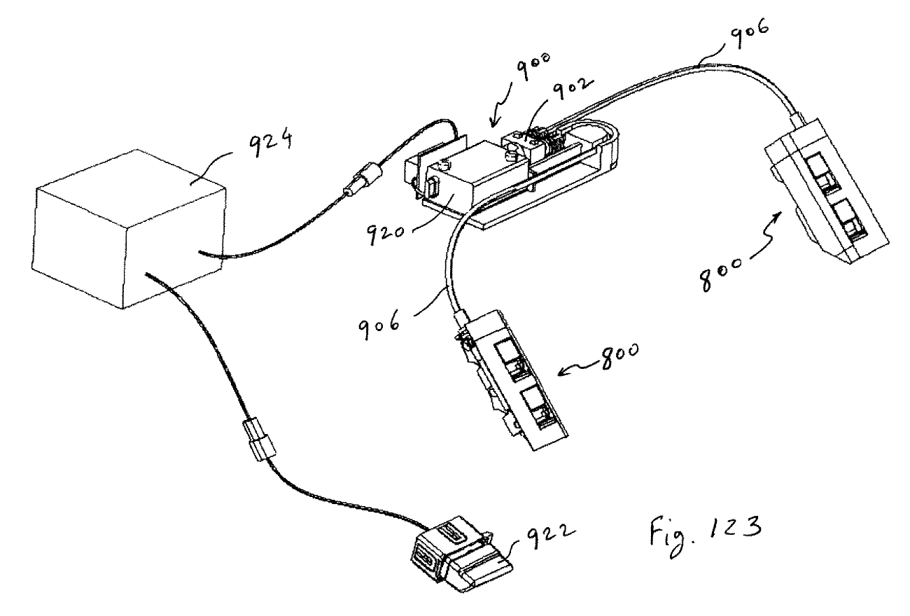

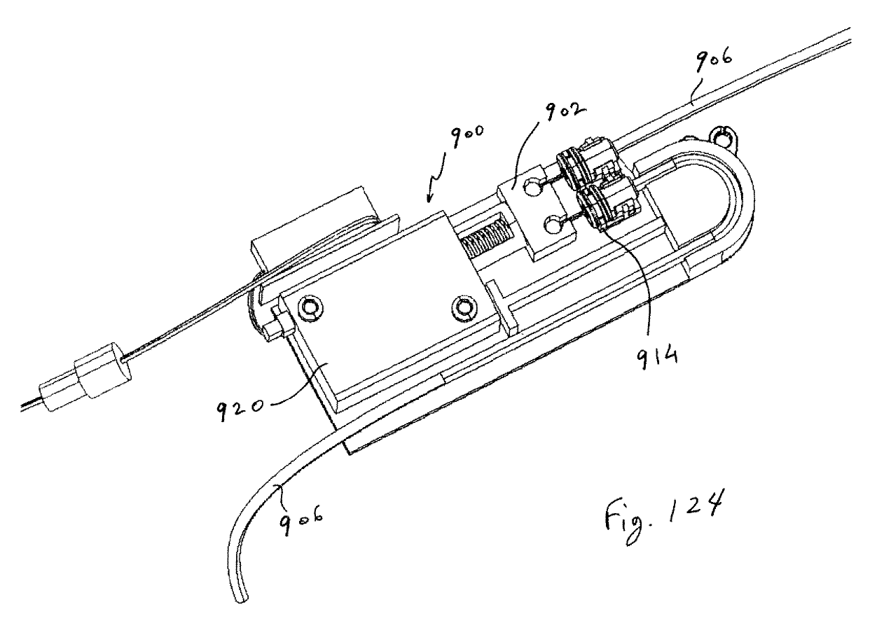

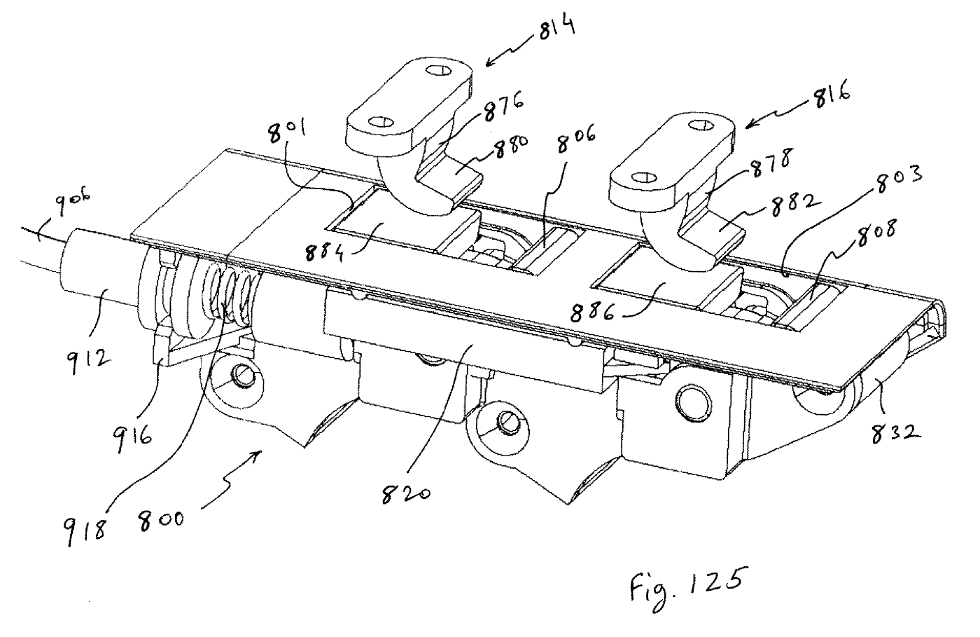

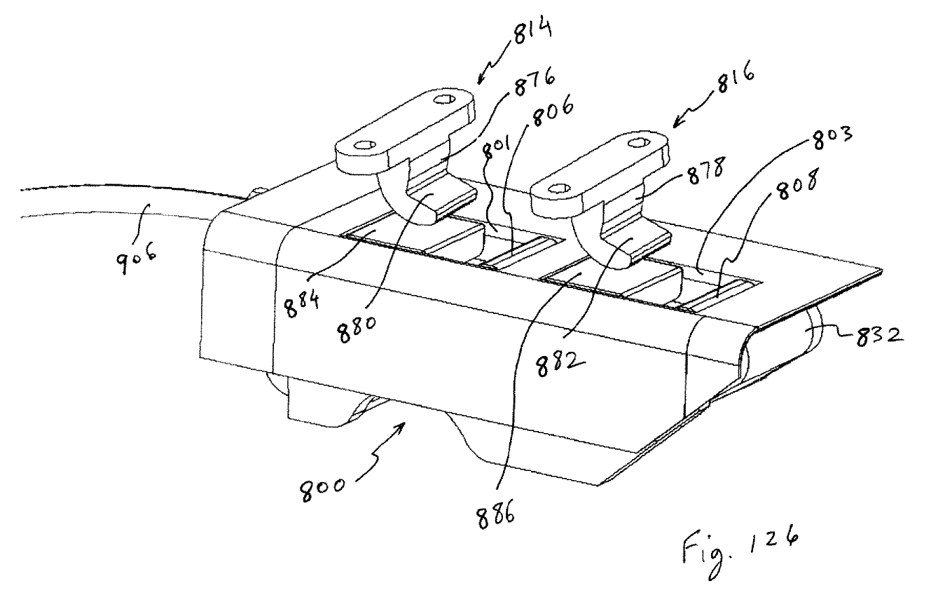

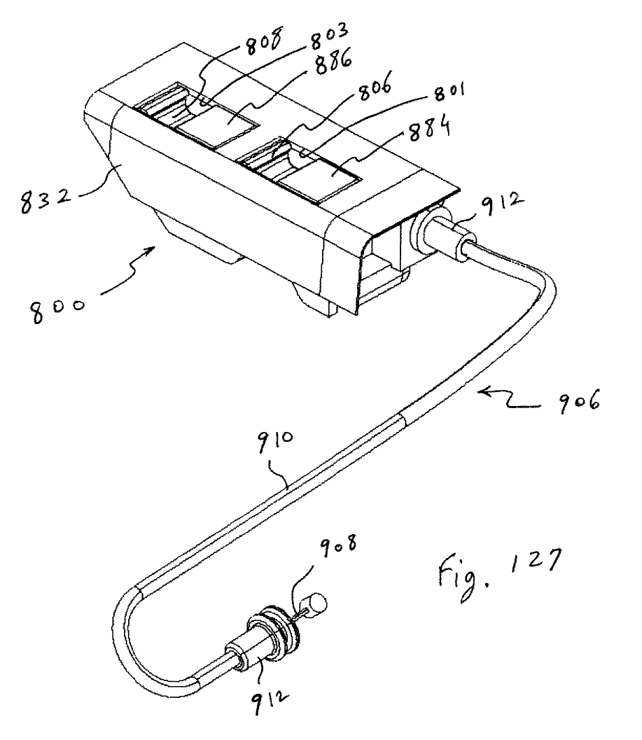

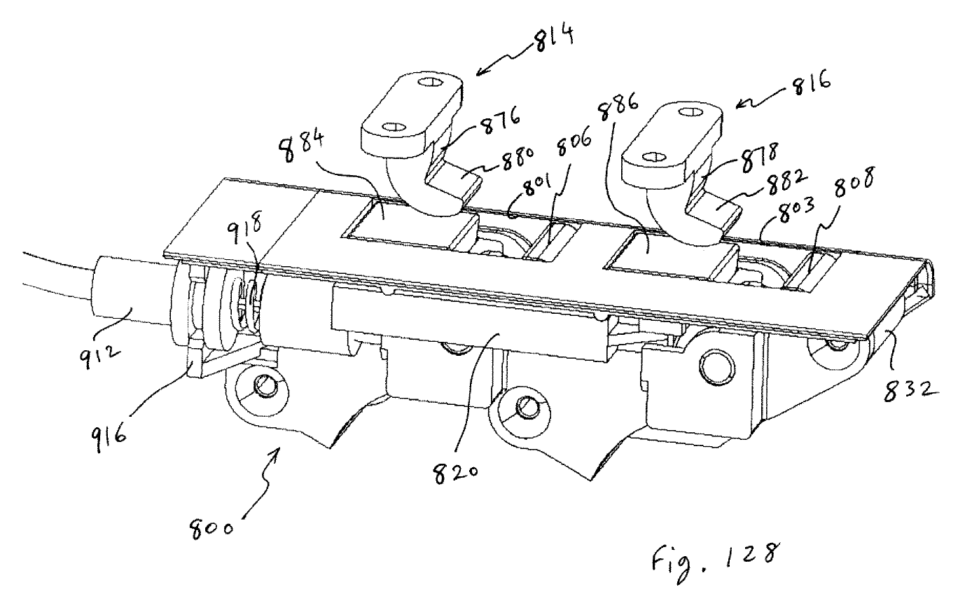

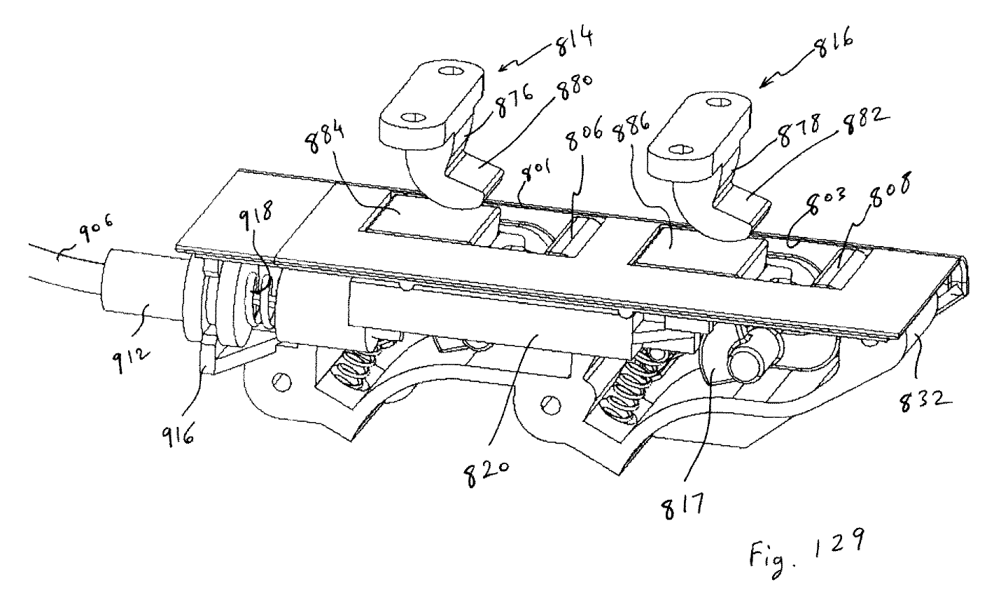

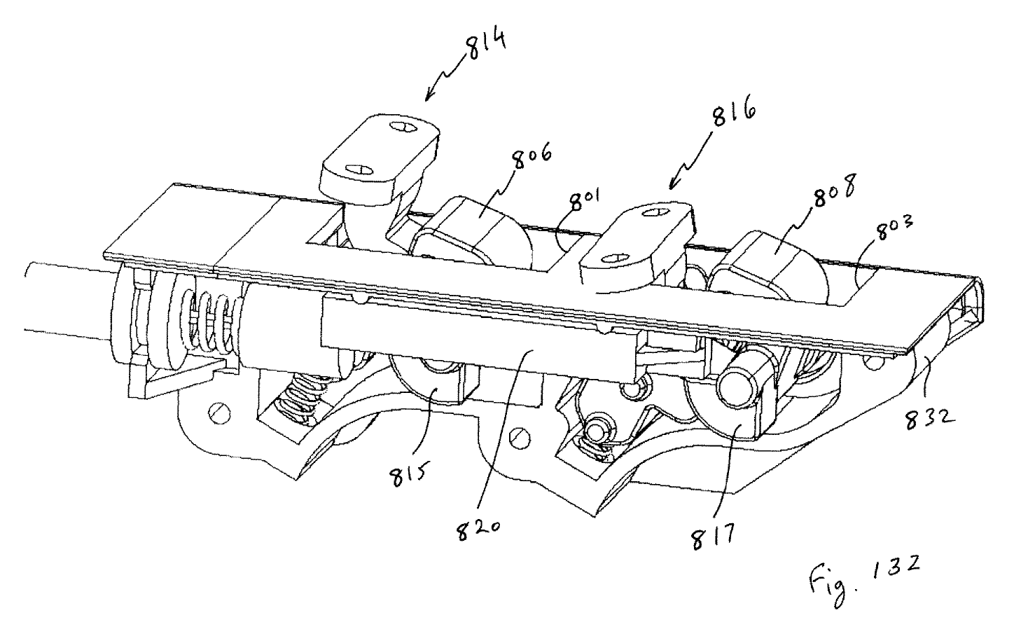

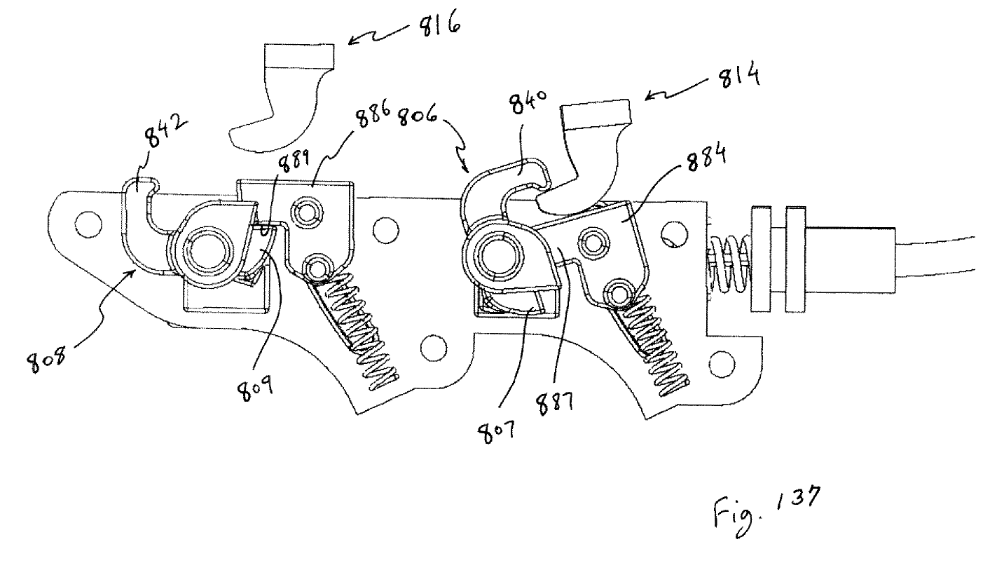

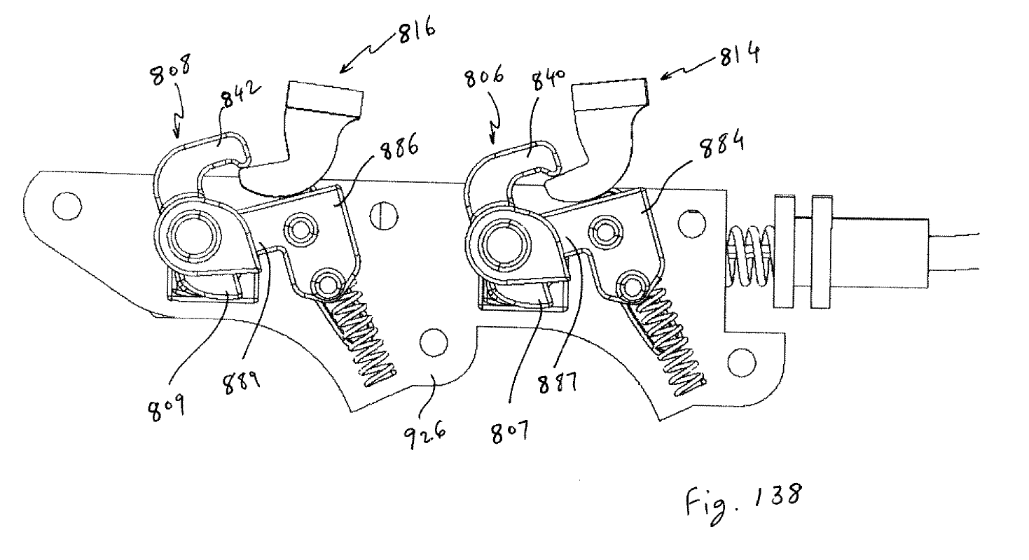

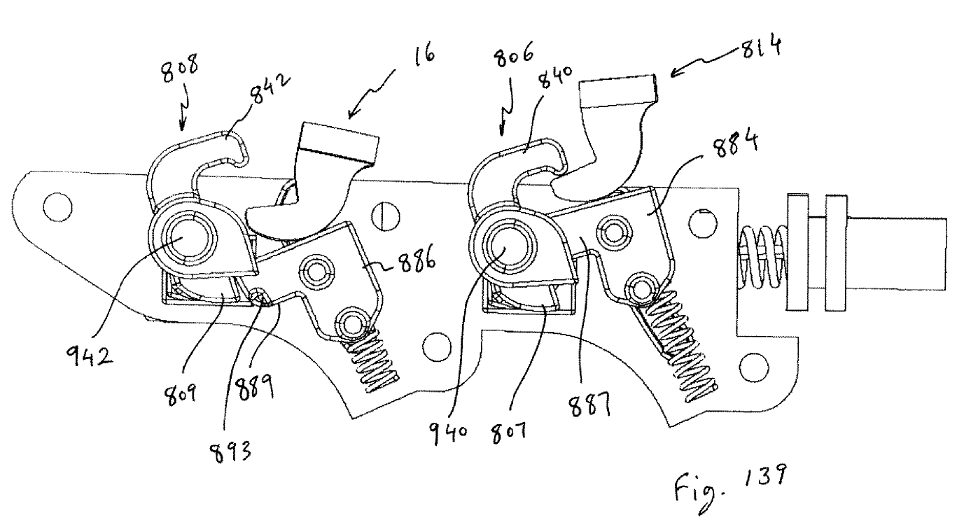

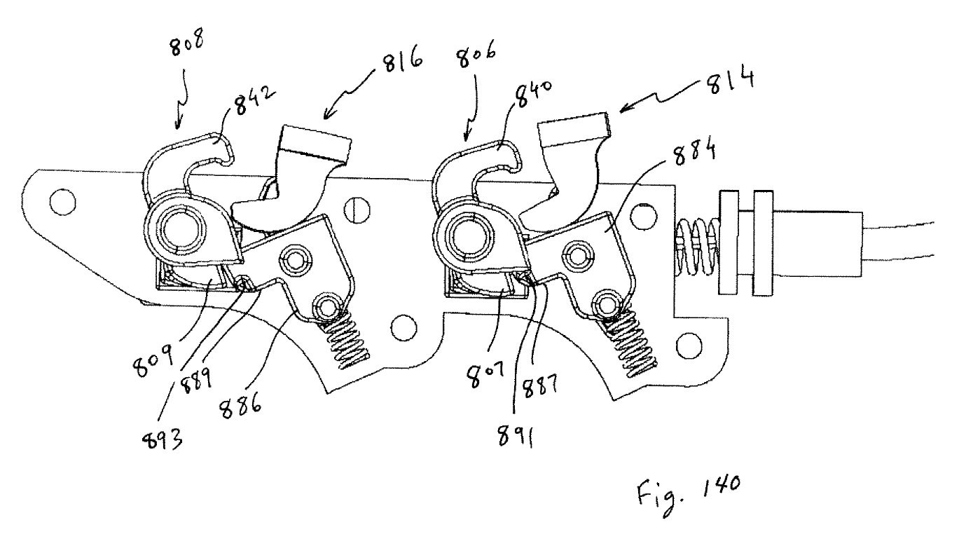

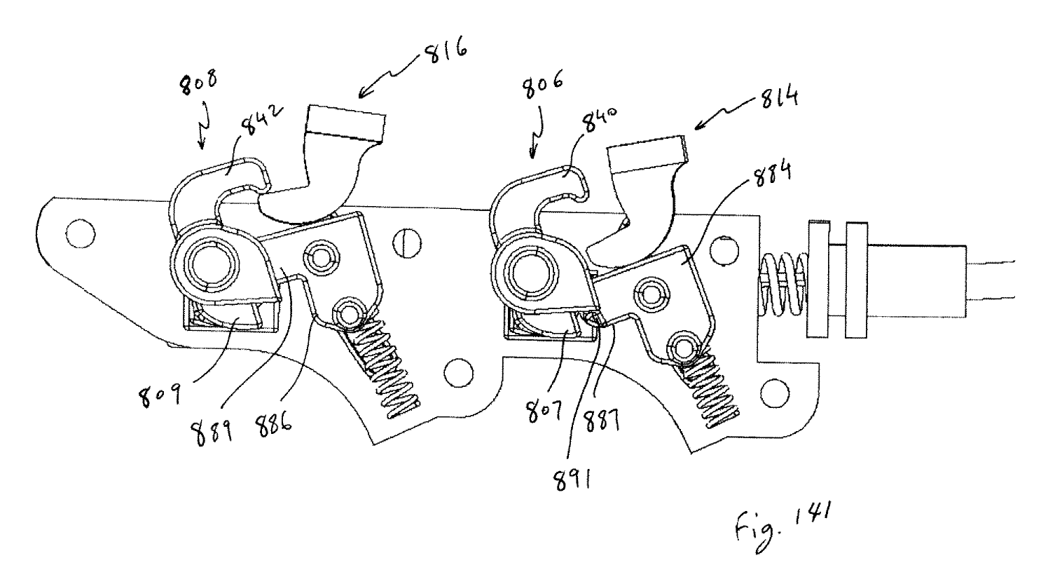

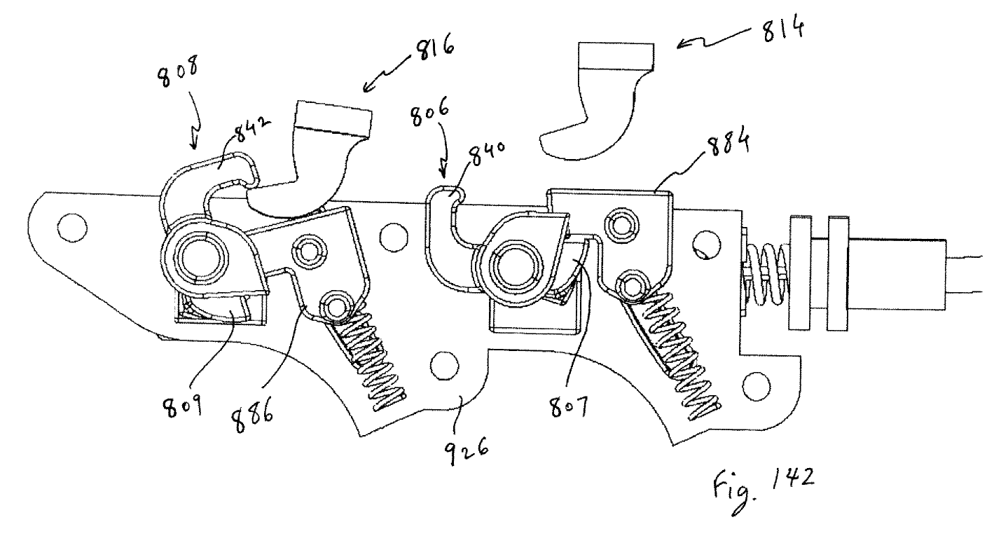

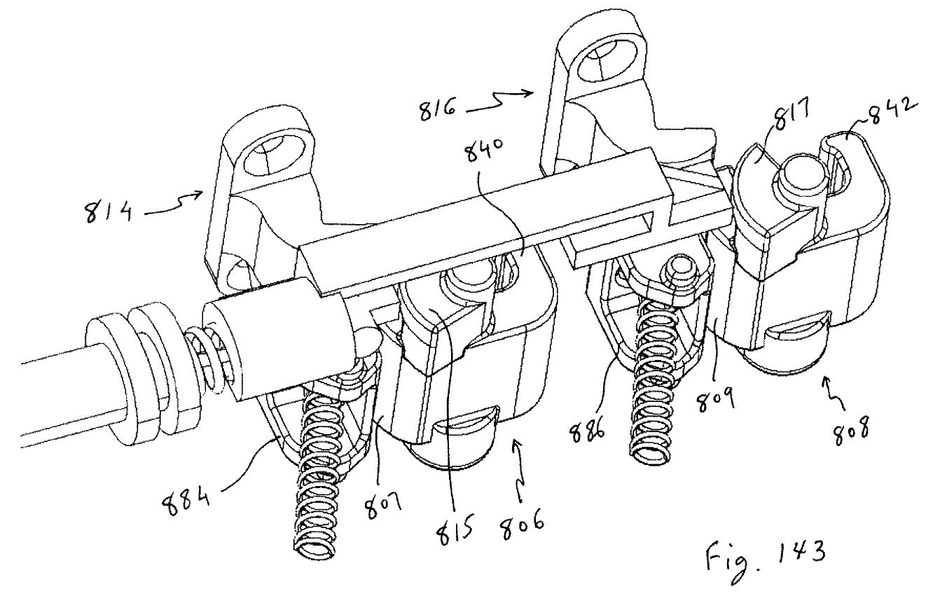

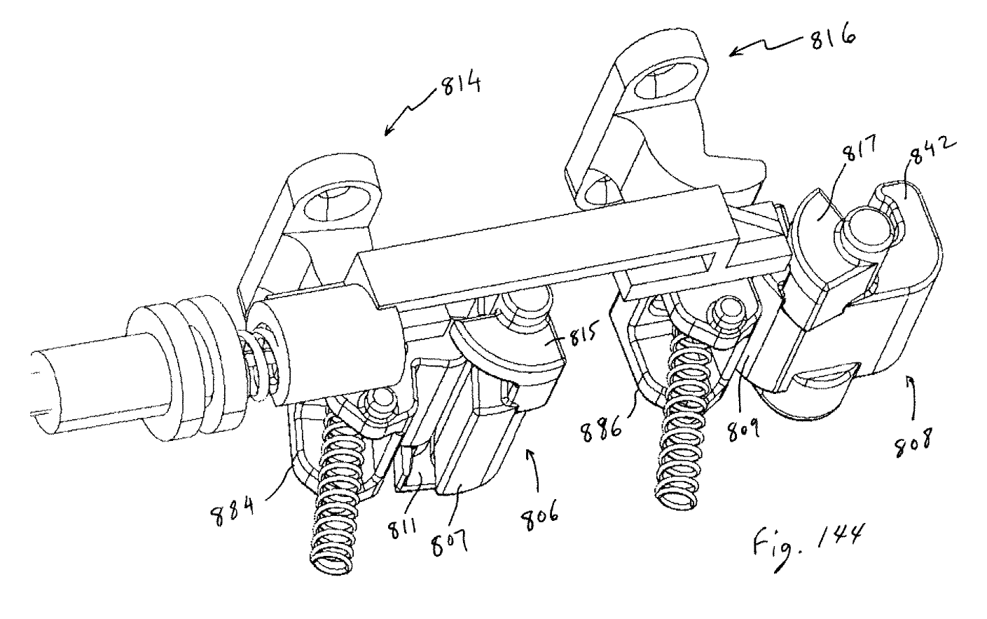

Referring to FIGS. 121-143, a latch 800 with dual rotary pawls according to the present invention can be seen. The latch 800 is an electrically operated latch designed to secure two doors 802 and 804 in the closed position substantially simultaneously, using two rotating pawls 806 and 808. The latch 800 is designed to be installed between the pivots or hinges of the doors 802, 804 with the pawls 806, 808 about parallel axes of rotation. Also the pawls 806, 808 rotate in the same direction. The pawls 806 and 808 are completely independent. The pawls 806, 808 are rotationally movable between respective latched and unlatched positions, where they respectively latch and unlatch their respective strikers 814 and 816. Each striker 814, 816 is attached to a respective one of the doors 802, 804. The strikers are L-shaped and are formed by a supporting post 876, 878 and an overhanging catch surface 880, 882. The latch 800 includes a housing 832 that houses a pair of pads 884, 886 (also referred to as slides) that are supported for a combination of pivotal and rectilinear movements within the housing 832. The top openings 801 and 803 of the housing 832 allow the strikers 814, 816 to engage the pads 884, 886 and the pawls 806, 808.

The pads 884, 886 have overhanging steps 887 and 889 that are positioned over the tail ends 807, 809 of the pawls 806, 808 when the pawls are in their unlatched positions. The Pawls 806, 808 have L-shaped claws 840, 842 that can engage the L-shaped strikers 814, 816, respectively, in interlocking fashion when the pawls are in the latched position. The claw 840 and the tail end 807 of the pawl 806 project outward in opposite directions relative to the axis of rotation of the pawl 807. Similarly, the claw 842 and the tail end 809 of the pawl 808 project outward in opposite directions relative to the axis of rotation of the pawl 808. Accordingly, as the pads 884, 886 are pushed inward into the housing 832 by each striker contacting a respective pad, the overhanging step 887, 889 of each pad 884, 886 engages the tail end 807, 809 of the respective pawl 806, 808 and causes the pawl to rotate toward the latched position. In addition, each of the pawls 806, 808 has an open-ended cam groove 811, 813 that receives an index projection 891, 893 of a respective one of the pads 884, 886 during at least a portion of each pawl's range of movement between its latched and unlatched positions that includes its unlatched position. This arrangement allows the combined pivotal and rectilinear motion of the slides or pads 884, 886 to effect the rotational motion of the pawls 806, 808 between their respective latched and unlatched positions. The slides 884, 886 are spring biased toward the top openings 801 and 803 of the housing 832 to thereby bias the pawls 806, 808 toward their unlatched positions through the engagement between the index projections 891, 893 and the cam grooves 811, 813.

The latch 800 has a single locking bar 820 that engages both pawls to hold the pawls in the latched configuration. Each pawl 806, 808 is provided with a cam lobe 815, 817 in the shape of a circular sector having two radial surfaces with an arc-shaped surface extending between the two radial surfaces. The locking bar 820 has two catch plates 821, 823 that are spaced apart such that each corresponds to a respective pawl 806, 808. The catch plates 821, 823 are connected by a connecting member 825 such that the catch plates 821, 823 move as a unit. The locking bar 820, and consequently the catch plates 821, 823, is movable rectilinearly between a retaining position and a release position. When the pawls 806, 808 are in their latched positions each catch plate 821, 823 engages a respective pawl 806, 808 to maintain the pawls in their latched positions when the locking bar 820 is in the retaining position. Each catch plate 821, 823 engages the radial surface of the cam lobe of the respective pawl 806, 808 that is closest to the claw of the respective pawl when the pawls are in their latched positions and the locking bar 820 is in the retaining position. When the locking bar 820 is in the release position the pawls 806, 808 are released from the latched position and can rotate to the unlatched position. When the locking bar 820 is in the release position and any one of the pawls 806, 808 is intermediate the latched position and the unlatched position, but is not in the latched position, or is in the unlatched position, the locking bar 820 cannot move to the retaining position, because the arc-shaped surface of the cam lobe 815, 817 of the pawl that is not in the latched position will block movement of the locking bar 820 to the retaining position by contact with the respective catch plate 821, 823. This arrangement ensures that the locking bar 820 will not move to the retaining position until both pawls 806, 808 are in the latched position. The locking bar 820 is spring biased toward the retaining position.

The locking bar 820 is remotely operated by a Bowden cable 906 operated by an electrical actuator 900. The actuator 900 is of the type known as a linear actuator and uses a rotary electric motor to rectilinearly move the cable connection block 902 via a rack-and-pinion or screw arrangement. The actuator 900 is attached to a support plate 904. The Bowden cable 906 is a steel cable 908 inside a sleeve 910. The sleeve 910 is of the type whose length remains essentially constant even when subjected to compressive forces. This can be achieved by providing for a flexible but incompressible layer, for example tightly coiled wire, to form the base layer of the sleeve 910. A bushing 912 is provided at each end of the sleeve 910. Each bushing 912 has an annular groove. The support plate 904 has at least one bracket 914 for holding the bushing 912 at one end of the sleeve 910 stationary relative to the support plate 904 by at least in part engaging the annular groove of the bushing. The bushing 912 at the other end of the sleeve to 910 is held stationary relative to the housing 832 by a bracket 916 that is similar to the bracket 914 and is attached to the housing 832. A coils spring 918 is provided between the bushing 912 supported by the housing 832 and the locking bar 820 to bias the locking bar toward the retaining position. One end of the cable 908 is connected to the cable connection block 902 and the other end of the cable 908 is connected to the locking bar 820 through the coils of spring 918.

Energizing the actuator 900 retracts the cable connection block 902 toward the actuator motor housing 920. Because the length of the sleeve 910 is fixed, pulling one end of the cable 908 by energizing the actuator 900 causes the retraction of the locking bar 820 to the release position. De-energizing the actuator 900 allows the locking bar 820 to return to the retaining position due to spring bias once the pawls 806 and 808 return to the latched position. In the illustrated example, the cable connection block 902 has provision for connection of multiple Bowden cables 906 such that multiple latches 800 can be operated by a single actuator 900. Two latches 800 can be mounted on either side of the glove box opening as illustrated. A push button 922 can be mounted on the vehicle's dashboard to operate the latches 800 via the control and power circuitry in housing 924.

The housing 832 has top openings 801 and 803 and a removable side plate 926. The side plate 926 has two pockets 928 and 930 each of which supports a respective catch plate 821, 823 for rectilinear motion. The pocket 928 is open on the side formed by the side plate 926 such that the cam lobe 815 can be received at least in part in the pocket 928 such that the catch plate 821 can interact with the cam lobe 815 in the fully assembled latch as previously described. The pocket 930 is open on the side formed by the side plate 926 such that the cam lobe 817 can be received at least in part in the pocket 930 such that the catch plate 823 can interact with the cam lobe 817 in the fully assembled latch as previously described. The pocket 928 has a hole in the side opposite the side plate 926. Similarly, the pocket 930 has a hole in the side opposite the side plate 926. Each pawl 806, 808 has a projection 932, 934, respectively, that fits into the hole formed in the side opposite the side plate 926 of the respective pocket 928, 930. The projections 932, 934 in part provide for the rotational support of the pawls 806, 808 within the housing 832. The side of the housing 832 opposite the side plate 926 has two projections 936, 938 that register with the holes that receive the projections 932 and 934, respectively. The projections 936, 938 fit into cavities 940 and 942, respectively, formed in the pawls 806 and 808 to provide for the rotational support of the pawls 806, 808 within the housing 832 on both sides of the pawls 806 and 808. The side plate 926 is provided with screw holes for mounting it to the housing 832.

The paths and orientations of the pads 884, 886 as they are pushed into the housing 832 by the strikers 814, 816 are determined by the slots 944, 946, 948, and 950. The slots 944 and 948 are formed in the side plate 926 and the slots 946 and 950 are formed in the side of the housing opposite the side plate. The slot 944 receives pins 952 and 954 of pad 884. The slot 946 receives pins 956 and 958 of pad 884. The slot 948 receives pins 960 and 962 of pad 886. The slot 950 receives pins 964 and 966 of pad 886. The slots 944 and 946 are superimposed and coextensive. Similarly, the slots 948 and 950 are superimposed and coextensive. The slots 944, 946, 948, and 950 are kinked at a location near the end of each slot closest to the top openings 801 and 803 of the housing 832. The kinked slots 944, 946, 948, and 950 provides for an initial pivotal movement of the pads 884, 886, but once all the pins are in the lower straight portion of the slots 944, 946, 948, and 950 the pads 884, 886 maintain a constant orientation throughout the rest of their range of motion.

In the unlatched position the pawl claws 840, 842, respectively, of both pawls 806, 808 are positioned, due to the spring bias applied to the slides 884, 886, such that the pawl claws 840, 842 point upward and are out of the way of the strikers 814 and 816 as the doors 802, 804 move toward the closed position relative to the compartment opening. As the doors 802, 804 move toward their closed positions, the strikers 814, 816 are bought into contact with the slides 884, 886, which are pushed into the housing 832. The contact between each slide and the tail end 807, 809 of the respective pawl 806, 808 causes the rotation of the pawls 806, 808 toward the latched position as each slide is pushed into the housing 832. As a result, each pawl 806, 808 is rotated to its latched position due to the movement of the doors 802, 804 toward their closed positions. As each of the pawls 806, 808 rotates to its respective latched position due to the closing of the doors 802, 804, the claw 840, 842 of each pawl 806, 808 hooks under the catch surface of the respective striker 814, 816. Once the pawls 806, 808 complete their rotation to their latched positions, the pawls are selectively retained in the latched position by locking bar 820. To open the doors 802, 804, the push button is pushed causing the actuator 900 to be energized and the locking bar 820 to be retracted to the release position such that the pawls 806, 808 are released to rotate to the unlatched position and thus release the strikers 814, 816 to allow the doors to be opened.

The latch 800 provides for the complete closing of both doors when one striker lags behind. The latch 800 relies on the doors 802 and 804 having some over travel (within specified limits) to allow the lagging striker to finally reach its fully latched position via the help of the mechanism linking the doors.

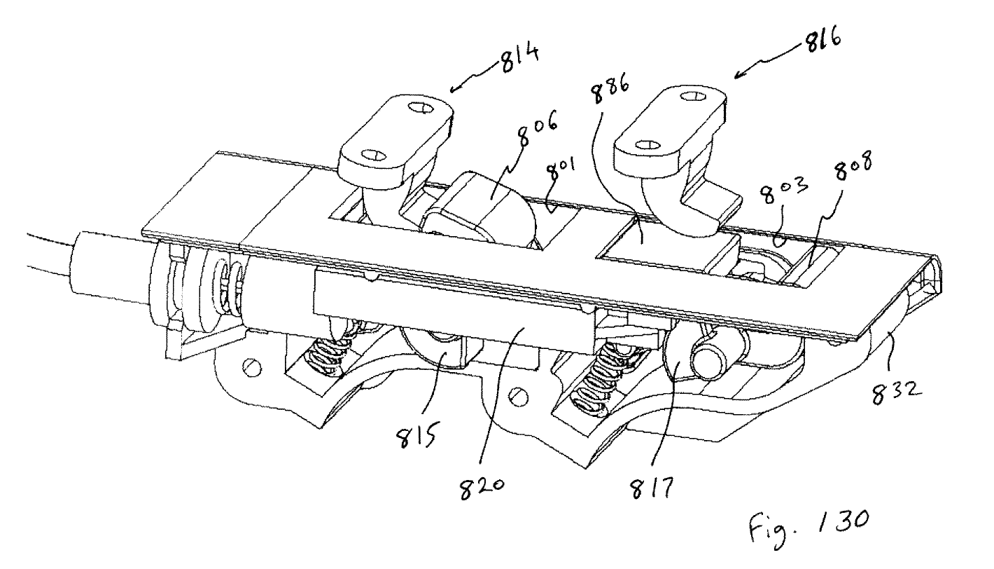

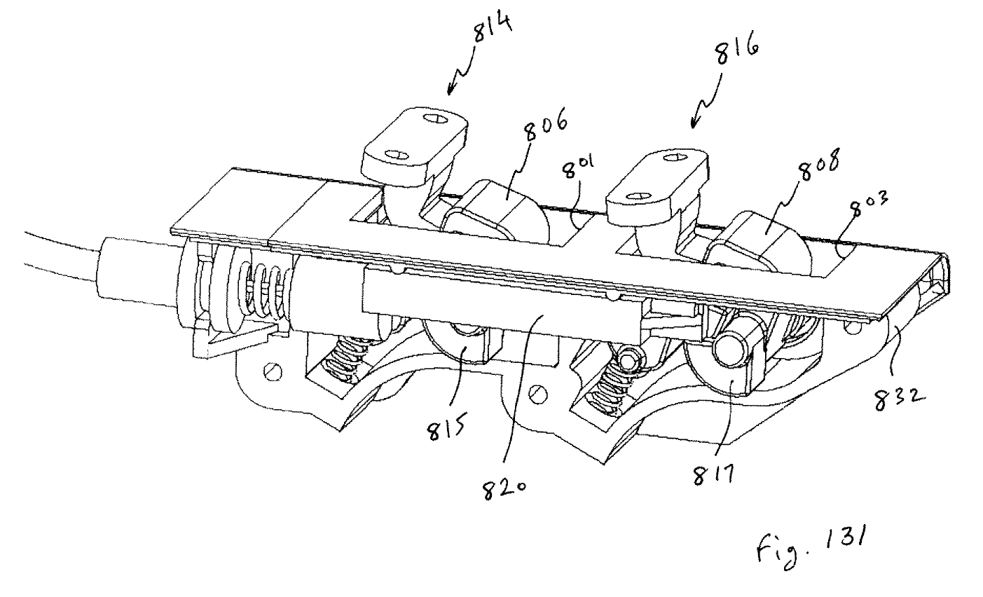

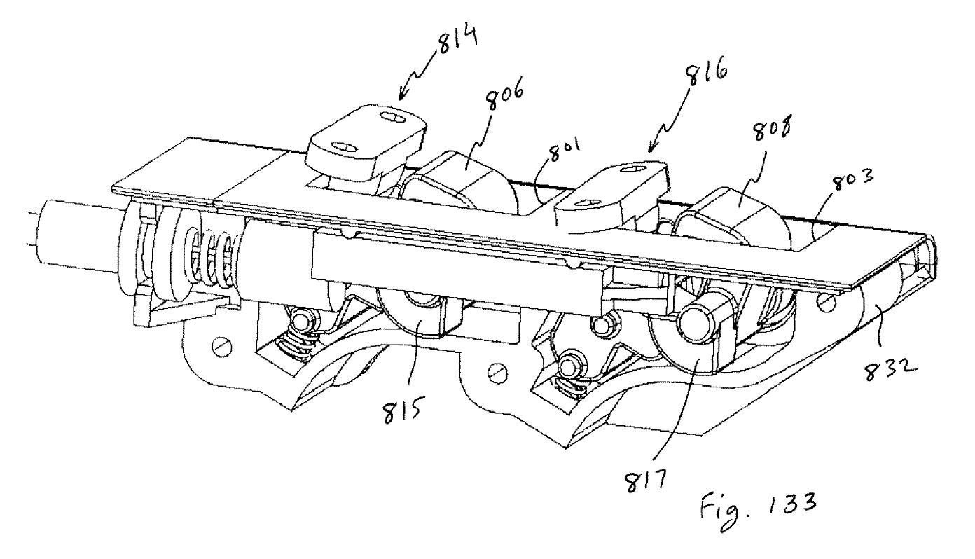

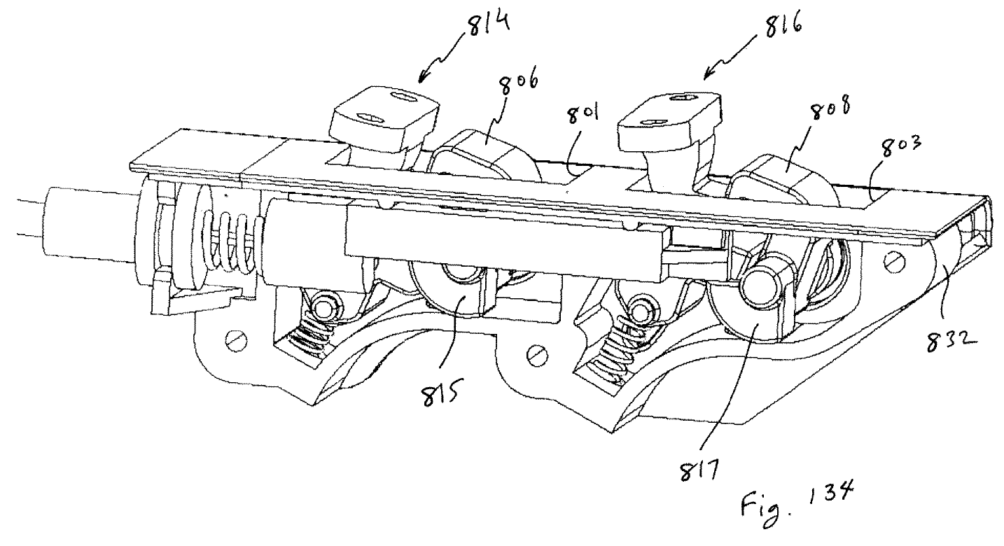

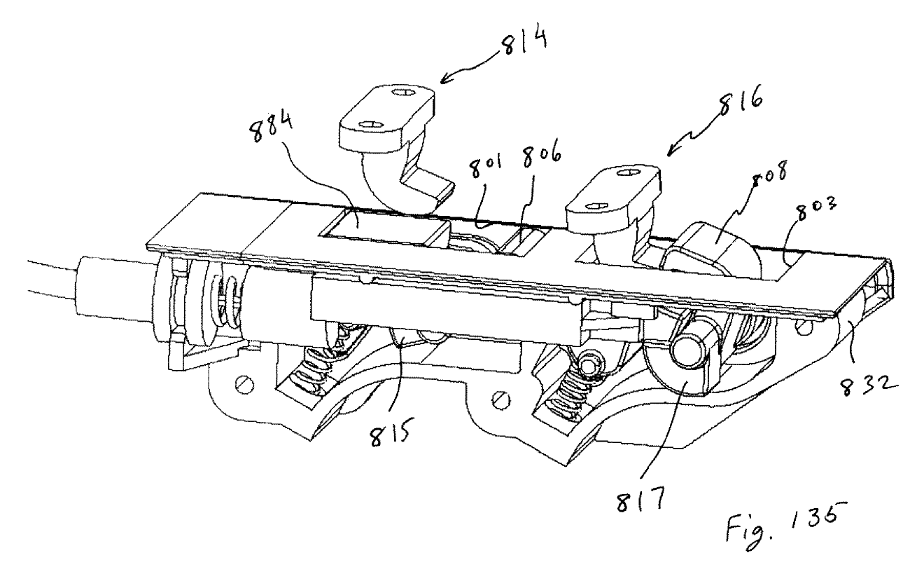

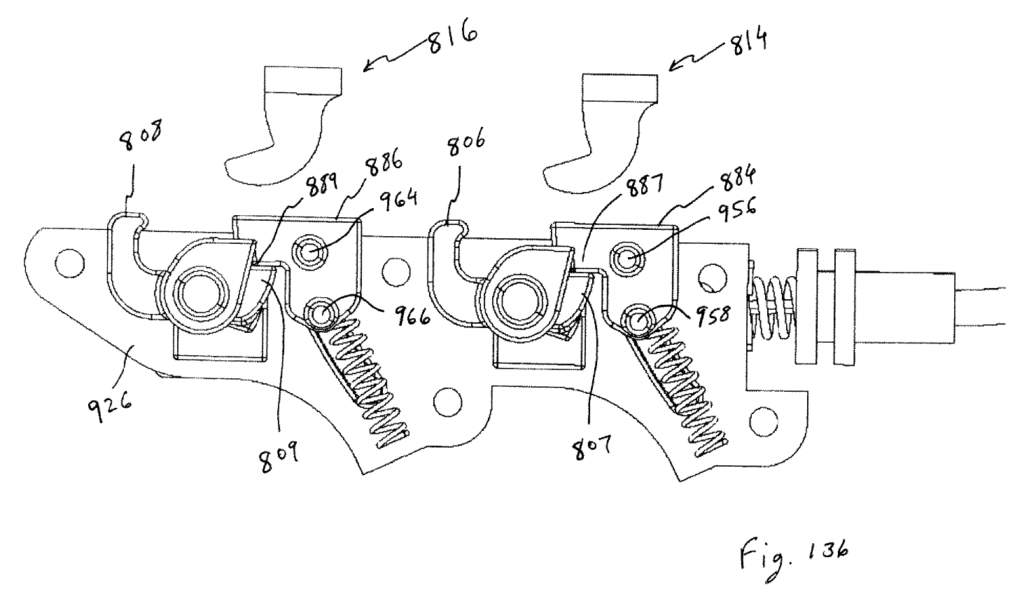

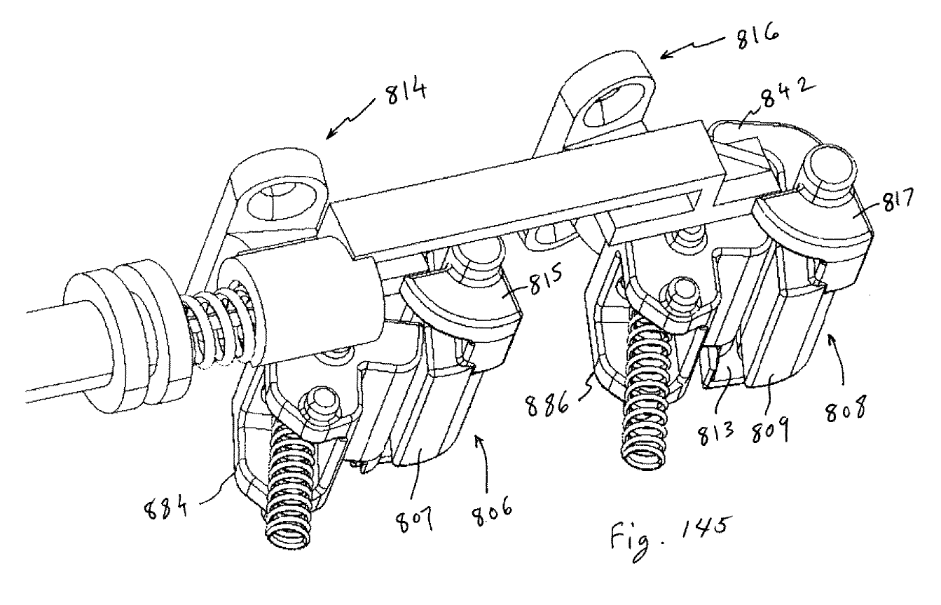

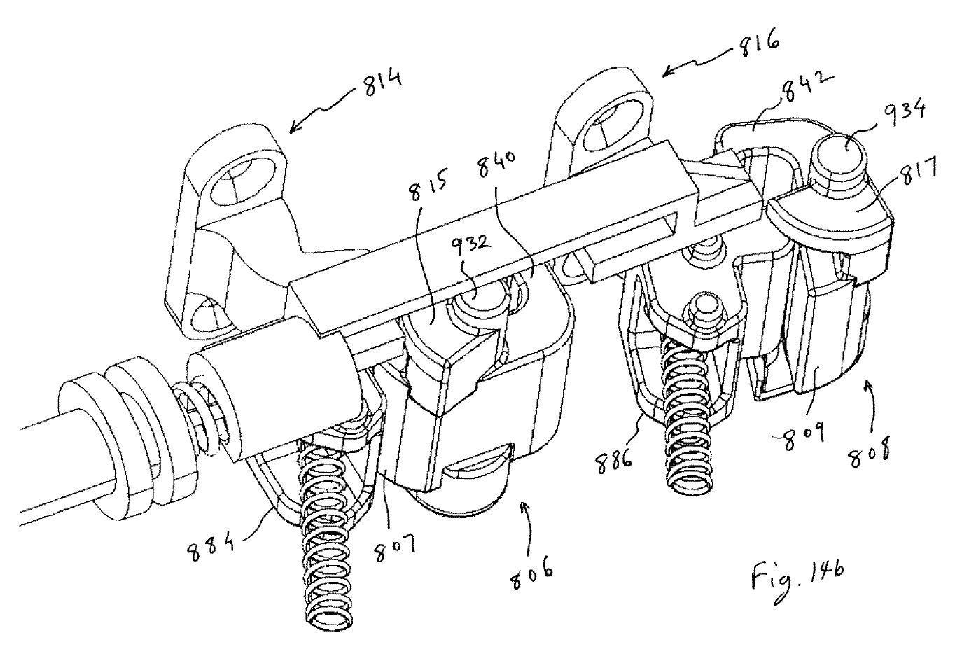

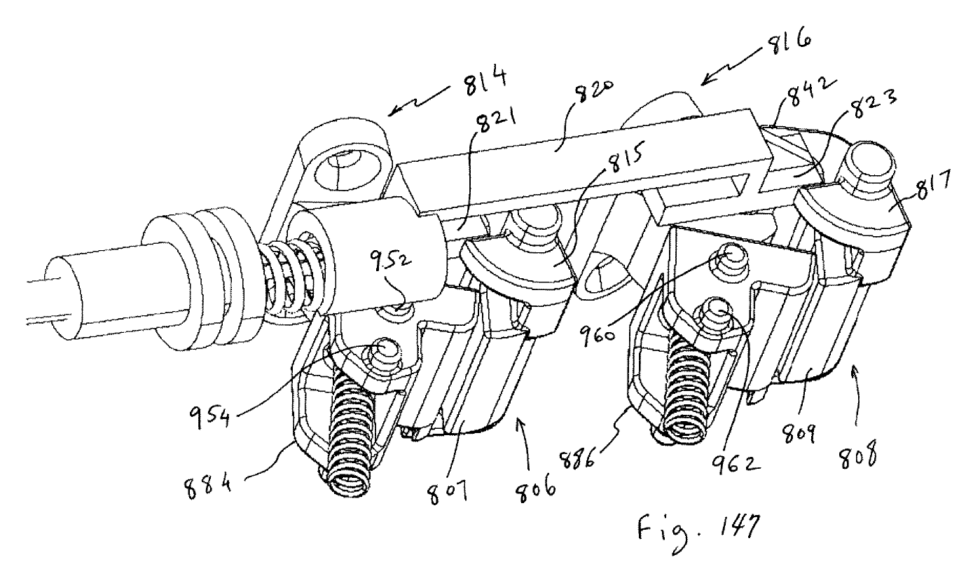

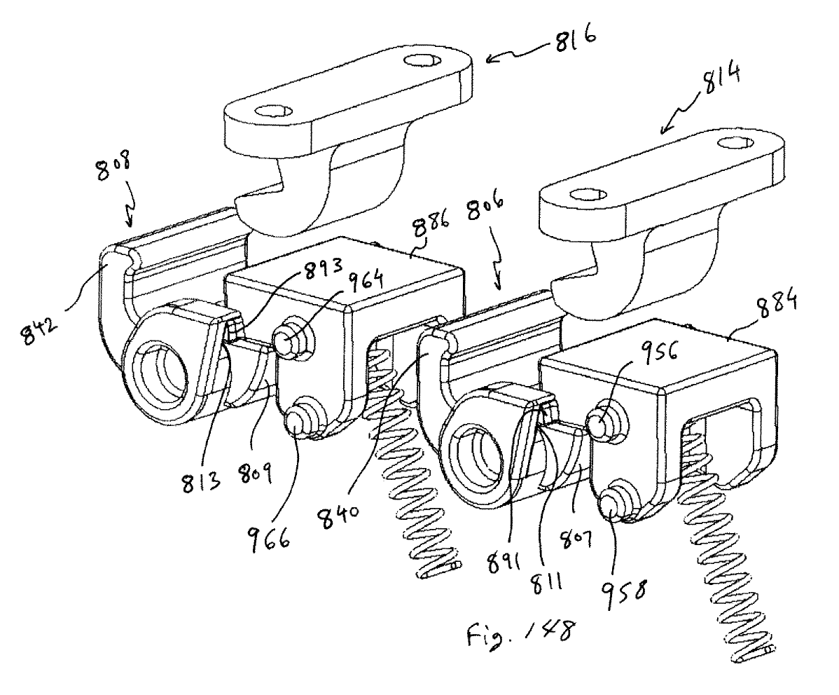

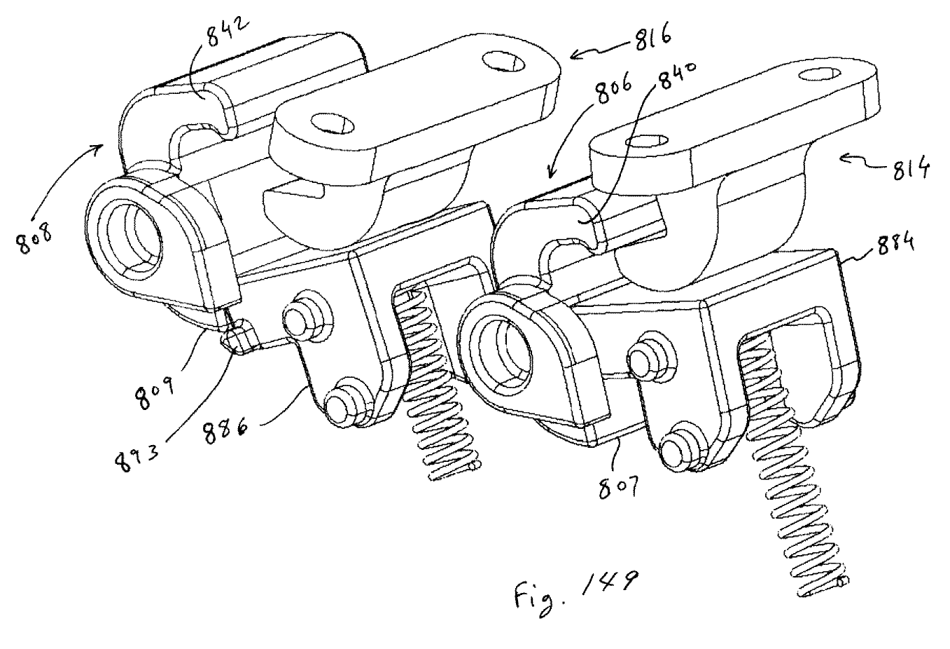

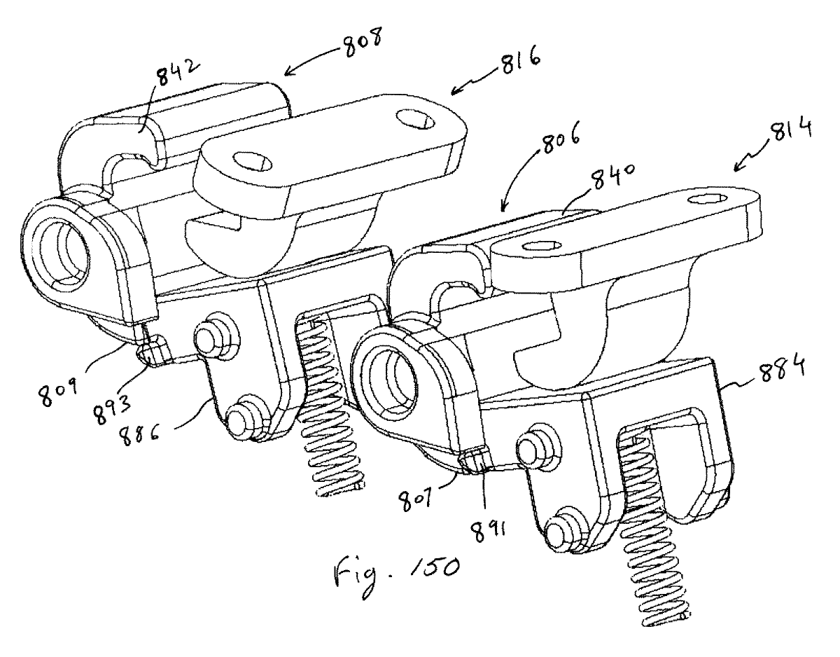

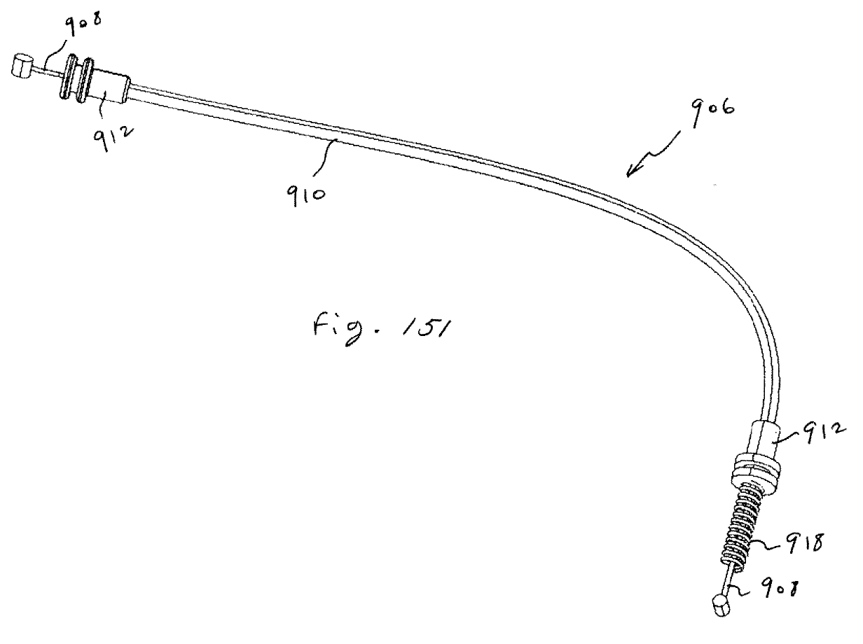

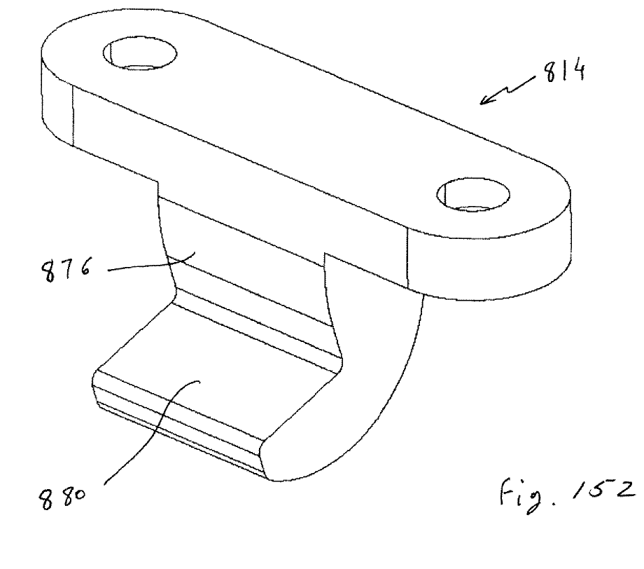

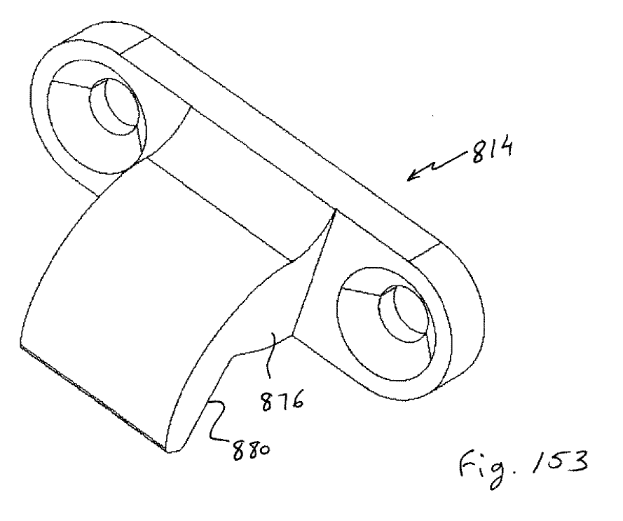

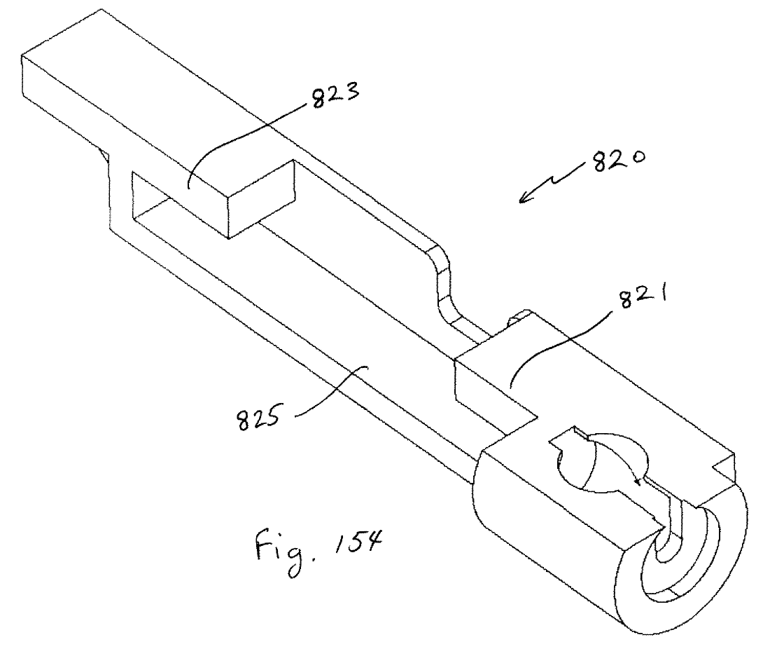

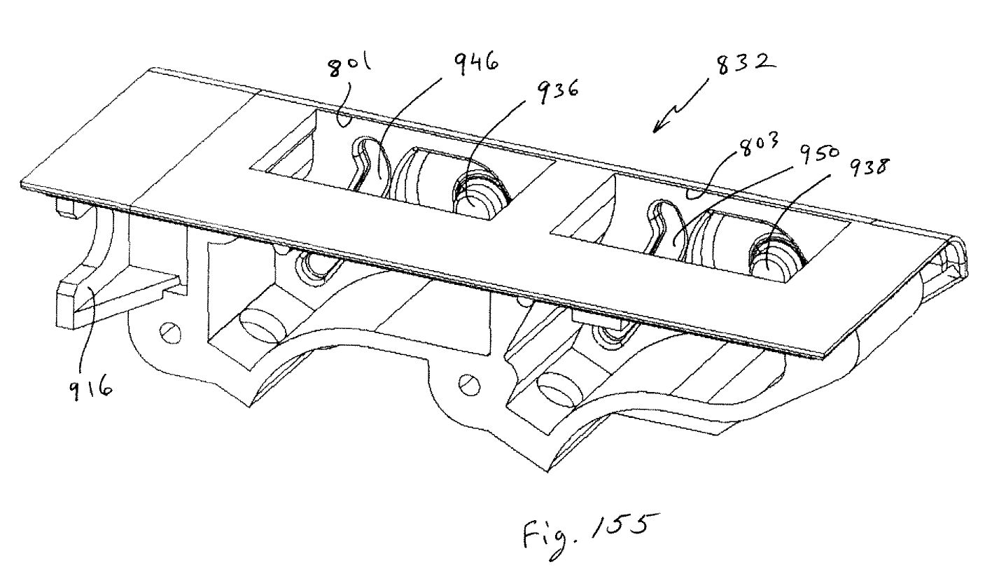

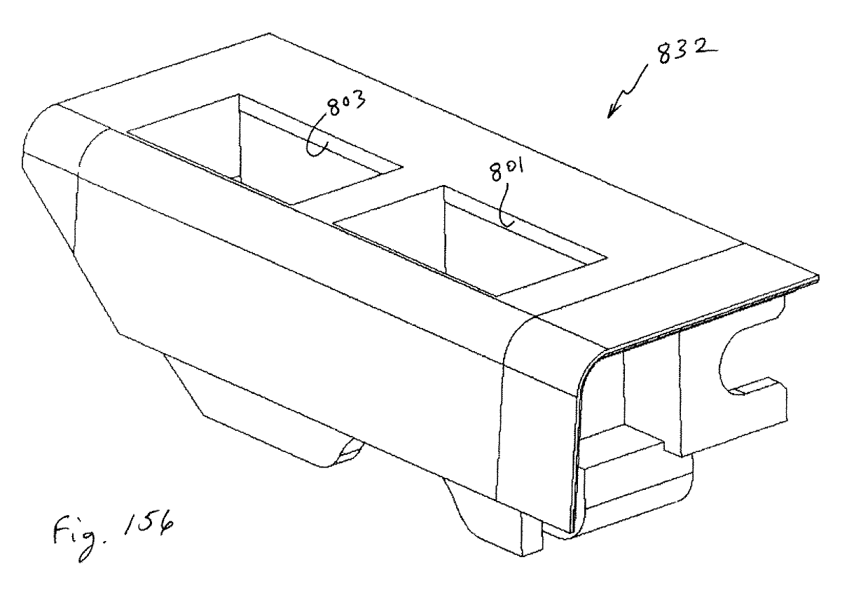

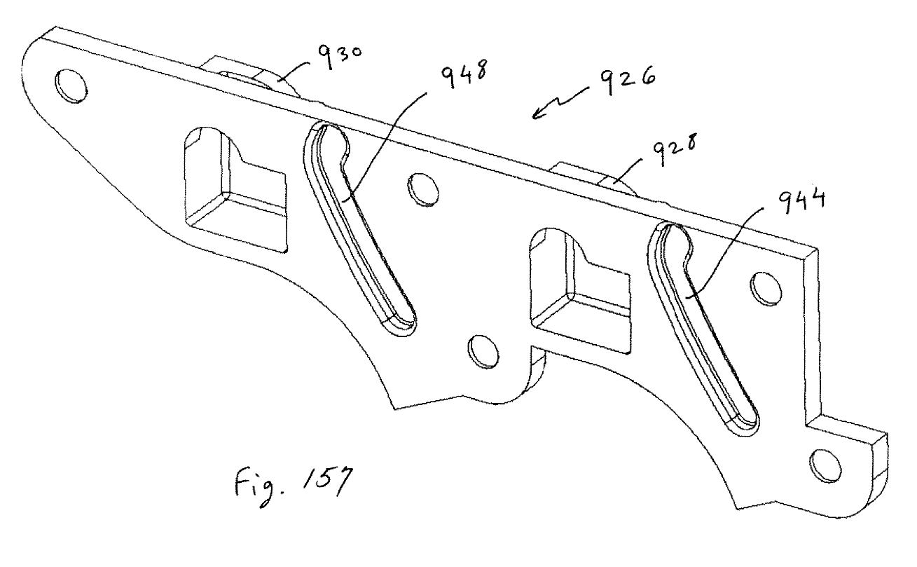

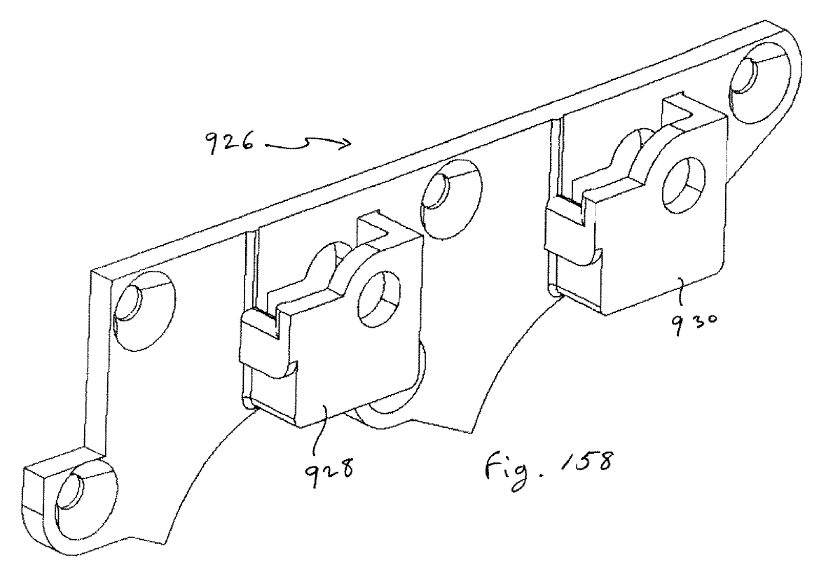

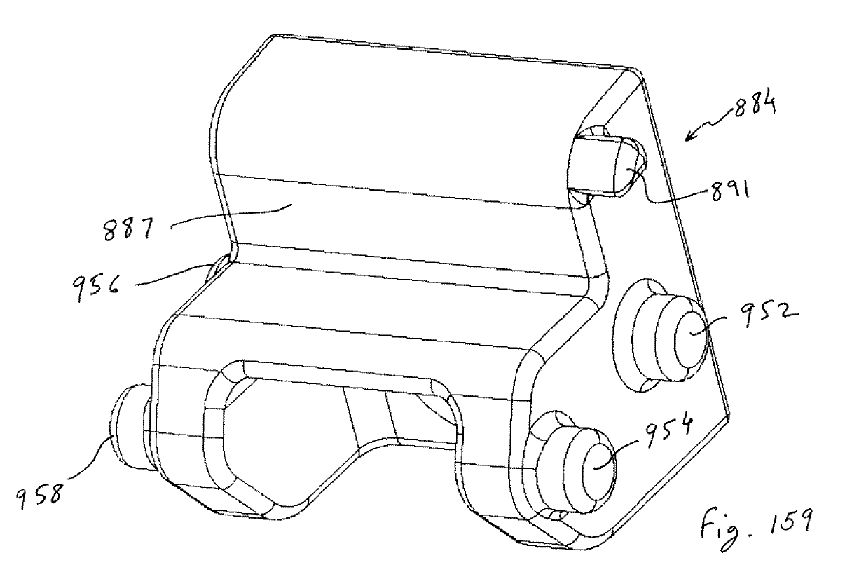

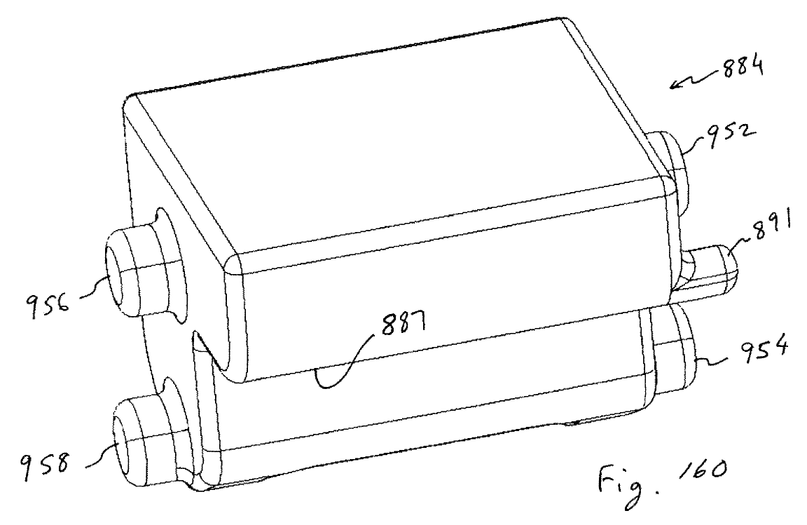

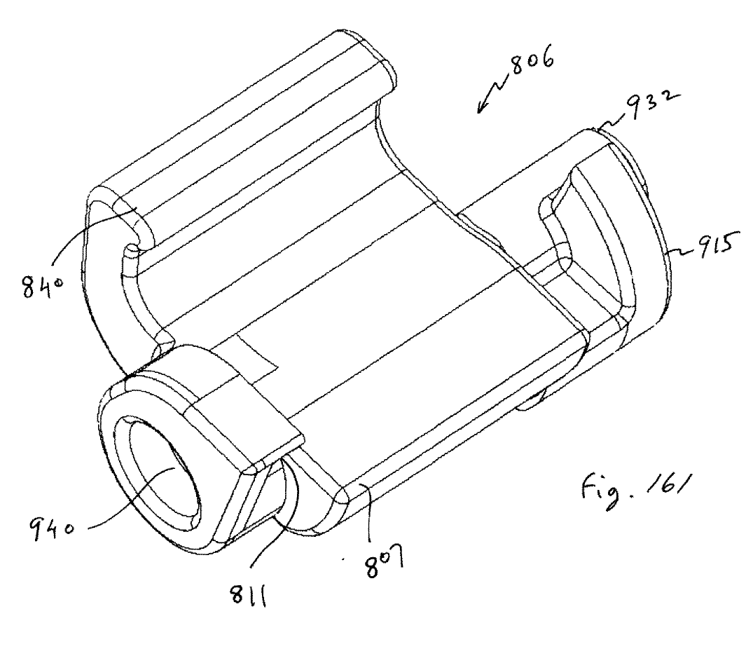

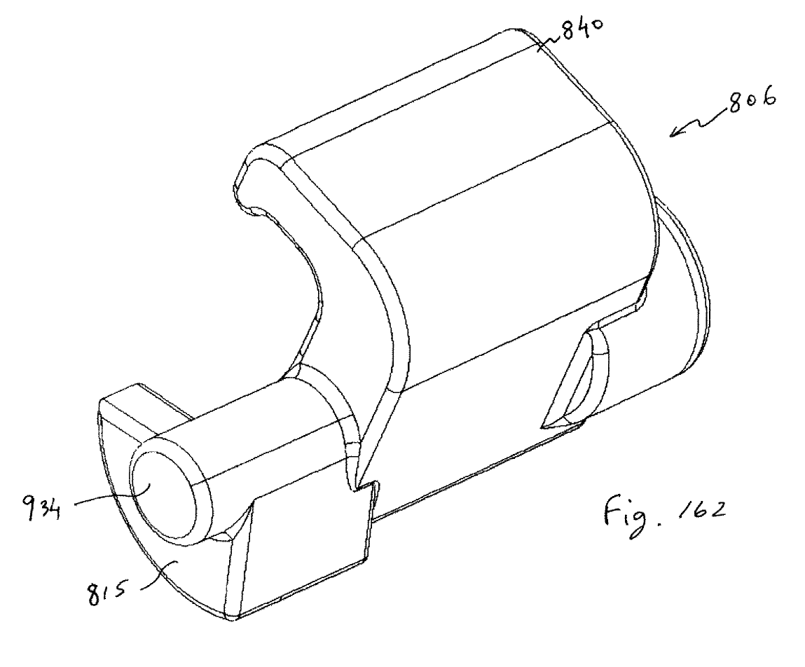

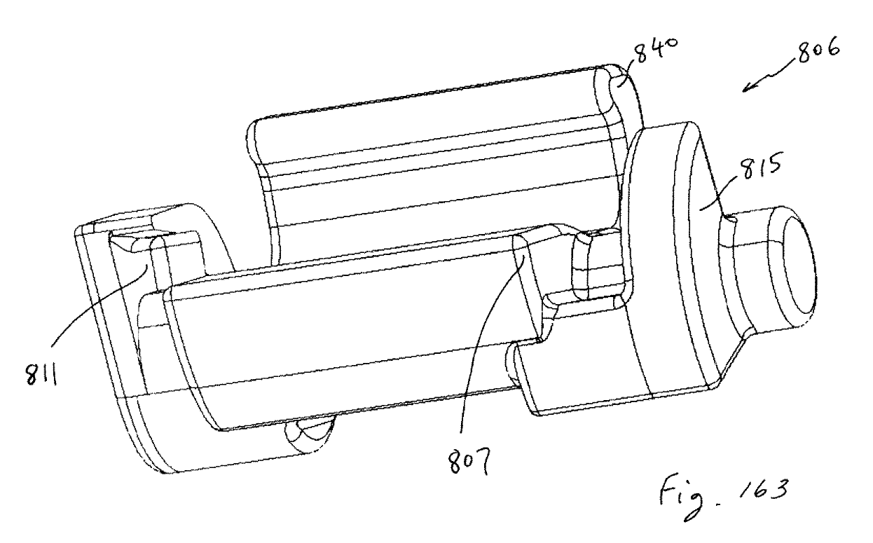

Referring to FIGS. 129-150, the operation of the latch 800 in cases when one striker lags the other is illustrated. FIGS. 129, 136, and 143, show the latch 800 with the pawls 806, 808 in the unlatched position and with the strikers 814, 816 at the beginning of the closing operation. FIGS. 130, 137, and 144, show the striker 816 lagging the striker 814 which has already started to depress the pad 884 and cause the rotation of the pawl 806 to a position near the latched position of the pawl 806. The initial pivotal movement of the pads causes a large rotation of the corresponding pawl toward the latched position, thus leaving a substantial portion of the over-travel of the leading striker available for bringing up the lagging striker. The illustrated embodiment of the latch 800 can accommodate lags of about 5 mm. FIGS. 134, 141, and 145, show the striker 816 and the pawl 808 in the latched position and the pad 884 and the striker 814 in an over-travel position. The pawl 806 is also in the latched position and the locking bar 820 is in the retaining position. FIGS. 133, 140, and 147, show both strikers 814 and 816 and pads 884 and 886 at maximum over-travel. The index projections 891, 893 are out of their respective cam grooves 811, 813, but because the slots 944, 946, 948, and 950 preserve the orientation of the pads 884 and 886 during over-travel, the index projections 891, 893 can reenter their respective cam grooves 811, 813, upon returning to their normal latched position and during the unlatching process. Thus the pawls remain in their normal latched positions even during over-travel by the strikers 814 and 816. FIGS. 135 and 146 illustrate best how if one striker is leading upon opening, then the pawl corresponding to the leading striker keeps the locking bar 820 in the release position to allow the lagging striker to disengage from its corresponding pawl. In the illustrated example, striker 814 is leading and the cam lobe 815 is keeping the locking bar 820 in the release position to allow the lagging striker 816 to disengage from its corresponding pawl 808.

Advantages of this latch are that the size of the latch is reduced, the size of the striker is reduced for accommodating a given lag range, and that the finish is aesthetically pleasing and the mechanism is hidden.

The latch 800 can be used with a solenoid rather than the linear actuator. The actuator or solenoid can be made integral with the latch to eliminate the need for Bowden cables. The Bowden cable can be linked directly to a push button for purely mechanical actuation or to provide a mechanical override.

It is to be understood that the present invention is not limited to the embodiments described above. Furthermore, it is to be understood that the embodiments of the present invention disclosed above are susceptible to various modifications, changes and adaptations by those skilled in the art, without departing from the spirit and scope of the invention.

1. A latch mechanism comprising:
a housing;
a first pawl rotationally supported by said housing, said first pawl being rotationally movable between latched and unlatched positions;
a second pawl rotationally supported by said housing, said second pawl being rotationally movable between latched and unlatched positions;
means for retaining said first pawl in its latched position;
means for retaining said second pawl in its latched position; and
means for actuating said means for retaining said first pawl and said means for retaining said second pawl, said means for actuating said means for retaining said first pawl and said means for retaining said second pawl providing for selective release of said first pawl and said second pawl from their latched positions under control of a user.

2. The latch mechanism according to claim 1, wherein said first pawl and said second pawl are mechanically linked such that each of said first pawl and said second pawl moves in response to at least some movement of the other one of said first pawl and said second pawl.

3. The latch mechanism according to claim 2, wherein said first pawl and said second pawl are mechanically linked by a linking bar having a first end and a second end, said linking bar being pivotally attached to said first pawl at said first end thereof and said linking bar being pivotally attached to said second pawl at said second end thereof.

4. The latch mechanism according to claim 2, wherein said first pawl is provided with a first plurality of gear teeth and said second pawl is provided with a second plurality of gear teeth, and wherein said first plurality of gear teeth meshes with said second plurality of gear teeth to thereby mechanically link said first pawl and said second pawl.

5. The latch mechanism according to claims 1, 2, 3, or 4, wherein said first pawl has an axis of rotation and said second pawl has an axis of rotation, and said axis of rotation of said first pawl is parallel to and spaced apart from said axis of rotation of said second pawl.

6. The latch mechanism according to claim 2, further comprising a bracket rigidly connected to said first pawl and to said second pawl, said bracket extending between said first pawl and said second pawl to thereby rigidly connect said first pawl to said second pawl such that said first pawl and said second pawl move as a unit.

7. The latch mechanism according to claim 6, wherein said first pawl has an axis of rotation and said second pawl has an axis of rotation, and said axis of rotation of said first pawl is coincident with said axis of rotation of said second pawl.

8. The latch mechanism according to claim 4, wherein said first pawl has a pawl claw, wherein said second pawl has a pawl claw, and wherein said first pawl and said second pawl rotate in opposite directions with said pawl claw of said first pawl and said pawl claw of said second pawl moving away from one another as said first pawl moves toward said latched position thereof and as said second pawl moves toward said latched position thereof.

9. The latch mechanism according to claim 3, wherein said first pawl and said second pawl rotate in the same direction as said first pawl moves toward said latched position thereof and as said second pawl moves toward said latched position thereof.

10. The latch mechanism according to claim 9, wherein said first pawl has a pawl claw and wherein said second pawl has a pawl claw.

11. The latch mechanism according to claim 1, wherein said first pawl has an axis of rotation and said second pawl has an axis of rotation, and said axis of rotation of said first pawl is coincident with said axis of rotation of said second pawl.

12. The latch mechanism according to claim 11, wherein said means for retaining said first pawl in said latched position thereof comprises:
a first locking bar pivotally movable between engaged and disengaged positions, said first locking bar engaging said first pawl to maintain said first pawl in its latched position when said first pawl is in its latched position and said first locking bar is in said engaged position;
wherein said means for retaining said second pawl in said latched position thereof comprises:
a second locking bar pivotally movable between engaged and disengaged positions, said second locking bar engaging said second pawl to maintain said second pawl in its latched position when said second pawl is in its latched position and said second locking bar is in said engaged position; and
wherein said means for actuating said means for retaining said first pawl and said means for retaining said second pawl comprises:
a plate pivotally supported by said housing, said first and second locking bars being attached to said plate.

13. The latch mechanism according to claim 12, wherein said means for actuating said means for retaining said first pawl and said means for retaining said second pawl comprises:
a solenoid supported by said housing, said solenoid having a shaft that is pivotally attached to said plate such that rectilinear movement of said shaft of said solenoid causes pivotal movement of said plate.

14. The latch mechanism according to claim 5, wherein said means for retaining said first pawl in said latched position thereof comprises:
a first locking bar rectilinearly movable between engaged and disengaged positions, said first locking bar engaging said first pawl to maintain said first pawl in its latched position when said first pawl is in its latched position and said first locking bar is in said engaged position;
wherein said means for retaining said second pawl in said latched position thereof comprises:
a second locking bar rectilinearly movable between engaged and disengaged positions, said second locking bar engaging said second pawl to maintain said second pawl in its latched position when said second pawl is in its latched position and said second locking bar is in said engaged position; and
wherein said means for actuating said means for retaining said first pawl and said means for retaining said second pawl comprises:
an operating rod supported for rectilinear movement relative to said housing, said first and second locking bars being attached to said operating rod.

15. The latch mechanism according to claim 14, wherein said first pawl is at least movable between said latched position thereof and an unlatched position and said second pawl is at least movable between said latched position thereof and an unlatched position, wherein said operating rod is capable of engaging both said first pawl and said second pawl to retain said first and second pawls in their latched positions, and wherein said operating rod is prevented from returning to said engaged position thereof when any one or both of said first pawl and said second pawl is displaced from its respective latched position in a direction toward its respective unlatched position.

16. The latch mechanism according to claim 1, wherein said means for retaining said first pawl in said latched position thereof comprises:
a first catch plate rectilinearly movable between engaged and disengaged positions, said first catch plate engaging said first pawl to maintain said first pawl in its latched position when said first pawl is in its latched position and said first catch plate is in said engaged position;
wherein said means for retaining said second pawl in said latched position thereof comprises:
a second catch plate rectilinearly movable between engaged and disengaged positions, said second catch plate engaging said second pawl to maintain said second pawl in its latched position when said second pawl is in its latched position and said second catch plate is in said engaged position; and
wherein said means for actuating said means for retaining said first pawl and said means for retaining said second pawl comprises:
a locking bar supported for rectilinear movement relative to said housing, said first and second locking bars being attached to said locking bar.

17. The latch mechanism according to claim 16, wherein said first pawl is at least movable between said latched position thereof and an unlatched position and said second pawl is at least movable between said latched position thereof and an unlatched position, wherein said locking bar is capable of engaging both said first pawl and said second pawl to retain said first and second pawls in their latched positions, and wherein said locking bar is prevented from returning to said engaged position thereof when any one or both of said first pawl and said second pawl is displaced from its respective latched position in a direction toward its respective unlatched position.

18. The latch mechanism according to claim 17, further comprising:
a first pad supported for at least rectilinear movement by said housing, said first pad being movable between a first position and at least a second position, said first pad engaging and moving said first pawl to said latched position thereof during movement of said first pad from said first position thereof to said second position thereof; and
a second pad supported for at least rectilinear movement by said housing, said second pad being movable between a first position and at least a second position, said second pad engaging and moving said second pawl to said latched position thereof during movement of said second pad from said first position thereof to said second position thereof.

19. The latch mechanism according to claim 2, wherein said means for actuating said means for retaining said first pawl and said means for retaining said second pawl comprises:
an operating rod supported for rectilinear movement relative to said housing, said operating rod having at least one catch surface that is capable of engaging said first pawl to maintain said first pawl in its latched position;
wherein said means for retaining said first pawl in said latched position thereof comprises said catch surface, and wherein said means for retaining said second pawl in said latched position thereof comprises said catch surface, said first pawl and a mechanical link between said first pawl and said second pawl.

20. The latch mechanism according to claim 2, wherein said means for actuating said means for retaining said first pawl and said means for retaining said second pawl comprises:
an operating rod supported for rectilinear movement relative to said housing, said operating rod having at least one catch surface that is capable of engaging said second pawl to maintain said second pawl in its latched position;
wherein said means for retaining said second pawl in said latched position thereof comprises said catch surface, and wherein said means for retaining said first pawl in said latched position thereof comprises said catch surface, said second pawl and a mechanical link between said first pawl and said second pawl.

21. The latch mechanism according to claim 1, wherein the latch mechanism is adapted for securing in a closed position first and second doors that are mechanically linked such that moving one of the first and second doors to the closed position moves a remaining one of the first and second doors at least substantially to the closed position, wherein the first door is provided with a first keeper and the second door is provided with a second keeper, wherein said first pawl is adapted to engage the first keeper, and wherein said second pawl is adapted to engage the second keeper to thereby secure the first and second doors in the closed position.

22. The latch mechanism according to claim 21, wherein when one of said first and second keepers reaches a respective one of said first and second pawls and a remaining one of the first and second keepers lags behind to within a predetermined distance relative to its respective one of the first and second pawls, a lagging one of the first and second keepers can be engaged and moved to its closed position by one of the first and second pawls corresponding to the lagging one of the first and second keepers as the first and second pawls move substantially simultaneously to their latched positions.

23. The latch mechanism according to claim 21, wherein when one of said first and second keepers reaches a respective one of said first and second pawls and a remaining one of the first and second keepers lags behind to within a predetermined distance relative to its respective one of the first and second pawls, one of said first and second pawls engaged by a leading one of the first and second keepers is adapted to allow the leading one of the first and second keepers to over-travel a predetermined amount past its closed position to allow a lagging one of the first and second keepers to engage and move to its latched position one of said first and second pawls corresponding to the lagging one of the first and second keepers as the lagging one of the first and second keepers moves to its closed position.

24. The latch mechanism according to claim 18, wherein the latch mechanism is adapted for securing in a closed position first and second doors that are mechanically linked such that moving one of the first and second doors to the closed position moves a remaining one of the first and second doors at least substantially to the closed position, wherein the first door is provided with a first keeper and the second door is provided with a second keeper, wherein said first pawl is adapted to engage the first keeper, and wherein said second pawl is adapted to engage the second keeper to thereby secure the first and second doors in the closed position.

25. The latch mechanism according to claim 24, wherein when one of said first and second keepers reaches a respective one of said first and second pads and a remaining one of the first and second keepers lags behind to within a predetermined distance relative to its respective one of the first and second pads, one of said first and second pads engaged by a leading one of the first and second keepers is adapted to allow the leading one of the first and second keepers to over-travel a predetermined amount past its closed position to allow a lagging one of the first and second keepers to engage a corresponding one of said first and second pads and move to its latched position a corresponding one of said first and second pawls as the lagging one of the first and second keepers moves to its closed position.

26. The latch mechanism according to any one of claims 1 and 16-25, wherein said means for actuating said means for retaining said first pawl and said means for retaining said second pawl is electrically actuated and wherein said means for actuating said means for retaining said first pawl and said means for retaining said second pawl includes a solenoid.

27. A latch mechanism comprising:
a housing;
a first pawl rotationally supported by said housing, said first pawl being rotationally movable between latched and unlatched positions;
a second pawl rotationally supported by said housing, said second pawl being rotationally movable between latched and unlatched positions;
a locking bar engageable with at least one of said first and second pawls to retain said first and second pawls in their latched positions, said locking bar being movable between an engaged position and a disengaged position, said first and second pawls being retained in their latched positions when said locking bar is in said engaged position; and
means for actuating said locking bar, said means for actuating said locking bar providing for selective movement of said locking bar between engaged and disengaged positions under control of a user.

28. The latch mechanism according to claim 27, wherein said first pawl and said second pawl are mechanically linked such that each of said first pawl and said second pawl moves in response to at least some movement of the other one of said first pawl and said second pawl.

29. The latch mechanism according to claim 28, wherein said first pawl and said second pawl are mechanically linked by a linking bar having a first end and a second end, said linking bar being pivotally attached to said first pawl at said first end thereof and said linking bar being pivotally attached to said second pawl at said second end thereof.

30. The latch mechanism according to claim 28, wherein said first pawl is provided with a first plurality of gear teeth and said second pawl is provided with a second plurality of gear teeth, and wherein said first plurality of gear teeth meshes with said second plurality of gear teeth to thereby mechanically link said first pawl and said second pawl.

31. The latch mechanism according to claims 27, 28, 29, or 30, wherein said first pawl has an axis of rotation and said second pawl has an axis of rotation, and said axis of rotation of said first pawl is parallel to and spaced apart from said axis of rotation of said second pawl.

32. The latch mechanism according to claim 28, further comprising a bracket rigidly connected to said first pawl and to said second pawl, said bracket extending between said first pawl and said second pawl to thereby rigidly connect said first pawl to said second pawl such that said first pawl and said second pawl move as a unit.
